(19) United States
(12) Patent Application Publication
(10) Pub. No.: US 2005/0282083 A1
(43) Pub. Date: Dec. 22, 2005

(54) Polymer, resist composition and patterning process

(75) Inventors: Kenji Funatsu, Joetsu-shi (JP); Koji Hasegawa, Joetsu-shi (JP); Tsunehiro Nishi, Joetsu-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/155,837

(22) Filed: Jun. 20, 2005

(30) Foreign Application Priority Data
Jun. 21, 2004 (JP) 2004-182686

(51) Int. Cl. G03C 1/492

(52) U.S. Cl. 430/270.1

(57) ABSTRACT

A polymer comprising recurring units having formulae (1) and (2) and having a weight average molecular weight of 1,000 to 50,000. In the formulae, R¹ and R³ are H or CH₃, R⁴ is alkylene, R² is a lactone structure-containing substituent group selected from formulae (R²-1) to (R²-4) wherein Y is CH₂ or O, R⁵ is CO₂R⁷ when Y is CH₂, or R⁵ is H or CO₂R⁷ when Y is O, R⁶ is H or alkyl, and R⁷ is alkyl which may be separated by at least one oxygen atom. The polymer is used as a base resin to formulate a resist composition, especially a chemically amplified positive resist composition which has a high sensitivity, resolution and dry etch resistance and forms a resist pattern having good substrate adhesion and least roughened sidewalls.

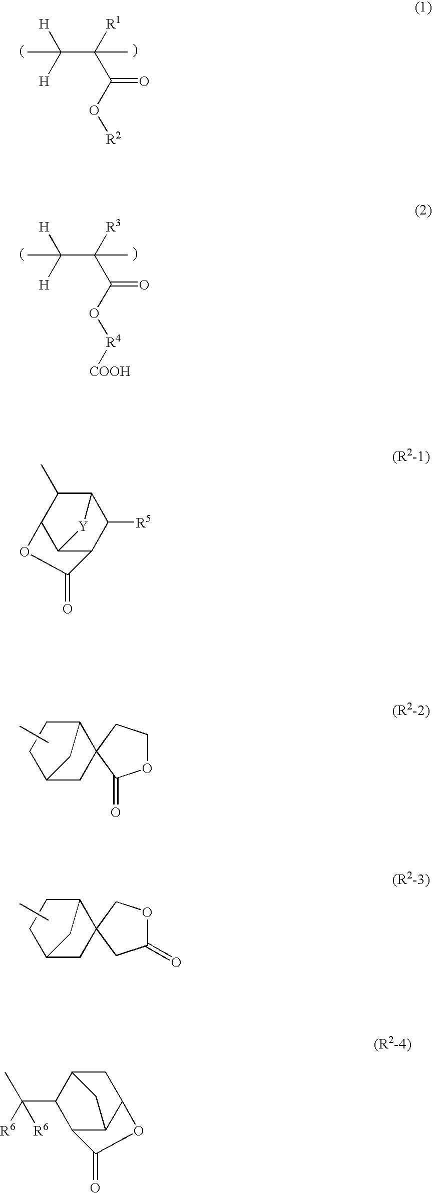

### CROSS-REFERENCE TO RELATED APPLICATION

This non-provisional application claims priority under 35 U.S.C. §119(a) on Patent Application No. 2004-182686 filed in Japan on Jun. 21, 2004, the entire contents of which are hereby incorporated by reference.

### TECHNICAL FIELD

This invention relates to (i) a novel polymer for resist use, (ii) a resist composition comprising the polymer as a base resin for use in the micropatterning technology, and (iii) a patterning process using the resist composition.

### BACKGROUND OF THE INVENTION

A number of efforts are being made to achieve a finer pattern rule in the recent drive for higher integration in LSI devices toward higher data processing speeds. Deep-ultraviolet lithography is the microfabrication technology essential for further miniaturization. In particular, photolithography using a KrF or ArF excimer laser as the light source is strongly desired to reach the practical level as the micropatterning technique capable of achieving a feature size of less than or equal to 0.2 μm.

The resins in widespread use as the resist material adapted for KrF excimer laser process include polyhydroxystyrenes having practically acceptable levels of both transparency and etch resistance. The resist materials adapted for ArF excimer laser process are required to have a high transparency, a dry etching resistance sufficient to allow for film thickness reduction, a high sensitivity sufficient to eliminate any extra burden on the expensive optical system, and a high resolution sufficient to form a precise micropattern. Active efforts have been made to develop a resist resin for the ArF excimer laser process having a high sensitivity and resolution as well as practically acceptable dry etch resistance. Known resins having high transparency at the relevant wavelength include polymers of acrylic or methacrylic acid derivatives as described in JP-A 4-39665. Resist compositions comprising such polymers have been often used in the ArF excimer laser lithography, but their performance is not considered satisfactory.

In order to impart high sensitivity and resolution to ArF resist compositions comprising acrylic or methacrylic derivatives, it is advantageous to introduce a larger proportion of acid labile units. The acid labile units are generally derived from cyclic structure compounds having a high carbon density. For example, JP-A 9-73173 and JP-A 9-90637 describe polymers having acid labile groups, typically 2-alkyl-adamantyl groups on side chains. Incorporating a large proportion of such cyclic structure compounds having a high carbon density is advantageous from the standpoint of dry etch resistance. However, the cyclic structure compounds having a high carbon density themselves are highly rigid and hydrophobic so that polymers having incorporated therein a large proportion of such cyclic structure compounds also have very high rigidity and hydrophobicity as a whole. A resist composition comprising such a highly rigid, hydrophobic polymer as the base resin often invites pattern stripping due to weak substrate adhesion and liquid developer cissing or development defects due to low affinity to liquid developers. Additionally, the resist composition comprising a highly hydrophobic polymer forms a resist film which is tenaciously held in an unexposed area, rapidly dissolved in an over-exposed area, and in a considerably wide exposed area between them, does not become dissolved due to shortage of liquid developer affinity and is rather swollen during development. This results in resist pattern seizure and collapse and pattern sidewall roughening. The composition is thus practically unacceptable, particularly in the future demand for a finer pattern rule.

While a finer pattern rule is being demanded, there is a need to have a polymer for resist material which exerts satisfactory performance with respect to sensitivity and resolution and has practically acceptable dry etch resistance, good adhesion to substrates and affinity to liquid developers.

### SUMMARY OF THE INVENTION

An object of the invention is to provide a novel polymer for use in a resist composition which satisfies high resolution, minimal pattern sidewall roughening, and practically acceptable etch resistance. Another object of the invention is to provide a resist composition comprising the polymer as a base resin, and a patterning process.

The inventor has found that a polymer comprising recurring units of the general formulae (1) and (2), shown below, and having a weight average molecular weight of 1,000 to 50,000 is an effective resin for use in resist compositions, and that a resist composition comprising the polymer as a base resin has a high resolution, minimal pattern sidewall roughening, and practically acceptable etch resistance, is improved in necessary properties such as adhesion to substrates and affinity to liquid developers, and lends itself to precise micropatterning.

In one aspect, the present invention provides a polymer comprising recurring units having the general formulae (1) and (2), the recurring units being of at least one type for each formula, and having a weight average molecular weight of 1,000 to 50,000. 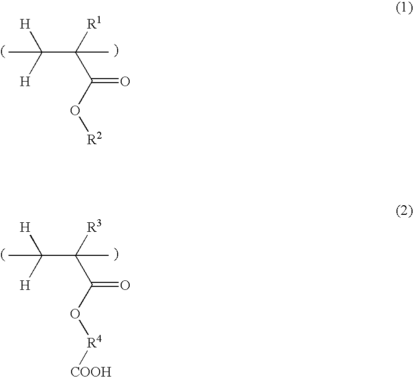
Herein R¹ and R³ are independently hydrogen or methyl, R⁴ is a straight, branched or cyclic alkylene group of 1 to 20 carbon atoms, which may be substituted with an oxygen-containing functional group and/or have an oxygen atom intervening in a carbon-to-carbon bond, R² is a lactone structure-containing substituent group selected from the general formulae (R²-1) to (R²-4): 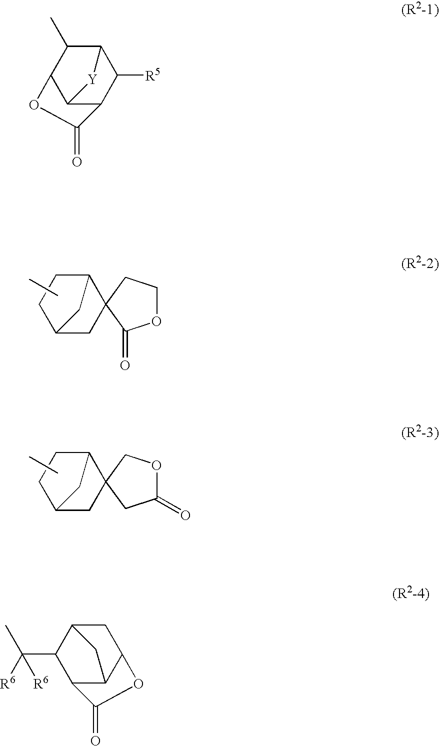
wherein Y is a methylene group or oxygen atom, R⁵ is CO₂R⁷ when Y is methylene, or R⁵ is hydrogen or CO₂R⁷ when Y is oxygen, R⁶ is each independently hydrogen or a straight, branched or cyclic alkyl group of 1 to 10 carbon atoms, two R⁶ may bond together to form a ring with the carbon atom to which they are attached, and R⁷ is a straight, branched or cyclic alkyl group of 1 to 15 carbon atoms which may have an oxygen atom intervening in a carbon-to-carbon bond.

The present invention further provides a polymer comprising recurring units having the general formulae (1) to (3), the recurring units being of at least one type for each formula, and having a weight average molecular weight of 1,000 to 50,000. 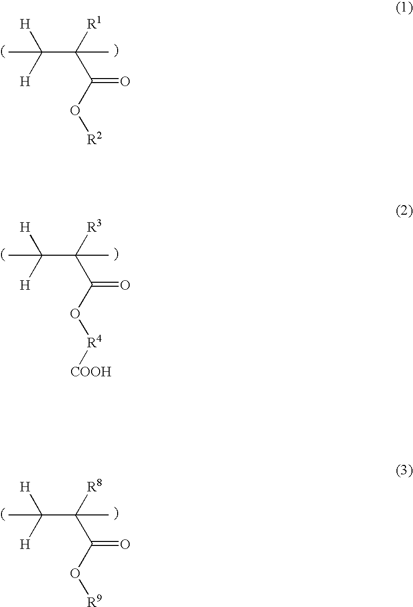
Herein R¹, R³ and R⁸ are independently hydrogen or methyl, R² and R⁴ are as defined above, R⁹ is an acid-labile protective group selected from the general formulae (R⁹-1) and (R⁹-2): 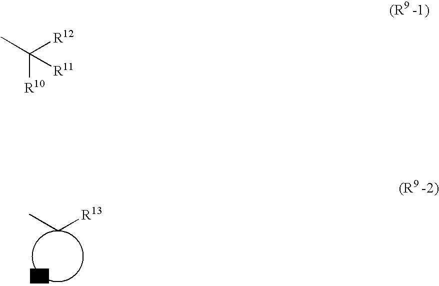
wherein R¹⁰, R¹¹ and R¹² are each independently a straight, branched or cyclic alkyl group of 1 to 15 carbon atoms, R¹³ is a straight or branched alkyl group of 1 to 15 carbon atoms, and Z forms cyclopentane, cyclohexane or adamantane with the carbon atom to which it is attached.

Still further the present invention provides a polymer comprising recurring units having the general formulae (1) to (4), the recurring units being of at least one type for each formula, and having a weight average molecular weight of 1,000 to 50,000. 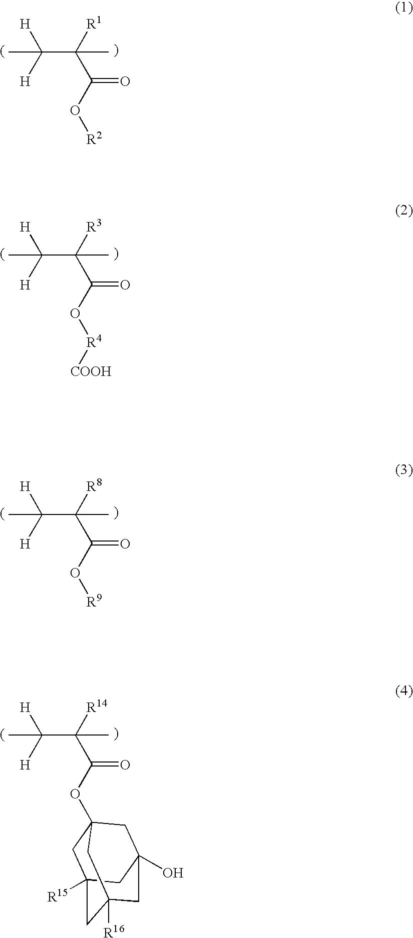
Herein R¹, R³, R⁸ and R¹⁴ are independently hydrogen or methyl, R², R⁴ and R⁹ are as defined above, R¹⁵ and R¹⁶ are each independently hydrogen or hydroxyl.

In another aspect, the invention provides a resist composition comprising the polymer defined above.

In a further aspect, the invention provides a pattern forming process comprising the steps of applying the resist composition onto a substrate to form a coating; heat treating the coating and then exposing it to high-energy radiation or electron beam through a photomask; and heat treating the exposed coating and developing it with a developer.

As discussed above, polymers using acid-reactive groups derived from cyclic structure compounds having a high carbon density, such as acrylic or methacrylic derivatives containing adamantane structures, typically 2-alkyl-2-adamantyl groups on side chains are often used in resist compositions. Incorporating a large proportion of such acid-reactive groups achieves some improvements in sensitivity and dry etch resistance. Owing to the rigidity and hydrophobicity of such groups, however, the resulting polymer also becomes highly rigid and hydrophobic as a whole. This leads to weak substrate adhesion, low liquid developer affinity, and development defects associated therewith. The resist film can be swollen during development, resulting in resist pattern seizure and collapse and pattern sidewall roughening. These polymers are thus unacceptable at the submicron feature size where deep-UV excimer lasers are used.

In contrast, the recurring units of formulae (1) and (2) impart high substrate adhesion and appropriate liquid developer affinity to polymers comprising the same. Then even polymers comprising the same in combination with recurring units containing highly rigid, hydrophobic acid-reactive groups having a cyclic structure and a high carbon density significantly restrain the development of unwanted phenomena including pattern peeling due to reduced substrate adhesion, development defects, swelling during development, pattern seizure and collapse, and pattern sidewall roughening. The polymers offer a higher resolution and practically acceptable dry etch resistance, and are very effective in forming micropatterns.

The polymer of the invention, when used as a base resin in a resist composition, especially chemically amplified positive resist composition, exhibits a high sensitivity, resolution and dry etch resistance, and forms a resist pattern having improved substrate adhesion and least roughened sidewalls.

### DESCRIPTION OF THE PREFERRED EMBODIMENTS

The novel high-molecular weight compound or polymer of the invention is defined as comprising recurring units having the general formulae (1) and (2), the recurring units being of at least one type for each formula. The polymer should have a weight average molecular weight of 1,000 to 50,000.

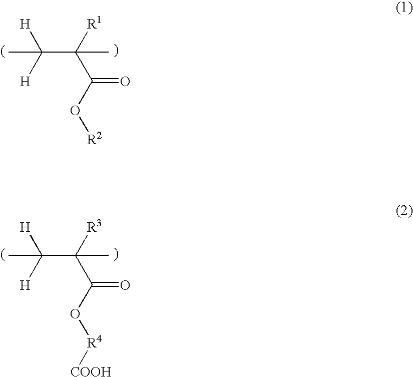

Herein R¹ and R³ are independently hydrogen or methyl. R² is a lactone structure-containing substituent group selected from the general formulae (R²-1) to (R²-4).

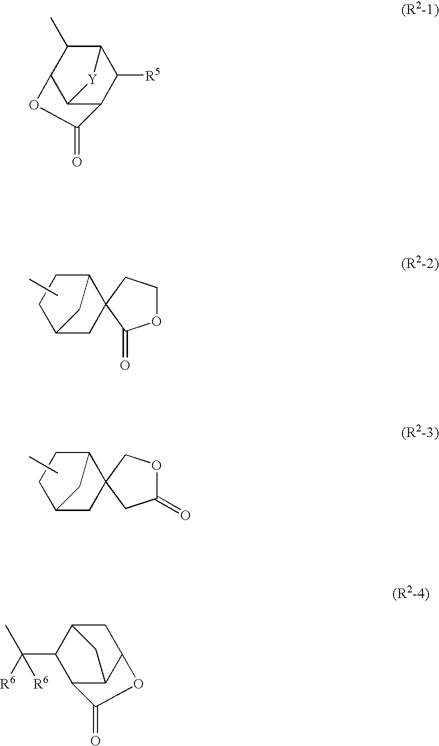

In the formulae, Y is a methylene group or oxygen atom. R⁵ is CO₂R⁷ when Y is methylene. R⁵ is hydrogen or CO₂R⁷ when Y is oxygen. R⁶ is each independently hydrogen or a straight, branched or cyclic alkyl group of 1 to 10 carbon atoms. Alternatively, two R⁶ may bond together to form a ring with the carbon atom to which they are attached. Examples of alkyl groups represented by R⁶ include methyl, ethyl, propyl, isopropyl, n-butyl, sec-butyl, tert-butyl, tert-amyl, n-pentyl, n-hexyl, cyclopentyl and cyclohexyl. When two R⁶ bond together to form a ring, suitable alkylene groups formed thereby include ethylene, propylene, trimethylene and tetramethylene, and the rings include those having 3 to 20 carbon atoms, especially 3 to 10 carbon atoms, such as cyclopentyl and cyclohexyl. R⁷ is a straight, branched or cyclic alkyl group of 1 to 15 carbon atoms or such an alkyl group which has at least one oxygen atom intervening in any carbon-to-carbon bond. Examples of suitable alkyl groups are as exemplified for R⁶; and suitable alkyl groups having at least one oxygen atom intervening in a carbon-to-carbon bond include methoxymethyl, methoxyethoxymethyl, 1-ethoxyethyl, and 2-tetrahydrofuranyl.

Illustrative, non-limiting examples of the recurring units of formula (1) wherein R² is (R²-1) are given below.

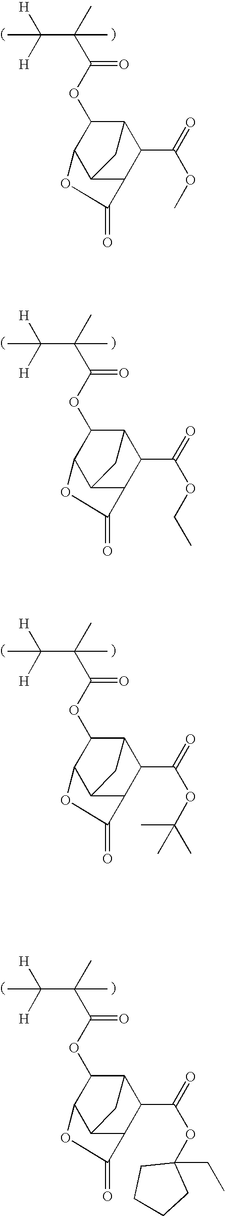

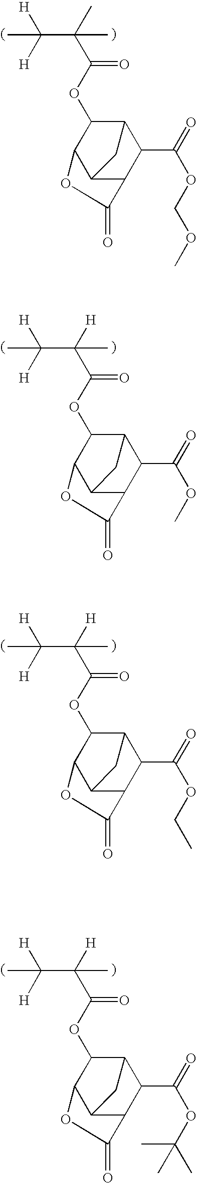

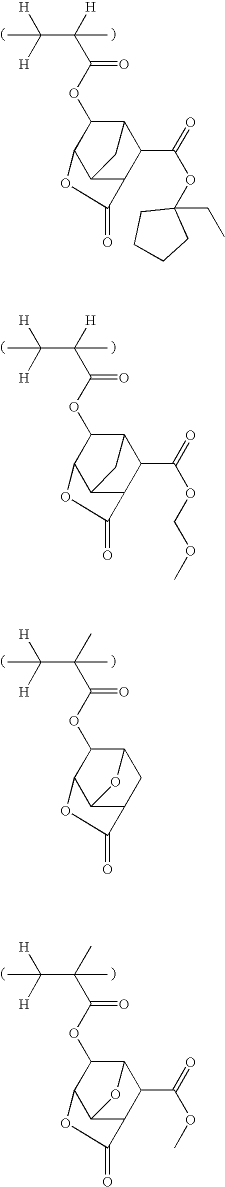

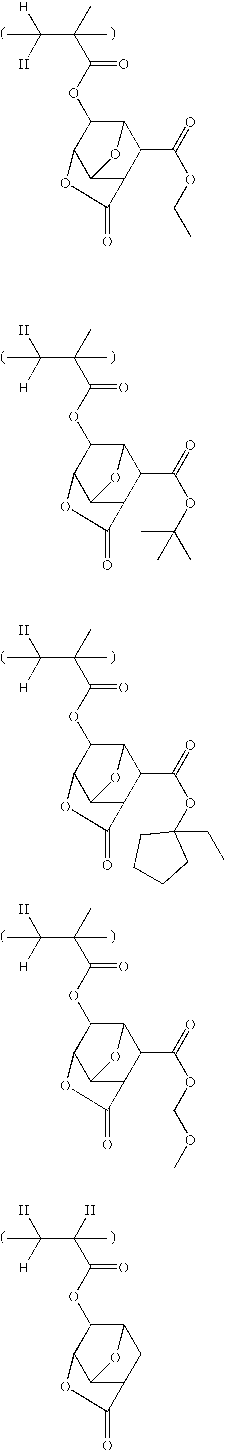

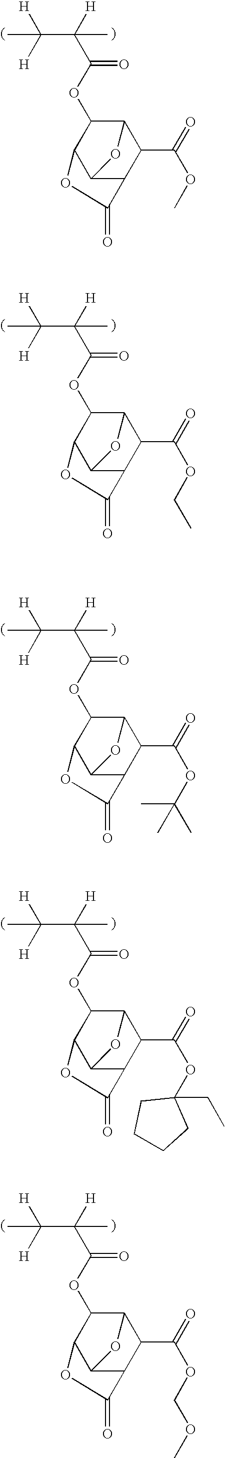

Illustrative, non-limiting examples of the recurring units of formula (1) wherein R² is (R²-4) are given below.

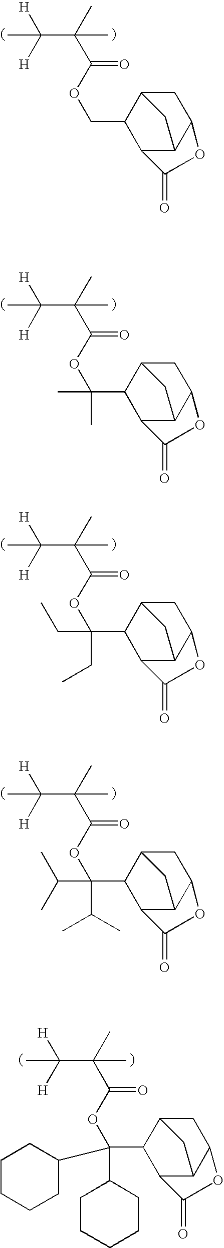

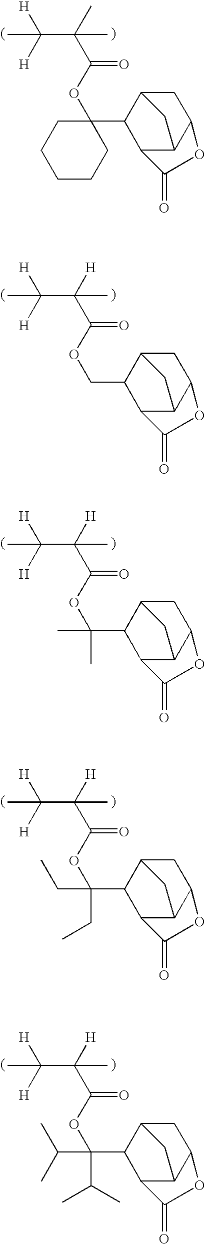

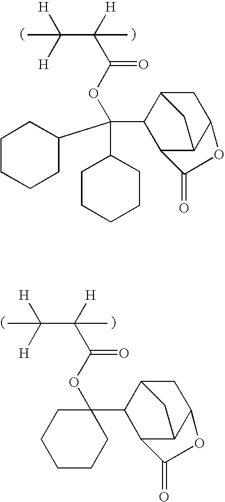

In formula (2), R⁴ is a straight, branched or cyclic alkylene group of 1 to 20 carbon atoms, preferably 1 to 15 carbon atoms, in which hydrogen atoms may be replaced by the oxygen (═O) of an oxygen-containing functional group such as carbonyl and/or which may have an oxygen atom intervening in a carbon-to-carbon bond.

Illustrative, non-limiting examples of the recurring units of formula (2) are given below.

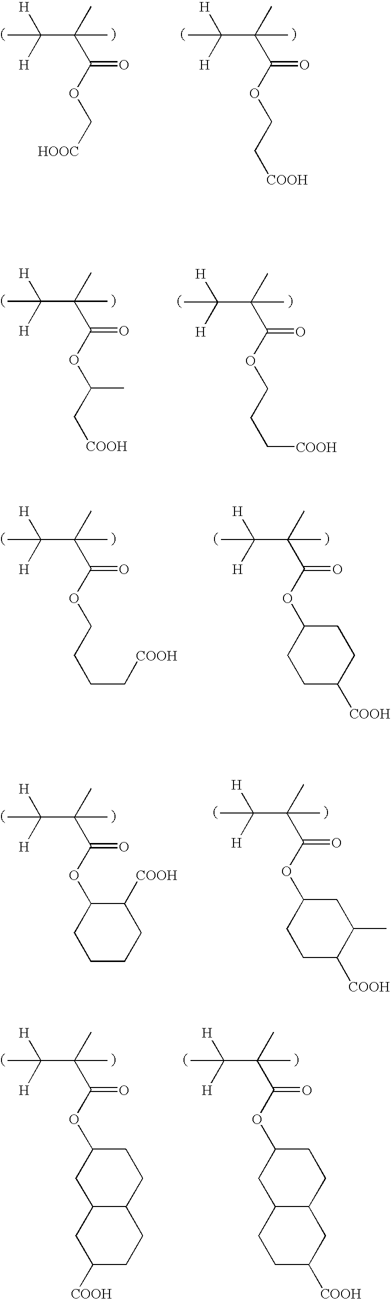

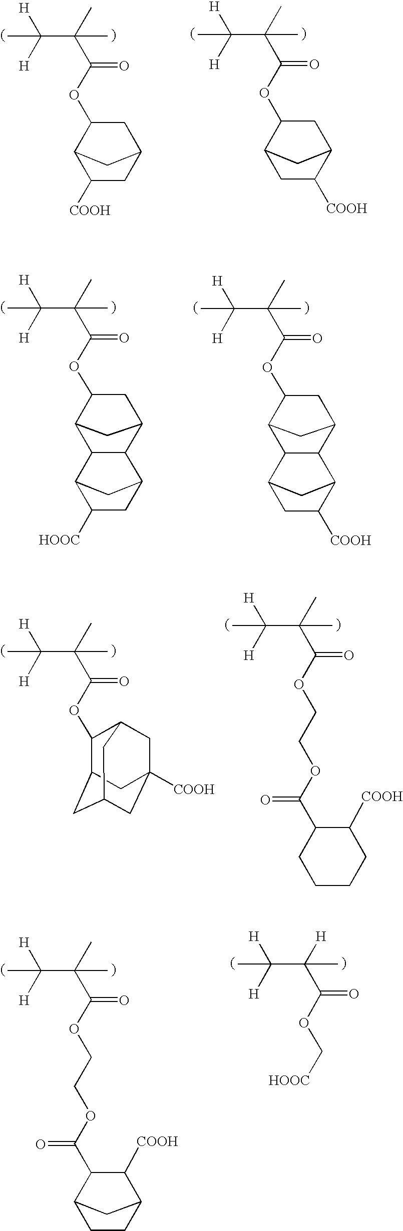

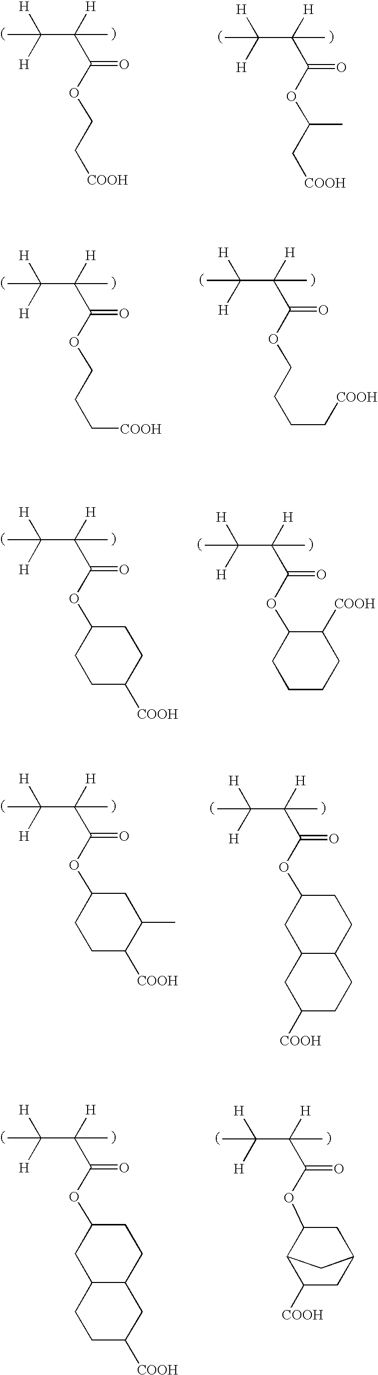

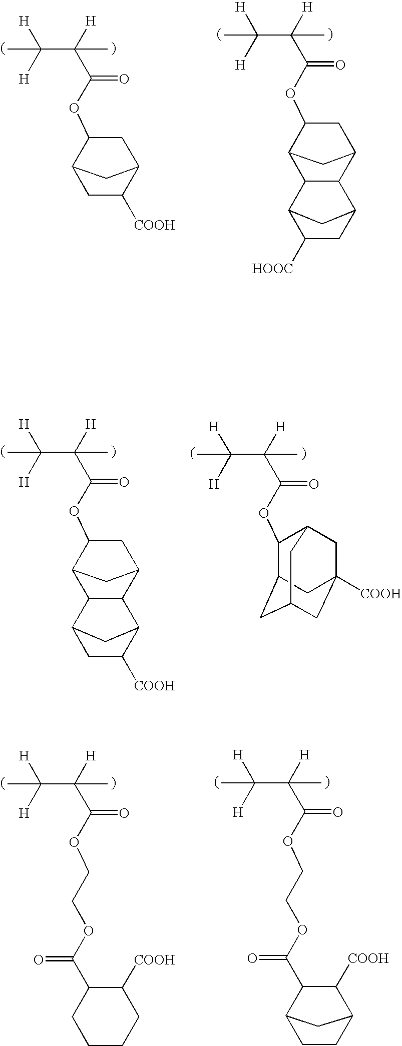

In a preferred embodiment, the polymer of the invention comprises recurring units having the general formulae (1) to (3), the recurring units being of at least one type for each formula. The polymer should have a weight average molecular weight of 1,000 to 50,000.

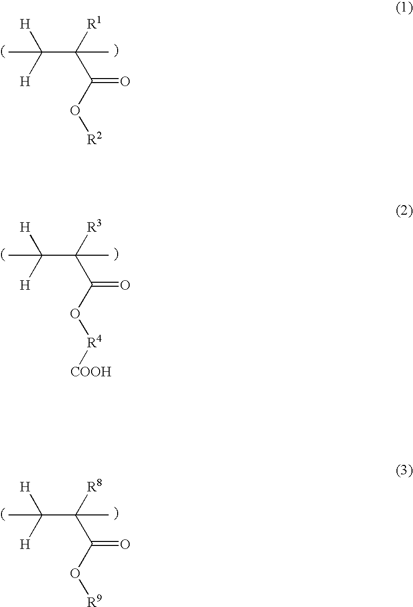

The formulae (1) and (2) are as described above. In formula (3), R⁸ stands for hydrogen or methyl, independent of R¹ and R³. R⁹ is an acid-labile protective group selected from the general formulae (R⁹-1) and (R⁹-2).

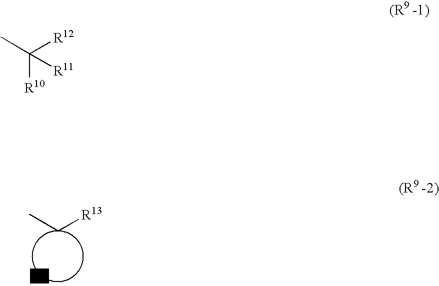

In the formulae, R¹⁰, R¹¹ and R¹² are each independently selected from straight, branched or cyclic alkyl groups of 1 to 15 carbon atoms, for example, methyl, ethyl, propyl, isopropyl, n-butyl, sec-butyl, tert-butyl, tert-amyl, n-pentyl, n-hexyl, cyclopentyl, cyclohexyl, 1-norbornyl, 2-norbornyl, 1-adamantyl and 2-adamantyl. R¹³ is a straight or branched alkyl group of 1 to 15 carbon atoms, for example, methyl, ethyl, propyl, isopropyl, n-butyl, sec-butyl, tert-butyl, tert-amyl, n-pentyl or n-hexyl. Z forms cyclopentane, cyclohexane or adamantane with the carbon atom to which it is attached.

Illustrative, non-limiting examples of the recurring units of formula (3) wherein R⁹ is (R⁹-1) are given below.

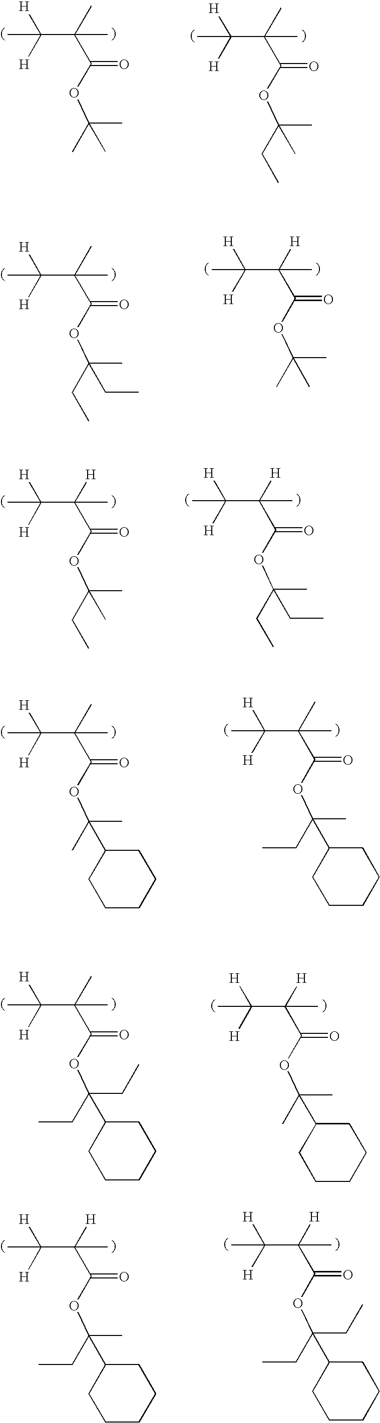

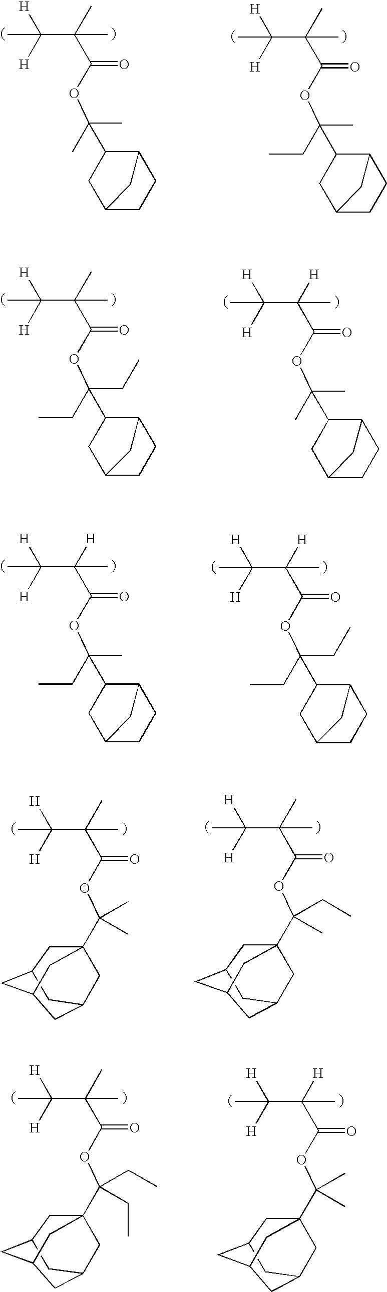

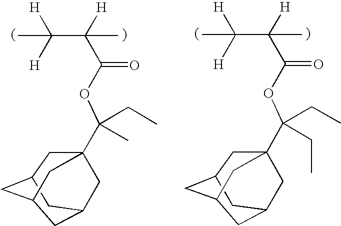

Illustrative, non-limiting examples of the recurring units of formula (3) wherein R⁹ is (R⁹-2) are given below.

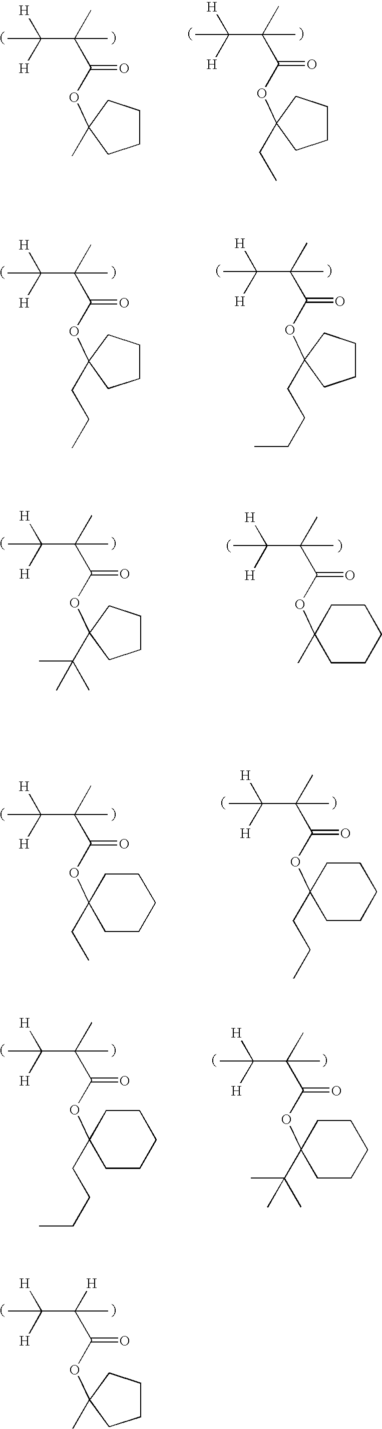

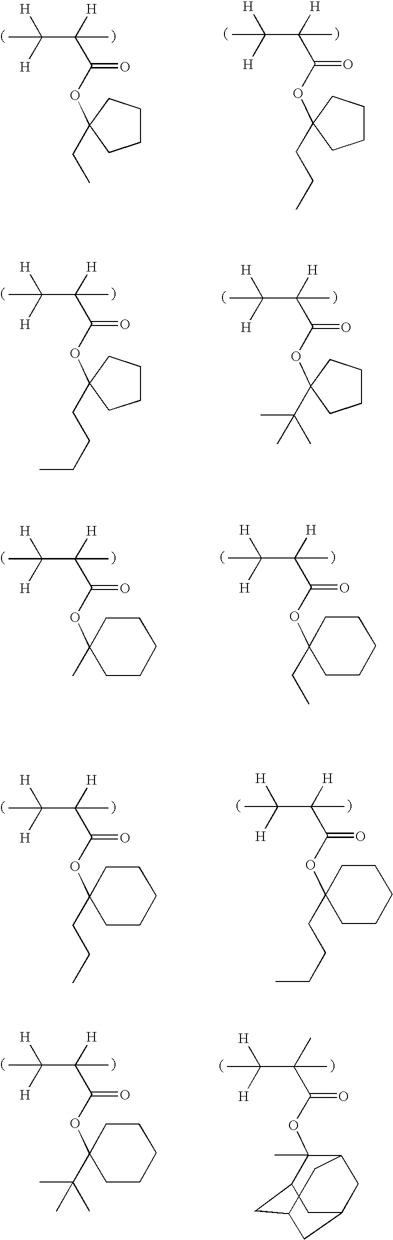

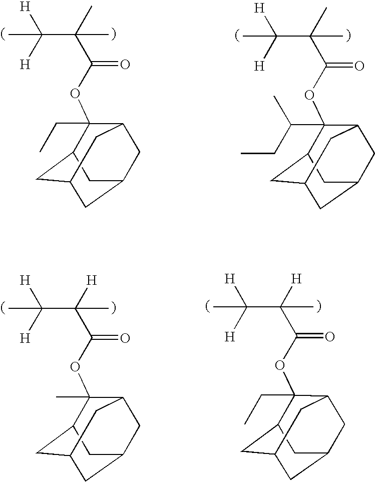

In a further preferred embodiment, the polymer of the invention comprises recurring units having the general formulae (1) to (4), the recurring units being of at least one type for each formula. The polymer should have a weight average molecular weight of 1,000 to 50,000.

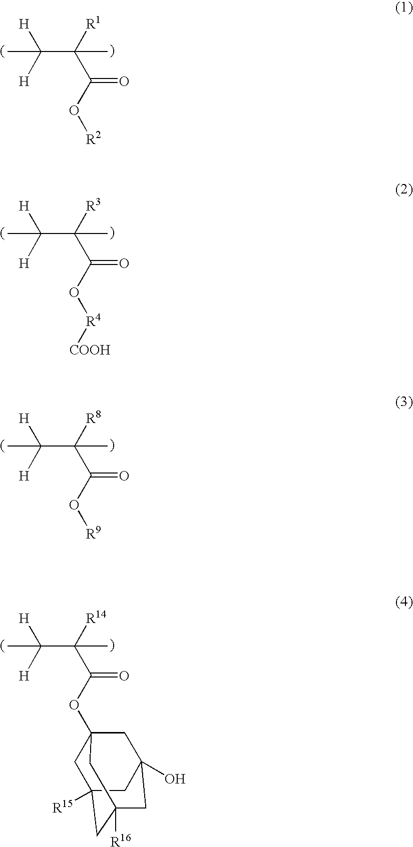

The formulae (1), (2) and (3) are as described above. In formula (4), R¹⁴ stands for hydrogen or methyl, independent of R¹, R³ and R⁸. R¹⁵ and R¹⁶ are each independently hydrogen or hydroxyl.

Illustrative, non-limiting examples of the recurring units of formula (4) are given below.

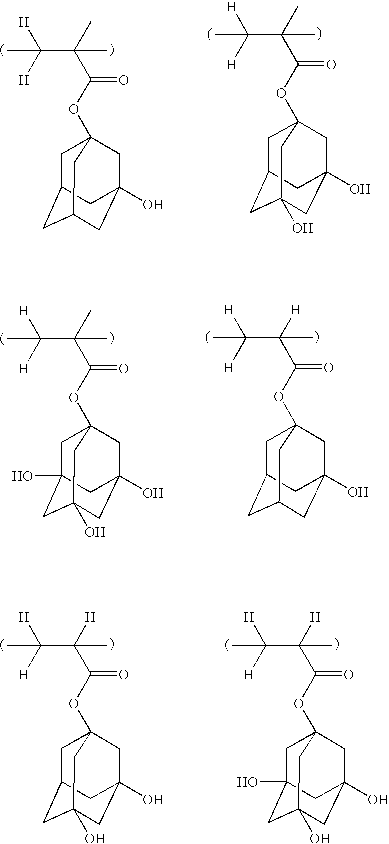

The polymers of the invention should have a weight average molecular weight (Mw) of 1,000 to 50,000, as measured by gel permeation chromatography (GPC) relative to polystyrene standards. Outside the range, there may occur an extreme drop of etch resistance, an obscured contrast of dissolution rate before and after exposure and hence a decline of resolution.

The polymers of the invention can be prepared by copolymerization reaction using compounds having the general formulae (1a) and (2a) as first and second monomers, optionally a compound having the general formula (3a) as a third monomer, and further optionally a compound having the general formula (4a) as a fourth monomer.

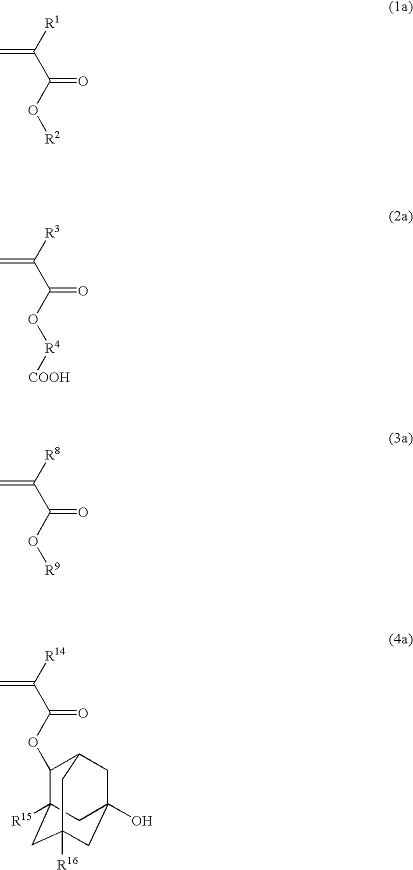

Herein, R¹ to R⁴, R⁸ to R⁹, and R¹⁴ to R¹⁶ are as defined above.

By suitably adjusting the proportion of the respective monomers in the copolymerization reaction, a polymer can be prepared that exerts better performance when formulated in a resist composition.

In addition to (i) monomers having formulae (1a) and (2a), (ii) a monomer having formula (3a), and (iii) a monomer having formula (4a), the inventive polymer may have further copolymerized therein (iv) at least one monomer having a carbon-to-carbon double bond other than (i) to (iii). Illustrative, non-limiting examples of the additional monomers include substituted acrylates such as methyl methacrylate, methyl crotonate, dimethyl maleate and dimethyl itaconate; unsaturated carboxylic acids such as maleic acid, fumaric acid and itaconic acid; substituted norbornenes such as norbornene and methyl norbornene-5-carboxylate; unsaturated acid anhydrides such as maleic anhydride and itaconic anhydride, and the like.

In the polymers of the invention, the preferred proportions of respective recurring units derived from the foregoing monomers are in the following ranges though not limited thereto.

The recurring units having formula (1) derived from a monomer having formula (1a) may be typically included in an amount of 3 to 80 mol %, preferably 5 to 70 mol %, and more preferably 8 to 60 mol %.

The recurring units having formula (2) derived from a monomer having formula (2a) may be typically included in an amount of 3 to 50 mol %, preferably 5 to 40 mol %, and more preferably 5 to 30 mol %.

The recurring units having formula (3) derived from a monomer having formula (3a) may be typically included in an amount of 3 to 90 mol %, preferably 5 to 80 mol %, and more preferably 10 to 70 mol %.

The recurring units having formula (4) derived from a monomer having formula (4a) may be typically included in an amount of 3 to 80 mol %, preferably 5 to 70 mol %, and more preferably 10 to 60 mol %.

The other recurring units derived from an additional monomer may be typically included in an amount of 0 to 60 mol %, preferably 0 to 40 mol %, and more preferably 0 to 30 mol %.

Monomers having formula (1a) from which units having formula (1) essentially included in the inventive polymer are derived are commercially available. Besides, monomers from which units having formula (1) wherein R² is (R²-1) are derived can be prepared by the method described in JP-A 2000-159758; monomers from which units having formula (1) wherein R² is (R²-2) or (R²-3) are derived can be prepared by the method described in JP-A 2002-371114; monomers from which units having formula (1) wherein R² is (R²-4) and R⁶ is hydrogen are derived can be prepared by the method described in JP-A 2003-002883; monomers from which units having formula (1) wherein R² is (R²-4) and R⁶ is other than hydrogen are derived can be prepared by the method described in JP-A 2004-115486. Monomers having formula (2a) from which units having formula (2) essentially included in the inventive polymer are derived can be prepared by well-known organochemical procedures.

Monomers having formula (3a) from which units having formula (3) are derived are commercially available and may be prepared by well-known organochemical procedures using norbornane carboxylate esters, adamantane carboxylate esters, cyclopentanone, cyclohexanone and adamantanone as starting reactants.

Monomers having formula (4a) from which units having formula (4) are derived are commercially available and may be prepared by well-known organochemical procedures using hydroxyadamantanes as starting reactants.

The polymer can be synthesized by a variety of copolymerization reactions, preferably radical polymerization. Preferred conditions for the radical polymerization include (a) solvents, for example, hydrocarbons such as benzene, ethers such as tetrahydrofuran and propylene glycol monomethyl ether acetal, alcohols such as ethanol, ketones such as methyl ethyl ketone and methyl isobutyl ketone, and esters such as ethyl acetate and γ-butyrolactone; (b) polymerization initiators, for example, azo compounds such as 2,2′-azobisisobutyronitrile and dimethyl-2,2′-azobis(2-methylpropionate) and peroxides such as benzoyl peroxide and lauroyl peroxide; (c) reaction temperatures in the range of about 0° C. to about 100° C.; and (d) reaction times in the range of about 0.5 to about 48 hours. The reaction can be effected outside the ranges, with the results being acceptable.

Resist Composition

Advantageously, the polymer of the invention is used as a base resin in a resist composition, especially a chemically amplified positive resist composition. Therefore, the present invention in the second aspect provides a resist composition, especially a chemically amplified positive resist composition, comprising the above-described polymer as a base resin.

The chemically amplified positive resist composition is typically comprised of (A) the above-described polymer as a base resin, (B) a photoacid generator, and (C) an organic solvent. Optionally, the resist composition further includes (D) an acid amplifier compound, (E) another polymer other than component (A) (if used, the base resin in the resist composition consists of components (A) and (E)), (F) a dissolution regulator, (G) a nitrogen-containing organic compound or basic compound, (H) a compound having a group ≡C—COOH in a molecule, (I) an acetylene alcohol derivative, and (J) a surfactant.

Photoacid Generator

The photoacid generator may be any compound capable of generating an acid upon exposure to high energy radiation or electron beam. Preferred photoacid generators are sulfonium salts, iodonium salts, sulfonyldiazomethanes, and N-sulfonyloxyimides. These photoacid generators are illustrated below while they may be used alone or in admixture of two or more.

Sulfonium salts are salts of sulfonium cations with sulfonates. Exemplary sulfonium cations include triphenylsulfonium, (4-tert-butoxyphenyl)diphenylsulfonium, bis(4-tert-butoxyphenyl)phenylsulfonium, tris(4-tert-butoxyphenyl)sulfonium, (3-tert-butoxyphenyl)diphenylsulfonium, bis(3-tert-butoxyphenyl)phenylsulfonium, tris(3-tert-butoxyphenyl)sulfonium, (3,4-di-tert-butoxyphenyl)diphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, (4-tert-butoxycarbonylmethyloxyphenyl)diphenylsulfonium, tris(4-tert-butoxycarbonylmethyloxyphenyl)sulfonium, (4-tert-butoxyphenyl)bis(4-dimethylaminophenyl)sulfonium, tris(4-dimethylaminophenyl)sulfonium, 2-naphthyldiphenylsulfonium, dimethyl-2-naphthylsulfonium, 4-hydroxyphenyldimethylsulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, and 2-oxo-2-phenylethylthiacyclopentanium. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4′-toluenesulfonyloxy)benzenesulfonate, naphthalenesulfonate, camphorsulfonate, octanesulfonate, dodecylbenzenesulfonate, butanesulfonate, and methanesulfonate. Sulfonium salts based on combination of the foregoing examples are included.

Iodinium salts are salts of iodonium cations with sulfonates. Exemplary iodinium cations are aryliodonium cations including diphenyliodinium, bis(4-tert-butylphenyl)iodonium, 4-tert-butoxyphenylphenyliodonium, and 4-methoxyphenylphenyliodonium. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4′-toluenesulfonyloxy)benzenesulfonate, naphthalenesulfonate, camphorsulfonate, octanesulfonate, dodecylbenzenesulfonate, butanesulfonate, and methanesulfonate. Iodonium salts based on combination of the foregoing examples are included.

Exemplary sulfonyldiazomethane compounds include bissulfonyldiazomethane compounds and sulfonyl-carbonyldiazomethane compounds such as bis(ethylsulfonyl)diazomethane, bis(l-methylpropylsulfonyl)diazomethane, bis(2-methylpropylsulfonyl)diazomethane, bis(1,1-dimethylethylsulfonyl)diazomethane, bis(cyclohexylsulfonyl)diazomethane, bis(perfluoroisopropylsulfonyl)diazomethane, bis(phenylsulfonyl)diazomethane, bis(4-methylphenylsulfonyl)diazomethane, bis(2,4-dimethylphenylsulfonyl)diazomethane, bis(2-naphthylsulfonyl)diazomethane, bis(4-acetyloxyphenylsulfonyl)diazomethane, bis(4-methanesulfonyloxyphenylsulfonyl)diazomethane, bis(4-(4-toluenesulfonyloxy)phenylsulfonyl)diazomethane, bis(4-(n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, 4-methylphenylsulfonylbenzoyldiazomethane, tert-butylcarbonyl-4-methylphenylsulfonyldiazomethane, 2-naphthylsulfonylbenzoyldiazomethane, 4-methylphenylsulfonyl-2-naphthoyldiazomethane, methylsulfonylbenzoyldiazomethane, and tert-butoxycarbonyl-4-methylphenylsulfonyldiazomethane.

N-sulfonyloxyimide photoacid generators include combinations of imide skeletons with sulfonates. Exemplary imide skeletons are succinimide, naphthalene dicarboxylic acid imide, phthalimide, cyclohexyldicarboxylic acid imide, 5-norbornene-2,3-dicarboxylic acid imide, and 7-oxabicyclo[2.2.1]-5-heptene-2,3-dicarboxylic acid imide. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, naphthalenesulfonate, camphorsulfonate, octanesulfonate, dodecylbenzenesulfonate, butanesulfonate, and methanesulfonate.

Benzoinsulfonate photoacid generators include benzoin tosylate, benzoin mesylate, and benzoin butanesulfonate.

Pyrogallol trisulfonate photoacid generators include pyrogallol, fluoroglycinol, catechol, resorcinol, and hydroquinone, in which all the hydroxyl groups are replaced by trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, and methanesulfonate.

Nitrobenzyl sulfonate photoacid generators include 2,4-dinitrobenzyl sulfonates, 2-nitrobenzyl sulfonates, and 2,6-dinitrobenzyl sulfonates, with exemplary sulfonates including trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, and methanesulfonate. Also useful are analogous nitrobenzyl sulfonate compounds in which the nitro group on the benzyl side is replaced by a trifluoromethyl group.

Sulfone photoacid generators include bis(phenylsulfonyl)methane, bis(4-methylphenylsulfonyl)methane, bis(2-naphthylsulfonyl)methane, 2,2-bis(phenylsulfonyl)propane, 2,2-bis(4-methylphenylsulfonyl)propane, 2,2-bis(2-naphthylsulfonyl)propane, 2-methyl-2-(p-toluenesulfonyl)propiophenone, 2-cyclohexylcarbonyl-2-(p-toluenesulfonyl)propane, and 2,4-dimethyl-2-(p-toluenesulfonyl)pentan-3-one.

Photoacid generators in the form of glyoxime derivatives are as described in Japanese Patent No. 2,906,999 and JP-A 9-301948. Examples include bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(methanesulfonyl)-α-dimethylglyoxime, bis-O-(trifluoromethanesulfonyl)-α-dimethylglyoxime, bis-O-(2,2,2-trifluoroethanesulfonyl)-α-dimethylglyoxime, bis-O-(10-camphorsulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-trifluoromethylbenzenesulfonyl)-α-dimethylglyoxime, bis-O-(xylenesulfonyl)-α-dimethylglyoxime, bis-O-(trifluoromethanesulfonyl)-nioxime, bis-O-(2,2,2-trifluoroethanesulfonyl)-nioxime, bis-O-(10-camphorsulfonyl)-nioxime, bis-O-(benzenesulfonyl)-nioxime, bis-O-(p-fluorobenzenesulfonyl)-nioxime, bis-O-(p-trifluoromethylbenzenesulfonyl)-nioxime, and bis-O-(xylenesulfonyl)-nioxime.

Also included are the oxime sulfonates described in U.S. Pat. No. 6,004,724, for example, (5-(4-toluenesulfonyl)oxyimino-5H-thiophen-2-ylidene)phenyl-acetonitrile, (5-(10-camphorsulfonyl)oxyimino-5H-thiophen-2-ylidene)phenyl-acetonitrile, (5-n-octanesulfonyloxyimino-5H-thiophen-2-ylidene)phenyl-acetonitrile, (5-(4-toluenesulfonyl)oxyimino-5H-thiophen-2-ylidene)(2-methylphenyl)acetonitrile, (5-(10-camphorsulfonyl)oxyimino-5H-thiophen-2-ylidene)(2-methylphenyl)acetonitrile, (5-n-octanesulfonyloxyimino-5H-thiophen-2-ylidene)(2-methylphenyl)acetonitrile, etc.

Also included are the oxime sulfonates described in U.S. Pat. No. 6,261,738 and JP-A 2000-314956, for example, 2,2,2-trifluoro-1-phenyl-ethanone oxime-O-methylsulfonate; 2,2,2-trifluoro-1-phenyl-ethanone oxime-O-(10-camphoryl-sulfonate); 2,2,2-trifluoro-1-phenyl-ethanone oxime-O-(4-methoxyphenylsulfonate); 2,2,2-trifluoro-1-phenyl-ethanone oxime-O-(1-naphthylsulfonate); 2,2,2-trifluoro-1-phenyl-ethanone oxime-O-(2-naphthylsulfonate); 2,2,2-trifluoro-1-phenyl-ethanone oxime-O-(2,4,6-trimethylphenylsulfonate); 2,2,2-trifluoro-1-(4-methylphenyl)-ethanone oxime-O-(10-camphorylsulfonate); 2,2,2-trifluoro-1-(4-methylphenyl)-ethanone oxime-O-(methylsulfonate); 2,2,2-trifluoro-1-(2-methylphenyl)-ethanone oxime-O-(10-camphorylsulfonate); 2,2,2-trifluoro-1-(2,4-dimethylphenyl)-ethanone oxime-O-(10-camphorylsulfonate); 2,2,2-trifluoro-1-(2,4-dimethylphenyl)-ethanone oxime-O-(1-naphthylsulfonate); 2,2,2-trifluoro-1-(2,4-dimethylphenyl)-ethanone oxime-O-(2-naphthylsulfonate); 2,2,2-trifluoro-1-(2,4,6-trimethylphenyl)-ethanone oxime-O-(10-camphorylsulfonate); 2,2,2-trifluoro-1-(2,4,6-trimethylphenyl)-ethanone oxime-O-(1-naphthylsulfonate); 2,2,2-trifluoro-1-(2,4,6-trimethylphenyl)-ethanone oxime-O-(2-naphthylsulfonate); 2,2,2-trifluoro-1-(4-methoxyphenyl)-ethanone oxime-O-methylsulfonate; 2,2,2-trifluoro-1-(4-methylthiophenyl)-ethanone oxime-O-methylsulfonate; 2,2,2-trifluoro-1-(3,4-dimethoxyphenyl)-ethanone oxime-O-methylsulfonate; 2,2,3,3,4,4,4-heptafluoro-1-phenyl-butanone oxime-O-(10-camphorylsulfonate); 2,2,2-trifluoro-1-(phenyl)-ethanone oxime-O-methylsulfonate; 2,2,2-trifluoro-1-(phenyl)-ethanone oxime-O-10-camphorylsulfonate; 2,2,2-trifluoro-1-(phenyl)-ethanone oxime-O-(4-methoxyphenyl)sulfonate; 2,2,2-trifluoro-1-(phenyl)-ethanone oxime-O-(1-naphthyl)-sulfonate; 2,2,2-trifluoro-1-(phenyl)-ethanone oxime-O-(2-naphthyl)sulfonate; 2,2,2-trifluoro-1-(phenyl)-ethanone oxime-O-(2,4,6-trimethylphenyl)sulfonate; 2,2,2-trifluoro-1-(4-methylphenyl)-ethanone oxime-O-(10-camphoryl)sulfonate; 2,2,2-trifluoro-1-(4-methylphenyl)-ethanone oxime-O-methylsulfonate; 2,2,2-trifluoro-1-(2-methylphenyl)-ethanone oxime-O-(10-camphoryl)sulfonate; 2,2,2-trifluoro-1-(2,4-dimethylphenyl)-ethanone oxime-O-(1-naphthyl)sulfonate; 2,2,2-trifluoro-1-(2,4-dimethylphenyl)-ethanone oxime-O-(2-naphthyl)sulfonate; 2,2,2-trifluoro-1-(2,4,6-trimethylphenyl)-ethanone oxime-O-(10-camphoryl)sulfonate; 2,2,2-trifluoro-1-(2,4,6-trimethylphenyl)-ethanone oxime-O-(1-naphthyl)sulfonate; 2,2,2-trifluoro-1-(2,4,6-trimethylphenyl)-ethanone oxime-O-(2-naphthyl)sulfonate; 2,2,2-trifluoro-1-(4-methoxyphenyl)-ethanone oxime-O-methylsulfonate; 2,2,2-trifluoro-1-(4-thiomethylphenyl)-ethanone oxime-O-methylsulfonate; 2,2,2-trifluoro-1-(3,4-dimethoxyphenyl)-ethanone oxime-O-methylsulfonate; 2,2,2-trifluoro-1-(4-methoxyphenyl)-ethanone oxime-O-(4-methylphenyl)sulfonate; 2,2,2-trifluoro-1-(4-methoxyphenyl)-ethanone oxime-O-(4-methoxyphenyl)sulfonate; 2,2,2-trifluoro-1-(4-methoxyphenyl)-ethanone oxime-O-(4-dodecylphenyl)-sulfonate; 2,2,2-trifluoro-1-(4-methoxyphenyl)-ethanone oxime-O-octylsulfonate; 2,2,2-trifluoro-1-(4-thiomethyl-phenyl)-ethanone oxime-O-(4-methoxyphenyl)sulfonate; 2,2,2-trifluoro-1-(4-thiomethylphenyl)-ethanone oxime-O-(4-dodecylphenyl)sulfonate; 2,2,2-trifluoro-1-(4-thiomethyl-phenyl)-ethanone oxime-O-octylsulfonate; 2,2,2-trifluoro-1-(4-thiomethylphenyl)-ethanone oxime-O-(2-naphthyl)sulfonate; 2,2,2-trifluoro-1-(2-methylphenyl)-ethanone oxime-O-methylsulfonate; 2,2,2-trifluoro-1-(4-methylphenyl)ethanone oxime-O-phenylsulfonate; 2,2,2-trifluoro-1-(4-chlorophenyl)-ethanone oxime-O-phenylsulfonate; 2,2,3,3,4,4,4-heptafluoro-1-(phenyl)-butanone oxime-O-(10-camphoryl)sulfonate; 2,2,2-trifluoro-1-naphthyl-ethanone oxime-O-methylsulfonate; 2,2,2-trifluoro-2-naphthyl-ethanone oxime-O-methylsulfonate; 2,2,2-trifluoro-1-[4-benzylphenyl]-ethanone oxime-O-methylsulfonate; 2,2,2-trifluoro-1-[4-(phenyl-1,4-dioxa-but-1-yl)phenyl]-ethanone oxime-O-methylsulfonate; 2,2,2-trifluoro-1-naphthyl-ethanone oxime-O-propylsulfonate; 2,2,2-trifluoro-2-naphthyl-ethanone oxime-O-propylsulfonate; 2,2,2-trifluoro-1-[4-benzylphenyl]-ethanone oxime-O-propylsulfonate; 2,2,2-trifluoro-1-[4-methylsulfonylphenyl]-ethanone oxime-O-propylsulfonate; 1,3-bis[l-(4-phenoxy-phenyl)-2,2,2-trifluoroethanone oxime-O-sulfonyl]phenyl; 2,2,2-trifluoro-1-[4-methylsulfonyloxyphenyl]-ethanone oxime-O-propylsulfonate; 2,2,2-trifluoro-1-[4-methylcarbonyloxy-phenyl]-ethanone oxime-O-propylsulfonate; 2,2,2-trifluoro-1-[6H,7H-5,8-dioxonaphth-2-yl]-ethanone oxime-O-propyl-sulfonate; 2,2,2-trifluoro-1-[4-methoxycarbonylmethoxy-phenyl]-ethanone oxime-O-propylsulfonate; 2,2,2-trifluoro-1-[4-(methoxycarbonyl)-(4-amino-1-oxa-pent-1-yl)-phenyl]-ethanone oxime-O-propylsulfonate; 2,2,2-trifluoro-1-[3,5-dimethyl-4-ethoxyphenyl]-ethanone oxime-O-propylsulfonate; 2,2,2-trifluoro-1-[4-benzyloxyphenyl]-ethanone oxime-O-propylsulfonate; 2,2,2-trifluoro-1-[2-thiophenyl)-ethanone oxime-O-propylsulfonate; and 2,2,2-trifluoro-1-[1-dioxa-thiophen-2-yl)]-ethanone oxime-O-propylsulfonate.

Also included are the oxime sulfonates described in JP-A 9-95479 and JP-A 9-230588 and the references cited therein, for example, α-(p-toluenesulfonyloxyimino)-phenylacetonitrile, α-(p-chlorobenzenesulfonyloxyimino)-phenylacetonitrile, α-(4-nitrobenzenesulfonyloxyimino)-phenylacetonitrile, α-(4-nitro-2-trifluoromethylbenzenesulfonyloxyimino)-phenylacetonitrile, α-(benzenesulfonyloxyimino)-4-chlorophenylacetonitrile, α-(benzenesulfonyloxyimino)-2,4-dichlorophenylacetonitrile, α-(benzenesulfonyloxyimino)-2,6-dichlorophenylacetonitrile, α-(benzenesulfonyloxyimino)-4-methoxyphenylacetonitrile, α-(2-chlorobenzenesulfonyloxyimino)-4-methoxyphenylacetonitrile, α-(benzenesulfonyloxyimino)-2-thienylacetonitrile, α-(4-dodecylbenzenesulfonyloxyimino)-phenylacetonitrile, α-[(4-toluenesulfonyloxyimino)-4-methoxyphenyl]acetonitrile, α-[(dodecylbenzenesulfonyloxyimino)-4-methoxyphenyl]-acetonitrile, α-(tosyloxyimino)-3-thienylacetonitrile, α-(methylsulfonyloxyimino)-1-cyclopentenylacetonitrile, α-(ethylsulfonyloxyimino)-1-cyclopentenylacetonitrile, α-(isopropylsulfonyloxyimino)-1-cyclopentenylacetonitrile, α-(n-butylsulfonyloxyimino)-1-cyclopentenylacetonitrile, α-(ethylsulfonyloxyimino)-1-cyclohexenylacetonitrile, α-(isopropylsulfonyloxyimino)-1-cyclohexenylacetonitrile, and α-(n-butylsulfonyloxyimino)-1-cyclohexenylacetonitrile.

Suitable bisoxime sulfonates include those described in JP-A 9-208554, for example, bis(α-(4-toluenesulfonyloxy)imino)-p-phenylenediacetonitrile, bis(α-(benzenesulfonyloxy)imino)-p-phenylenediacetonitrile, bis(α-(methanesulfonyloxy)imino)-p-phenylenediacetonitrile, bis(α-(butanesulfonyloxy)imino)-p-phenylenediacetonitrile, bis(α-(10-camphorsulfonyloxy)imino)-p-phenylenediacetonitrile, bis(α-(4-toluenesulfonyloxy)imino)-p-phenylenediacetonitrile, bis(α-(trifluoromethanesulfonyloxy)imino)-p-phenylene-diacetonitrile, bis(α-(4-methoxybenzenesulfonyloxy)imino)-p-phenylene-diacetonitrile, bis(α-(4-toluenesulfonyloxy)imino)-m-phenylenediacetonitrile, bis(α-(benzenesulfonyloxy)imino)-m-phenylenediacetonitrile, bis(α-(methanesulfonyloxy)imino)-m-phenylenediacetonitrile, bis(α-(butanesulfonyloxy)imino)-m-phenylenediacetonitrile, bis(α-(10-camphorsulfonyloxy)imino)-m-phenylenediacetonitrile, bis(α-(4-toluenesulfonyloxy)imino)-m-phenylenediacetonitrile, bis(α-(trifluoromethanesulfonyloxy)imino)-m-phenylene-diacetonitrile, bis(α-(4-methoxybenzenesulfonyloxy)imino)-m-phenylene-diacetonitrile, etc.

Of the photoacid generators, sulfonium salts, bissulfonyldiazomethanes, N-sulfonyloxyimides and glyoxime derivatives are preferred, with the sulfonium salts, bissulfonyldiazomethanes, and N-sulfonyloxyimides being most preferred. Illustrative examples include triphenylsulfonium p-toluenesulfonate, triphenylsulfonium camphorsulfonate, triphenylsulfonium pentafluorobenzenesulfonate, triphenylsulfonium nonafluorobutanesulfonate, triphenylsulfonium 4-(4′-toluenesulfonyloxy)benzenesulfonate, triphenylsulfonium 2,4,6-triisopropylbenzenesulfonate, 4-tert-butoxyphenyldiphenylsulfonium p-toluenesulfonate, 4-tert-butoxyphenyldiphenylsulfonium camphorsulfonate, 4-tert-butoxyphenyldiphenylsulfonium 4-(4′-toluene-sulfonyloxy)benzenesulfonate, tris(4-methylphenyl)sulfonium camphorsulfonate, tris(4-tert-butylphenyl)sulfonium camphorsulfonate, bis(tert-butylsulfonyl)diazomethane, bis(cyclohexylsulfonyl)diazomethane, bis(2,4-dimethylphenylsulfonyl)diazomethane, bis(4-(n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, bis(4-tert-butylphenylsulfonyl)diazomethane, N-camphorsulfonyloxy-5-norbornene-2,3-dicarboxylic acid imide, and N-p-toluenesulfonyloxy-5-norbornene-2,3-dicarboxylic acid imide.

In the chemically amplified resist composition of the invention, the photoacid generator may be added in any desired amount, typically from 0.1 to 10 parts, preferably from 0.1 to 5 parts by weight, per 100 parts by weight of the base resin in the composition. Excessive amounts of the photoacid generator may degrade resolution and give rise to a problem of foreign matter during development and resist peeling. The photoacid generators may be used alone or in admixture. It is also possible to use a photoacid generator having a low transmittance at the exposure wavelength in a controlled amount so as to adjust the transmittance of a resist coating.

Acid-Amplifier

In the resist composition of the invention, there may be added a compound which is decomposed with an acid to generate another acid, that is, acid-amplifier compound. For these compounds, reference should be made to J. Photopolym. Sci. and Tech., 8, 43-44, 45-46 (1995), and ibid., 9, 29-30 (1996).

Examples of the acid-amplifier compound include tert-butyl 2-methyl-2-tosyloxymethylacetoacetate and 2-phenyl 2-(2-tosyloxyethyl)-1,3-dioxolane, but are not limited thereto. Of well-known photoacid generators, many of those compounds having poor stability, especially poor thermal stability exhibit an acid-amplifier compound-like behavior.

In the resist composition of the invention, an appropriate amount of the acid-amplifier compound is up to 2 parts, and especially up to 1 part by weight per 100 parts by weight of the base resin in the composition. Excessive amounts of the acid-amplifier compound makes diffusion control difficult, leading to degradation of resolution and pattern profile.

Solvent

The organic solvent used herein may be any organic solvent in which the base resin, photoacid generator, and other components are soluble. Illustrative, non-limiting, examples of the organic solvent include ketones such as cyclohexanone and methyl 2-n-amyl ketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate; and lactones such as γ-butyrolactone. These solvents may be used alone or in combinations of two or more thereof. Of the above organic solvents, it is recommended to use diethylene glycol dimethyl ether, 1-ethoxy-2-propanol, propylene glycol monomethyl ether acetate, or a mixture thereof because the photoacid generator is most soluble therein.

An appropriate amount of the organic solvent used is about 200 to 1,000 parts, especially about 400 to 800 parts by weight per 100 parts by weight of the base resin.

Other Polymer

To the resist composition of the invention, another polymer other than the inventive polymer may also be added. The other polymers that can be added to the resist composition are, for example, those polymers comprising units of the following formula (R1) or (R2) and having a weight average molecular weight of about 1,000 to about 100,000, especially about 3,000 to about 30,000 although the other polymers are not limited thereto.

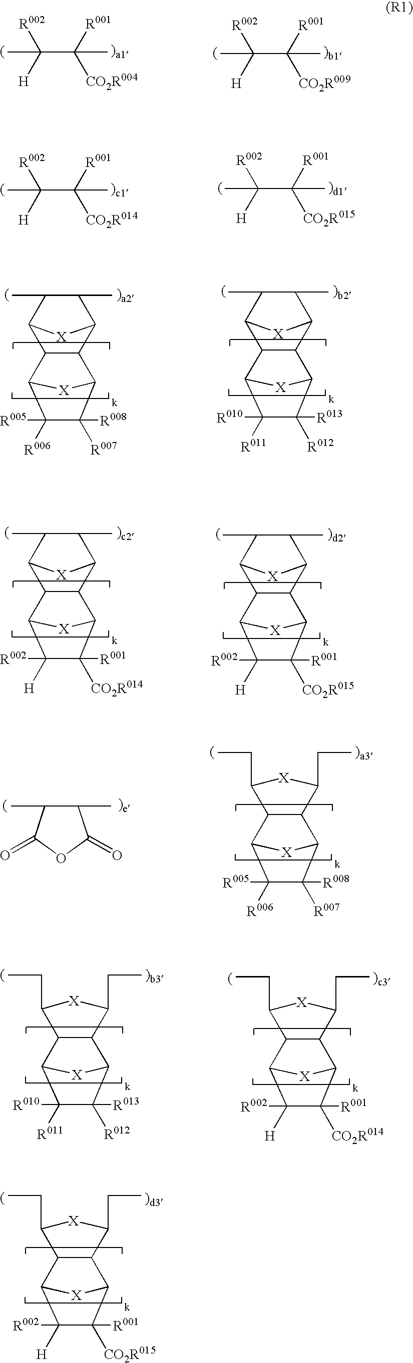

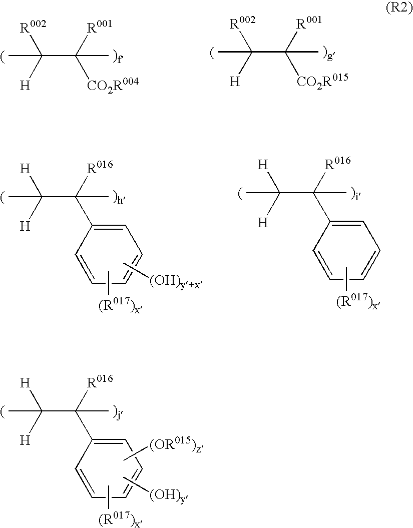

Herein, R⁰⁰¹ is hydrogen, methyl or CH₂CO₂R⁰⁰³. R⁰⁰² is hydrogen, methyl or CO₂R⁰⁰³. R⁰⁰³ is a straight, branched or cyclic C₁-C₁₅ alkyl group, for example, methyl, ethyl, propyl, isopropyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl, ethyladamantyl, and butyladamantyl. R⁰⁰⁴ is hydrogen or a monovalent C₁-C₁₅ hydrocarbon group having a carboxyl or hydroxyl group, for example, hydrogen, carboxyethyl, carboxybutyl, carboxycyclopentyl, carboxycyclohexyl, carboxynorbornyl, carboxyadamantyl, hydroxyethyl, hydroxybutyl, hydroxycyclopentyl, hydroxycyclohexyl, hydroxynorbornyl, and hydroxyadamantyl.

At least one of R⁰⁰⁵ to R⁰⁰⁸ represents a monovalent C₁-C₁₅ hydrocarbon group having a carboxyl or hydroxyl group while the remaining R's independently represent hydrogen or a straight, branched or cyclic C₁-C₁₅alkyl group. Examples of the carboxyl or hydroxyl-bearing monovalent C₁-C₁₅hydrocarbon group include carboxy, carboxymethyl, carboxyethyl, carboxybutyl, hydroxymethyl, hydroxyethyl, hydroxybutyl, 2-carboxyethoxycarbonyl, 4-carboxybutoxycarbonyl, 2-hydroxyethoxycarbonyl, 4-hydroxybutoxycarbonyl, carboxycyclopentyloxycarbonyl, carboxycyclohexyloxycarbonyl, carboxynorbornyloxycarbonyl, carboxyadamantyloxycarbonyl, hydroxycyclopentyloxycarbonyl, hydroxycyclohexyloxycarbonyl, hydroxynbrbornyloxycarbonyl, and hydroxyadamantyloxycarbonyl. Examples of the straight, branched or cyclic C₁-C₁₅ alkyl group are the same as exemplified for R⁰⁰³.

Alternatively, R⁰⁰⁵ to R⁰⁰⁸, taken together, may form a ring, and in that event, at least one of R⁰⁰⁵ to R⁰⁰⁸ is a divalent C₁-C₁₅hydrocarbon group having a carboxyl or hydroxyl group, while the remaining R's are independently single bonds or straight, branched or cyclic C₁-C₁₅alkylene groups. Examples of the carboxyl or hydroxyl-bearing divalent C₁-C₁₅ hydrocarbon group include the groups exemplified as the carboxyl or hydroxyl-bearing monovalent hydrocarbon group, with one hydrogen atom eliminated therefrom. Examples of the straight, branched or cyclic C₁-C₁₅ alkylene groups include the groups exemplified for R⁰⁰³, with one hydrogen atom eliminated therefrom.

R⁰⁰⁹ is a monovalent C₃-C₁₅ hydrocarbon group containing a —CO₂— partial structure, for example, 2-oxooxolan-3-yl, 4,4-dimethyl-2-oxooxolan-3-yl, 4-methyl-2-oxooxan-4-yl, 2-oxo-1,3-dioxolan-4-ylmethyl, and 5-methyl-2-oxooxolan-5-yl.

At least one of R⁰¹⁰ to R⁰¹³ is a monovalent C₂-C₁₅hydrocarbon group containing a —CO₂— partial structure, while the remaining R's are independently hydrogen or straight, branched or cyclic C₁-C₁₅ alkyl groups. Examples of the monovalent C₂-C₁₅hydrocarbon group containing a —CO₂— partial structure include 2-oxooxolan-3-yloxycarbonyl, 4,4-dimethyl-2-oxooxolan-3-yloxycarbonyl, 4-methyl-2-oxooxan-4-yloxycarbonyl, 2-oxo-1,3-dioxolan-4-ylmethyloxycarbonyl, and 5-methyl-2-oxooxolan-5-yloxycarbonyl. Examples of the straight, branched or cyclic C₁-C₁₅ alkyl groups are the same as exemplified for R⁰⁰³.

R⁰¹⁰ to R⁰¹³, taken together, may form a ring, and in that event, at least one of R⁰¹⁰ to R⁰¹³ is a divalent C₁-C₁₅hydrocarbon group containing a —CO₂— partial structure, while the remaining R's are independently single bonds or straight, branched or cyclic C₁-C₁₅alkylene groups. Examples of the divalent C₁-C₁₅hydrocarbon group containing a —CO₂— partial structure include 1-oxo-2-oxapropane-1,3-diyl, 1,3-dioxo-2-oxapropane-1,3-diyl, 1-oxo-2-oxabutane-1,4-diyl, and 1,3-dioxo-2-oxabutane-1,4-diyl, as well as the groups exemplified as the monovalent hydrocarbon group containing a —CO₂— partial structure, with one hydrogen atom eliminated therefrom. Examples of the straight, branched or cyclic C₁-C₁₅ alkylene groups include the groups exemplified for R⁰⁰³, with one hydrogen atom eliminated therefrom.

R⁰¹⁴ is a polycyclic C₁-C₁₅ hydrocarbon group or an alkyl group containing a polycyclic hydrocarbon group, for example, norbornyl, bicyclo[3.3.1]nonyl, tricyclo[5.2.1.0^{2.6}]decyl, adamantyl, ethyladamantyl, butyladamantyl, norbornylmethyl, and adamantylmethyl.

R⁰¹⁵ is an acid labile group, which will be described later.

X is CH₂ or an oxygen atom.

The subscript k is 0 or 1.

The acid labile groups represented by R⁰¹⁵ may be selected from a variety of such groups. Examples of the acid labile group are groups of the following general formulae (L1) to (L4), tertiary alkyl groups of 4 to 20 carbon atoms, preferably 4 to 15 carbon atoms, trialkylsilyl groups in which each alkyl moiety has 1 to 6 carbon atoms, and oxoalkyl groups of 4 to 20 carbon atoms.

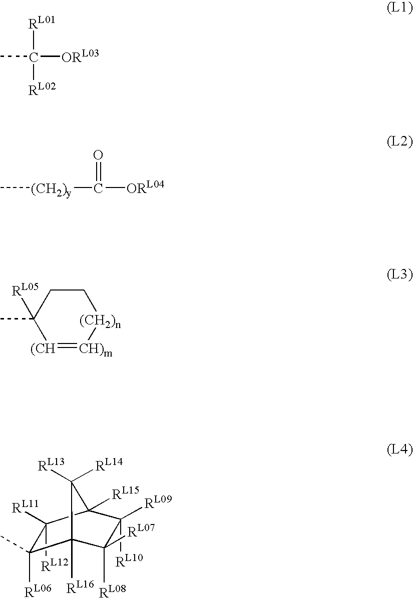

The broken line indicates a bonding site and direction.

The subscript y is an integer of 0 to 6, m is 0 or 1, n is 0, 1, 2 or 3, and 2m+n is equal to 2 or 3.

R^{L01} and R^{L02} are hydrogen or straight, branched or cyclic alkyl groups of 1 to 18 carbon atoms, preferably 1 to 10 carbon atoms. Exemplary alkyl groups include methyl, ethyl, propyl, isopropyl, n-butyl, sec-butyl, tert-butyl, cyclopentyl, cyclohexyl, 2-ethylhexyl, and n-octyl.

R^{L03} is a monovalent hydrocarbon group of 1 to 18 carbon atoms, preferably 1 to 10 carbon atoms, which may contain a hetero atom such as oxygen, examples of which include unsubstituted straight, branched or cyclic alkyl groups and straight, branched or cyclic alkyl groups in which some hydrogen atoms are replaced by hydroxyl, alkoxy, oxo, amino, alkylamino or the like. Illustrative examples are the substituted alkyl groups shown below wherein the broken line indicates a bonding site.

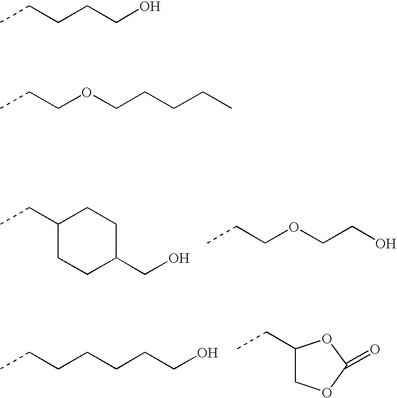

A pair of R^{L01} and R^{L02}, R^{L01} and R^{L03}, or R^{L02} and R^{L03} may form a ring. Each of R^{L01}, R^{L02} and R^{L03} is a straight or branched alkylene group of 1 to 18 carbon atoms, preferably 1 to 10 carbon atoms when they form a ring.

R^{L04} is a tertiary alkyl group of 4 to 20 carbon atoms, preferably 4 to 15 carbon atoms, a trialkylsilyl group in which each alkyl moiety has 1 to 6 carbon atoms, an oxoalkyl group of 4 to 20 carbon atoms, or a group of formula (L1). Exemplary tertiary alkyl groups are tert-butyl, tert-amyl, 1,1-diethylpropyl, 2-cyclopentylpropan-2-yl, 2-cyclohexylpropan-2-yl, 2-(bicyclo[2.2.1]heptan-2-yl, 2-(adamantan-1-yl)propan-2-yl, 1-ethylcyclopentyl, 1-butylcyclopentyl, 1-ethylcyclohexyl, 1-butylcyclohexyl, 1-ethyl-2-cyclopentenyl, 1-ethyl-2-cyclohexenyl, 2-methyl-2-adamantyl, and 2-ethyl-2-adamantyl. Exemplary trialkylsilyl groups are trimethylsilyl, triethylsilyl, and dimethyl-tert-butylsilyl. Exemplary oxoalkyl groups are 3-oxocyclohexyl, 4-methyl-2-oxooxan-4-yl, and 5-methyl-2-oxooxolan-5-yl.

R^{L05} is a monovalent C₁-C₈ hydrocarbon group which may contain a hetero atom or a substituted or unsubstituted C₆-C₂₀ aryl group. Examples of the monovalent hydrocarbon group which may contain a hetero atom include straight, branched or cyclic alkyl groups such as methyl, ethyl, propyl, isopropyl, n-butyl, sec-butyl, tert-butyl, tert-amyl, n-pentyl, n-hexyl, cyclopentyl and cyclohexyl, and substituted forms of the foregoing in which some hydrogen atoms are replaced by hydroxyl, alkoxy, carboxy, alkoxycarbonyl, oxo, amino, alkylamino, cyano, mercapto, alkylthio, sulfo or other groups. Exemplary aryl groups are phenyl, methylphenyl, naphthyl, anthryl, phenanthryl, and pyrenyl.

R^{L06} is a monovalent C₁-C₈ hydrocarbon group which may contain a hetero atom or a substituted or unsubstituted C₆-C₂₀ aryl group. Examples of these groups are the same as exemplified for R^{L05}.

R^{L07} to R^{L16} independently represent hydrogen or monovalent C₁-C₁₅ hydrocarbon groups which may contain a hetero atom. Exemplary hydrocarbon groups are straight, branched or cyclic alkyl groups such as methyl, ethyl, propyl, isopropyl, n-butyl, sec-butyl, tert-butyl, tert-amyl, n-pentyl, n-hexyl, n-octyl, n-nonyl, n-decyl, cyclopentyl, cyclohexyl, cyclopentylmethyl, cyclopentylethyl, cyclopentylbutyl, cyclohexylmethyl, cyclohexylethyl and cyclohexylbutyl, and substituted forms of the foregoing in which some hydrogen atoms are replaced by hydroxyl, alkoxy, carboxy, alkoxycarbonyl, oxo, amino, alkylamino, cyano, mercapto, alkylthio, sulfo or other groups. Alternatively, R^{L07} to R^{L16}, taken together, may form a ring (for example, a pair of R^{L07} and R^{L08}, R^{L07} and R^{L09}, R^{L08} and R_{L10}, R^{L09} and R^{L10}, R^{L11} and R^{L12}, R^{L13} and R^{L14}, or a similar pair form a ring). Each of R^{L07} to R^{L16} represents a divalent C₁-C₁₅ hydrocarbon group which may contain a hetero atom, when they form a ring, examples of which are the ones exemplified above for the monovalent hydrocarbon groups, with one hydrogen atom being eliminated. Two of R^{L07} to R^{L16} which are attached to adjoining carbon atoms (for example, a pair of R^{L07} and R^{L09}, R^{L09} and R^{L15}, R^{L13} and R^{L15}, or a similar pair) may bond together directly to form a double bond.

Of the acid labile groups of formula (L1), the straight and branched ones are exemplified by the following groups wherein the broken line indicates a bonding site.

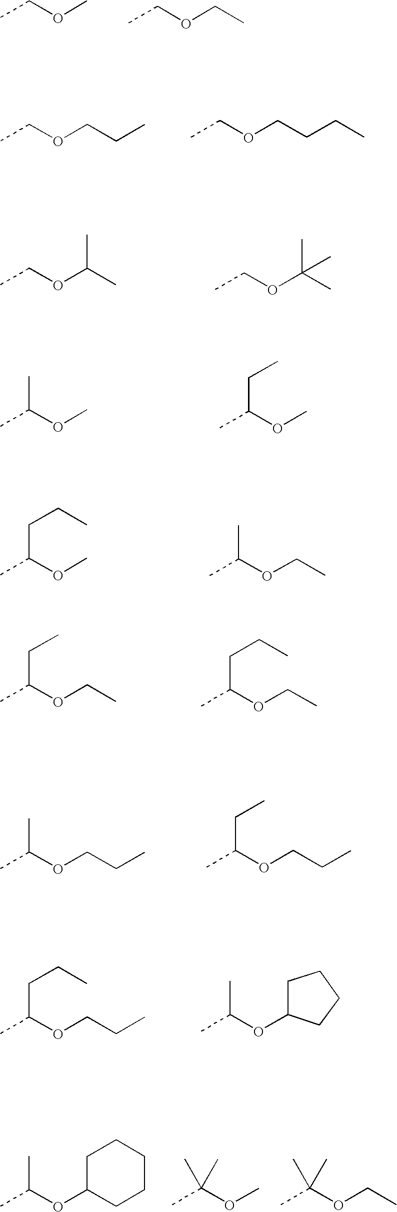

Of the acid labile groups of formula (L1), the cyclic ones are, for example, tetrahydrofuran-2-yl, 2-methyltetrahydrofuran-2-yl, tetrahydropyran-2-yl, and 2-methyltetrahydropyran-2-yl.

Examples of the acid labile groups of formula (L2) include tert-butoxycarbonyl, tert-butoxycarbonylmethyl, tert-amyloxycarbonyl, tert-amyloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl groups.

Examples of the acid labile groups of formula (L3) include 1-methylcyclopentyl, 1-ethylcyclopentyl, 1-n-propylcyclopentyl, 1-isopropylcyclopentyl, 1-n-butylcyclopentyl, 1-sec-butylcyclopentyl, 1-cyclohexylcyclopentyl, 1-(4-methoxy-n-butyl)cyclopentyl, 1-methylcyclohexyl, 1-ethylcyclohexyl, 3-methyl-1-cyclopenten-3-yl, 3-ethyl-1-cyclopenten-3-yl, 3-methyl-1-cyclohexen-3-yl, and 3-ethyl-1-cyclohexen-3-yl groups.

The acid labile groups of formula (L4) are exemplified by the following groups wherein the broken line indicates a bonding site and direction.

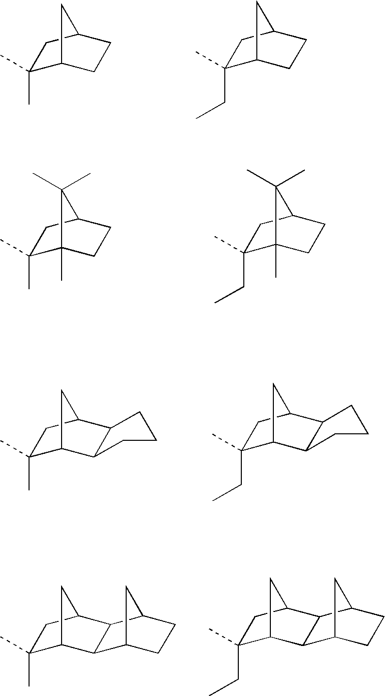

Examples of the tertiary C₄-C₂₀ alkyl, tri(C₁-C₆-alkyl)silyl and C₄-C₂₀ oxoalkyl groups included in the acid labile groups represented by R⁰¹⁵ are as exemplified above for R^{L04}.

R⁰¹⁶ is hydrogen or methyl. R⁰¹⁷ is a straight, branched or cyclic C₁-C₈ alkyl group. Letter a1′, a2′, a3′, b1′, b2′, b3′, c1′, c2′, c3′, d1′, d2′, d3′, and e′ are numbers from 0 to less than 1, satisfying a1′+a2′+a3′+b1′+b2′+b3′+c1′+c2′+c3′+d1′+d2′+d3′+e′=1; f′, g′, h′, i′, and j′ are numbers from 0 to less than 1, satisfying f′+g′+h′+i′+j′=1; x′, y′ and z′ are each an integer of 0 to 3, satisfying 1≦x′+y′+z′≦5 and 1≦y′+z′≦3.

The inventive polymer and the other polymer are preferably blended in a weight ratio from 100:0 to 10:90, more preferably from 100:0 to 20:80. If the blend ratio of the inventive polymer is below this range, the resist composition would become poor in some of the desired properties. The properties of the resist composition can be adjusted by properly changing the blend ratio of the inventive polymer.

The other polymer is not limited to one type and a mixture of two or more other polymers may be added. The use of plural polymers allows for easy adjustment of resist properties.

Dissolution Regulator

To the resist composition, a dissolution regulator may be added. The dissolution regulator is a compound having on the molecule at least two phenolic hydroxyl groups, in which an average of from 0 to 100 mol % of all the hydrogen atoms on the phenolic hydroxyl groups are replaced with acid labile groups or a compound having on the molecule at least one carboxyl group, in which an average of 50 to 100 mol % of all the hydrogen atoms on the carboxyl groups are replaced with acid labile groups, both the compounds having an average molecular weight within a range of 100 to 1,000, and preferably 150 to 800.

The degree of substitution of the hydrogen atoms on the phenolic hydroxyl groups with acid labile groups is on average at least 0 mol %, and preferably at least 30 mol %, of all the phenolic hydroxyl groups. The upper limit is 100 mol %, and preferably 80 mol %. The degree of substitution of the hydrogen atoms on the carboxyl groups with acid labile groups is on average at least 50 mol %, and preferably at least 70 mol %, of all the carboxyl groups, with the upper limit being 100 mol %.

Preferable examples of such compounds having two or more phenolic hydroxyl groups or compounds having at least one carboxyl group include those of formulas (D1) to (D14) below.

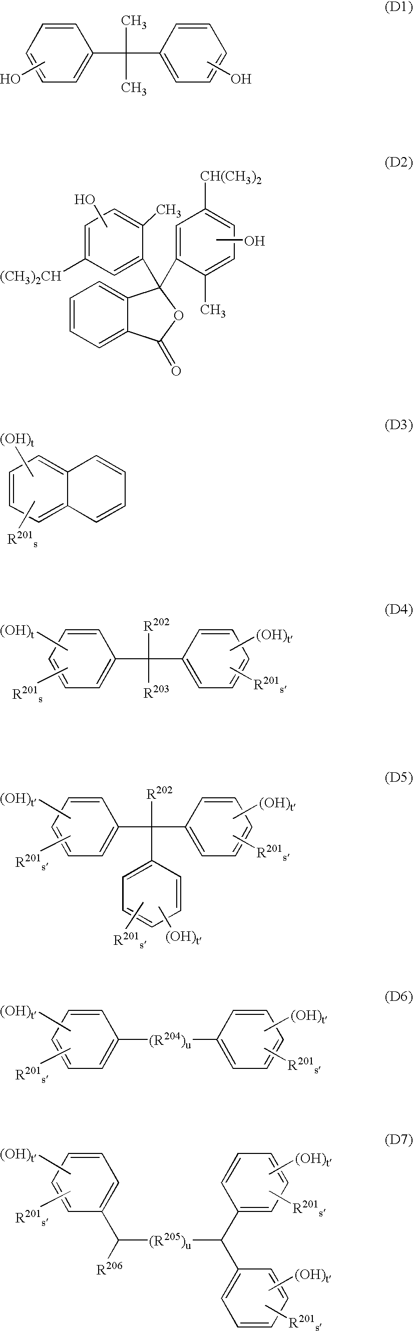

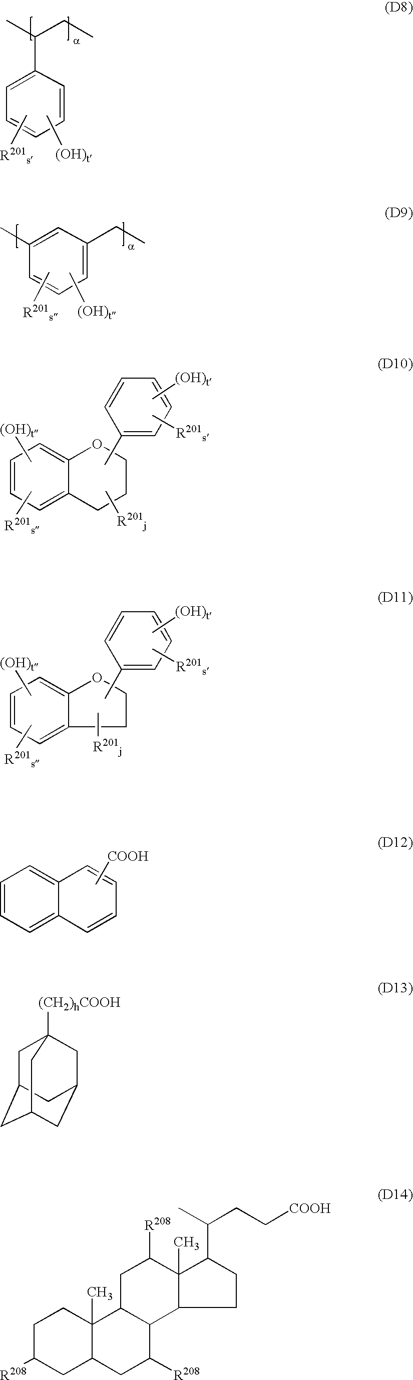

In these formulas, R²⁰¹ and R²⁰² are each hydrogen or a straight or branched C₁-C₈ alkyl or alkenyl group, for example, hydrogen, methyl, ethyl, butyl, propyl, ethynyl and cyclohexyl.

R²⁰³ is hydrogen, a straight or branched C₁-C₈ alkyl or alkenyl group, or —(R²⁰⁷)ₕ—COOH wherein R²⁰⁷ is a straight or branched C₁-C₁₀ alkylene, for example, those exemplified for R²⁰¹ and R²⁰² and —COOH and —CH₂COOH.

R²⁰⁴ is —(CH₂)ᵢ— wherein i=2 to 10, C₆-C₁₀ arylene, carbonyl, sulfonyl, an oxygen atom, or a sulfur atom, for example, ethylene, phenylene, carbonyl, sulfonyl, oxygen atom or sulfur atom.

R²⁰⁵ is a C₁-C₁₀ alkylene, a C₆-C₁₀ arylene, carbonyl, sulfonyl, an oxygen atom, or a sulfur atom, for example, methylene and those exemplified for R²⁰⁴.

R²⁰⁶ is hydrogen, a straight or branched C₁-C₈ alkyl or alkenyl, or a hydroxyl-substituted phenyl or naphthyl, for example, hydrogen, methyl, ethyl, butyl, propyl, ethynyl, cyclohexyl, hydroxyl-substituted phenyl, and hydroxyl-substituted naphthyl.

R²⁰⁸ is hydrogen or hydroxyl.

The letter j is an integer from 0 to 5; u and h are each 0 or 1; s, t, s′, t′, s″, and t″ are each numbers which satisfy s+t=8, s′+t′=5, and s″+t″=4, and are such that each phenyl skeleton has at least one hydroxyl group; and α is a number such that the compounds of formula (D8) or (D9) have a weight average molecular weight of from 100 to 1,000.

Exemplary acid labile groups on the dissolution regulator include a variety of such groups, typically groups of the general formulae (L1) to (L4), tertiary alkyl groups of 4 to 20 carbon atoms, trialkylsilyl groups in which each of the alkyls has 1 to 6 carbon atoms, and oxoalkyl groups of 4 to 20 carbon atoms. Examples of the respective groups are as previously described.

The dissolution regulator may be formulated in an amount of 0 to 50 parts, preferably 0 to 40 parts, and more preferably 0 to 30 parts by weight, per 100 parts by weight of the base resin, and may be used singly or as a mixture of two or more thereof. The use of more than 50 parts of the dissolution regulator would lead to slimming of the patterned film, and thus a decline in resolution.

The dissolution regulator can be synthesized by introducing acid labile groups into a compound having phenolic hydroxyl or carboxyl groups in accordance with an organic chemical formulation.

Nitrogen-Containing Compound

In the resist composition, an organic nitrogen-containing compound or compounds may be compounded.

The organic nitrogen-containing compound used herein is preferably a compound capable of suppressing the rate of diffusion when the acid generated by the acid generator diffuses within the resist film. The inclusion of this type of organic nitrogen-containing compound holds down the rate of acid diffusion within the resist film, resulting in better resolution. In addition, it suppresses changes in sensitivity following exposure and reduces substrate and environment dependence, as well as improving the exposure latitude and the pattern profile.

Examples of organic nitrogen-containing compounds include primary, secondary, and tertiary aliphatic amines, mixed amines, aromatic amines, heterocyclic amines, nitrogen-containing compounds having carboxyl group, nitrogen-containing compounds having sulfonyl group, nitrogen-containing compounds having hydroxyl group, nitrogen-containing compounds having hydroxyphenyl group, alcoholic nitrogen-containing compounds, amide derivatives, imide derivatives, and carbamate derivatives.

Examples of suitable primary aliphatic amines include ammonia, methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. Examples of suitable secondary aliphatic amines include dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. Examples of suitable tertiary aliphatic amines include trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of suitable mixed amines include dimethylethylamine, methylethylpropylamine, benzylamine, phenethylamine, and benzyldimethylamine. Examples of suitable aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 1-methyl-2-pyridone, 4-pyrrolidinopyridine, 1-methyl-4-phenylpyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives.

Examples of suitable nitrogen-containing compounds having carboxyl group include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable nitrogen-containing compounds having sulfonyl group include 3-pyridinesulfonic acid and pyridinium p-toluenesulfonate. Examples of suitable nitrogen-containing compounds having hydroxyl group, nitrogen-containing compounds having hydroxyphenyl group, and alcoholic nitrogen-containing compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. Examples of suitable amide derivatives include formamide, N-methylformamide, N,N-dimethylformamide, acetamide, N-methylacetamide, N,N-dimethylacetamide, propionamide, benzamide, and 1-cyclohexylpyrrolidone. Suitable imide derivatives include phthalimide, succinimide, and maleimide. Suitable carbamate derivatives include N-t-butoxycarbonyl-N,N-dicyclohexylamine, N-t-butoxycarbonylbenzimidazole and oxazolidinone.

In addition, organic nitrogen-containing compounds of the following general formula (B)-1 may also be included alone or in admixture.
N(X)ₙ(Y)₃₋ₙ (B)-1

In the formula, n is equal to 1, 2 or 3; side chain Y is independently hydrogen or a straight, branched or cyclic alkyl group of 1 to 20 carbon atoms which may contain an ether or hydroxyl group; and side chain X is independently selected from groups of the following general formulas (X)-1 to (X)-3, and two or three X's may bond together to form a ring.

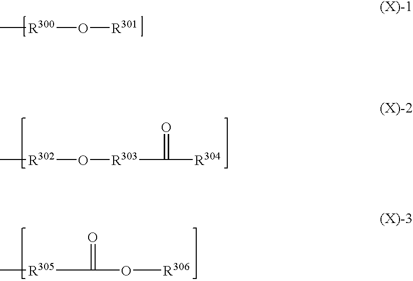

In the formulas, R³⁰⁰, R³⁰² and R³⁰⁵ are independently straight or branched alkylene groups of 1 to 4 carbon atoms; R³⁰¹ and R³⁰⁴ are independently hydrogen, straight, branched or cyclic alkyl groups of 1 to 20 carbon atoms, which may contain at least one hydroxyl, ether, ester group or lactone ring; R³⁰³ is a single bond or a straight or branched alkylene group of 1 to 4 carbon atoms; and R³⁰⁶ is a straight, branched or cyclic alkyl group of 1 to 20 carbon atoms, which may contain at least one hydroxyl, ether, ester group or lactone ring.

Illustrative examples of the compounds of formula (B)-1 include tris(2-methoxymethoxyethyl)amine, tris{2-(2-methoxyethoxy)ethyl}amine, tris{2-(2-methoxyethoxymethoxy)ethyl)amine, tris{2-(1-methoxyethoxy)ethyl}amine, tris{2-(1-ethoxyethoxy)ethyl)amine, tris{2-(1-ethoxypropoxy)ethyl)amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4, 1-aza-15-crown-5, 1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]-ethylamine, N,N-bis(2-acetoxyethyl)-2-[(methoxycarbonyl)methoxycarbonyl]-ethylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(tetrahydrofurfuryloxycarbonyl)-ethylamine, N,N-bis(2-acetoxyethyl)-2-(tetrahydrofurfuryloxycarbonyl)-ethylamine, N,N-bis(2-hydroxyethyl)-2-[(2-oxotetrahydrofuran-3-yl)oxy-carbonyl]ethylamine, N,N-bis(2-acetoxyethyl)-2-[(2-oxotetrahydrofuran-3-yl)oxy-carbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)-ethylamine, N,N-bis(2-formyloxyethyl)-2-(2-formyloxyethoxycarbonyl)-ethylamine, N,N-bis(2-methoxyethyl)-2-(methoxycarbonyl)ethylamine, N-(2-hydroxyethyl)-bist2-(methoxycarbonyl)ethyl]amine, N-(2-acetoxyethyl)-bis[2-(methoxycarbonyl)ethyl]amine, N-(2-hydroxyethyl)-bis[2-(ethoxycarbonyl)ethyl]amine, N-(2-acetoxyethyl)-bis[2-(ethoxycarbonyl)ethyl]amine, N-(3-hydroxy-1-propyl)-bis[2-(methoxycarbonyl)ethyl]amine, N-(3-acetoxy-1-propyl)-bis[2-(methoxycarbonyl)ethyl]amine, N-(2-methoxyethyl)-bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexyl-bis(methoxycarbonylmethyl)amine, and β-(diethylamino)-δ-valerolactone.

Also useful are one or more organic nitrogen-containing compounds having cyclic structure represented by the following general formula (B)-2. 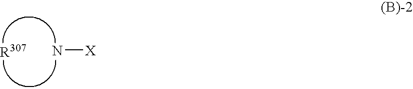
Herein X is as defined above, and R³⁰⁷ is a straight or branched alkylene group of 2 to 20 carbon atoms which may contain one or more carbonyl, ether, ester or sulfide groups.

Illustrative examples of the organic nitrogen-containing compounds having formula (B)-2 include 1-[2-(methoxymethoxy)ethyl]pyrrolidine, 1-[2-(methoxymethoxy)ethyl]piperidine, 4-[2-(methoxymethoxy)ethyl)morpholine, 1-[2-[(2-methoxyethoxy)methoxylethyllpyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butyrolactone, β-piperidino-γ-butyrolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, and 2-methoxyethyl morpholinoacetate.

Also, one or more organic nitrogen-containing compounds having cyano group represented by the following general formulae (B)-3 to (B)-6 may be blended. 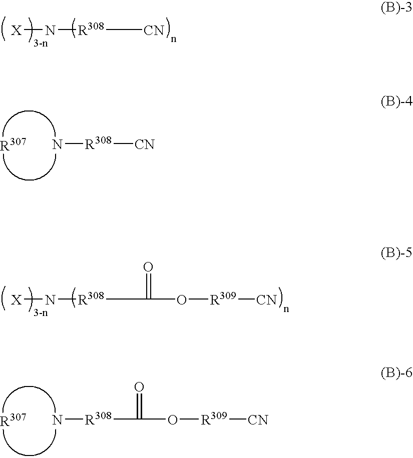
Herein, X, R³⁰⁷ and n are as defined above, and R³⁰⁸ and R³⁰⁹ are each independently a straight or branched alkylene group of 1 to 4 carbon atoms.

Illustrative examples of the organic nitrogen-containing compounds having cyano represented by formulae (B)-3 to (B)-6 include 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis[2-(methoxymethoxy)ethyl]-3-aminopropiononitrile, methyl N-(2-cyanoethyl)-N-(2-methoxyethyl)-3-aminopropionate, methyl N-(2-cyanoethyl)-N-(2-hydroxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyanoethyl)-N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiono-nitrile, N-(2-cyanoethyl)-N-(3-hydroxy-1-propyl)-3-aminopropiono-nitrile, N-(3-acetoxy-1-propyl)-N-(2-cyanoethyl)-3-aminopropiono-nitrile, N-(2-cyanoethyl)-N-(3-formyloxy-1-propyl)-3-aminopropiono-nitrile, N-(2-cyanoethyl)-N-tetrahydrofurfuryl-3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)aminoacetonitrile, N,N-bis[2-(methoxymethoxy)ethyl]aminoacetonitrile, methyl N-cyanomethyl-N-(2-methoxyethyl)-3-aminopropionate, methyl N-cyanomethyl-N-(2-hydroxyethyl)-3-aminopropionate, methyl N-(2-acetoxyethyl)-N-cyanomethyl-3-aminopropionate, N-cyanomethyl-N-(2-hydroxyethyl)aminoacetonitrile, N-(2-acetoxyethyl)-N-(cyanomethyl)aminoacetonitrile, N-cyanomethyl-N-(2-formyloxyethyl)aminoacetonitrile, N-cyanomethyl-N-(2-methoxyethyl)aminoacetonitrile, N-cyanomethyl-N-[2-(methoxymethoxy)ethyl)aminoacetonitrile, N-cyanomethyl-N-(3-hydroxy-1-propyl)aminoacetonitrile, N-(3-acetoxy-1-propyl)-N-(cyanomethyl)aminoacetonitrile, N-cyanomethyl-N-(3-formyloxy-1-propyl)aminoacetonitrile, N,N-bis(cyanomethyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis(2-methoxyethyl)-3-aminopropionate, cyanomethyl N,N-bis[2-(methoxymethoxy)ethyl)-3-aminopropionate, 2-cyanoethyl 3-diethylaminopropionate, 2-cyanoethyl N,N-bis(2-hydroxyethyl)-3-aminopropionate, 2-cyanoethyl N,N-bis(2-acetoxyethyl)-3-aminopropionate, 2-cyanoethyl N,N-bis(2-formyloxyethyl)-3-aminopropionate, 2-cyanoethyl N,N-bis(2-methoxyethyl)-3-aminopropionate, 2-cyanoethyl N,N-bis[2-(methoxymethoxy)ethyl]-3-amino-propionate, cyanomethyl 1-pyrrolidinepropionate, cyanomethyl 1-piperidinepropionate, cyanomethyl 4-morpholinepropionate, 2-cyanoethyl 1-pyrrolidinepropionate, 2-cyanoethyl 1-piperidinepropionate, and 2-cyanoethyl 4-morpholinepropionate.

Also included are organic nitrogen-containing compounds having an imidazole structure and a polar functional group, represented by the general formula (B)-7. 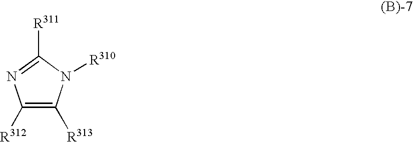
Herein, R³¹⁰ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹¹, R³¹² and R³¹³ are each independently a hydrogen atom, a straight, branched or cyclic alkyl group, aryl group or aralkyl group having 1 to 10 carbon atoms.

Also included are organic nitrogen-containing compounds having a benzimidazole structure and a polar functional group, represented by the general formula (B)-8. 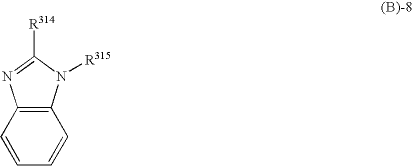
Herein, R³¹⁴ is a hydrogen atom, a straight, branched or cyclic alkyl group, aryl group or aralkyl group having 1 to 10 carbon atoms. R³¹⁵ is a polar functional group-bearing, straight, branched or cyclic alkyl group of 1 to 20 carbon atoms, and the alkyl group contains as the polar functional group at least one group selected from among ester, acetal and cyano groups, and may additionally contain at least one group selected from among hydroxyl, carbonyl, ether, sulfide and carbonate groups.

Further included are heterocyclic nitrogen-containing compounds having a polar functional group, represented by the general formulae (B)-9 and (B)-10. 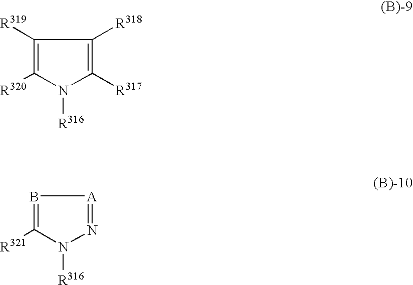
Herein, A is a nitrogen atom or ≡C—R³²², B is a nitrogen atom or ≡C—R³²³, R³¹⁶ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹⁷ , R³¹⁸ , R³¹⁹ and R³²⁰ are each independently a hydrogen atom, a straight, branched or cyclic alkyl group or aryl group having 1 to 10 carbon atoms, or a pair of R³¹⁷ and R³¹⁸ and a pair of R³¹⁹ and R³²⁰, taken together, may form a benzene, naphthalene or pyridine ring; R³²¹ is a hydrogen atom, a straight, branched or cyclic alkyl group or aryl group having 1 to 10 carbon atoms; R³²² and R³²³ each are a hydrogen atom, a straight, branched or cyclic alkyl group or aryl group having 1 to 10 carbon atoms, or a pair of R³²¹ and R³²³, taken together, may form a benzene or naphthalene ring.

The organic nitrogen-containing compounds may be used alone or in admixture of two or more. The organic nitrogen-containing compound is preferably formulated in an amount of 0.001 to 2 parts, and especially 0.01 to 1 part by weight, per 100 parts by weight of the entire base resin. Less than 0.001 part of the nitrogen-containing compound achieves no or little addition effect whereas more than 2 parts would result in too low a sensitivity.

Other Components

In the resist composition, a compound having a group ≡C—COOH in a molecule may be blended. Exemplary, non-limiting compounds having a group ≡C—COOH include one or more compounds selected from Groups I and II below. Including this compound improves the PED stability of the resist and ameliorates edge roughness on nitride film substrates.

Group I:

Compounds in which some or all of the hydrogen atoms on the phenolic hydroxyl groups of the compounds of general formulas (A1) to (A10) below are replaced by —R⁴⁰¹—COOH (wherein R⁴⁰¹ is a straight or branched alkylene of 1 to 10 carbon atoms), and in which the molar ratio C/(C+D) of phenolic hydroxyl groups (C) to ≡C—COOH groups (D) in the molecule is from 0.1 to 1.0.

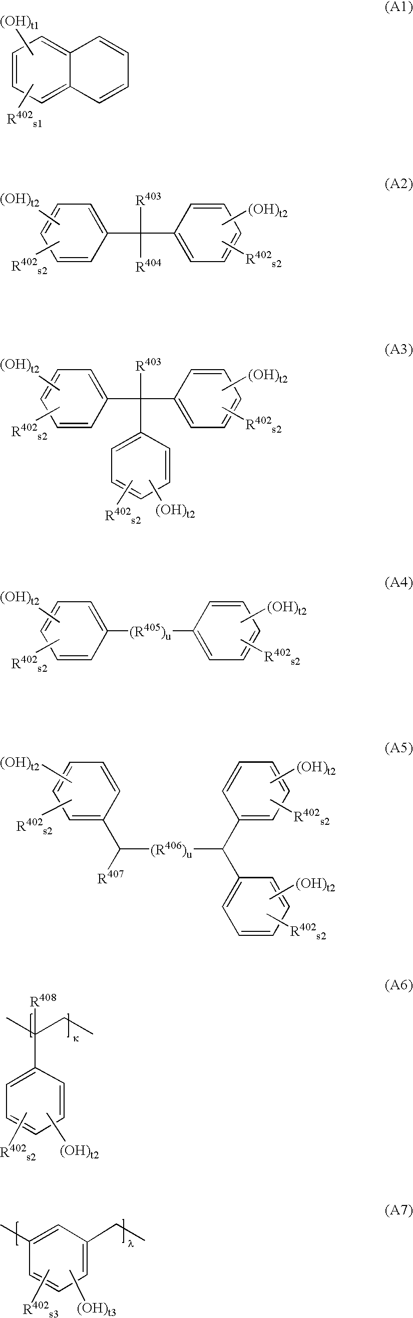

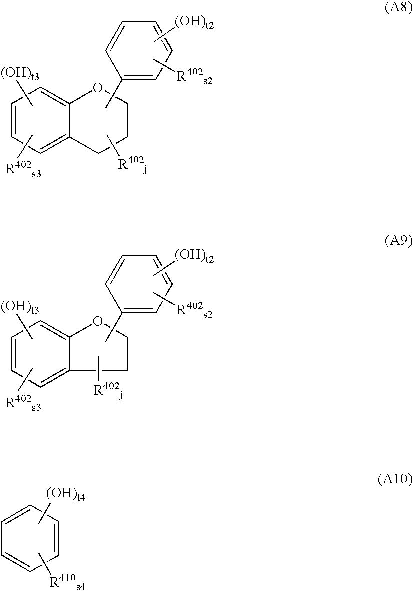

In these formulas, R⁴⁰⁸ is hydrogen or methyl; R⁴⁰² and R⁴⁰³ are each hydrogen or a straight or branched C₁-C₈ alkyl or alkenyl; R⁴⁰⁴ is hydrogen, a straight or branched C₁-C₈ alkyl or alkenyl, or a —(R⁴⁰⁹)ₕ—COOR′ group (R′ being hydrogen or —R⁴⁰⁹—COOH); R⁴⁰⁵ is —(CH₂)ᵢ— (wherein i is 2 to 10), a C₆-C₁₀ arylene, carbonyl, sulfonyl, an oxygen atom, or a sulfur atom; R⁴⁰⁶ is a C₁-C₁₀ alkylene, a C₆-C₁₀ arylene, carbonyl, sulfonyl, an oxygen atom, or a sulfur atom; R⁴⁰⁷ is hydrogen, a straight or branched C₁-C₈ alkyl or alkenyl, or a hydroxyl-substituted phenyl or naphthyl; R⁴⁰⁹ is a straight or branched C₁-C₁₀ alkylene; R⁴¹⁰ is hydrogen, a straight or branched C₁-C₈ alkyl or alkenyl, or a —R⁴¹¹—COOH group; R⁴¹¹ is a straight or branched C₁-C₁₀ alkylene; the letter j is an integer from 0 to 3; u is 1 to 4; s1, t1, s2, t2, s3, t3, s4, and t4 are each numbers which satisfy s1+t1=8, s2+t2=5, s3+t3=4, and s4+t4=6, and are such that each phenyl structure has at least one hydroxyl group; κ is a number such that the compound of formula (A6) may have a weight average molecular weight of 1,000 to 5,000; and λ is a number such that the compound of formula (A7) may have a weight average molecular weight of 1,000 to 10,000.

Group II:

Compounds of general formulas (A11) to (A15) below.

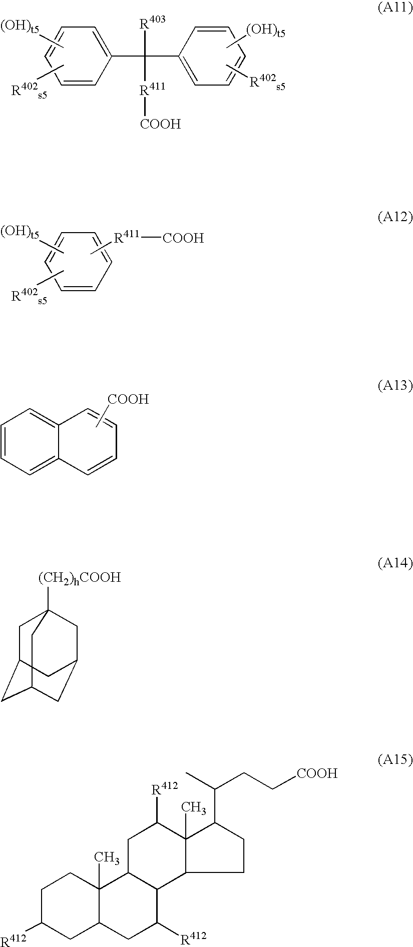

In these formulas, R⁴⁰², R⁴⁰³, and R⁴¹¹ are as defined above; R⁴¹² is hydrogen or hydroxyl; s5 and t5 are numbers which satisfy s5≧0, t5≧0, and s5+t5=5; and h is 1 to 4.

Illustrative, non-limiting examples of the compound having a carboxyl group include compounds of the general formulas AI-1 to AI-14 and AII-1 to AII-10 below.

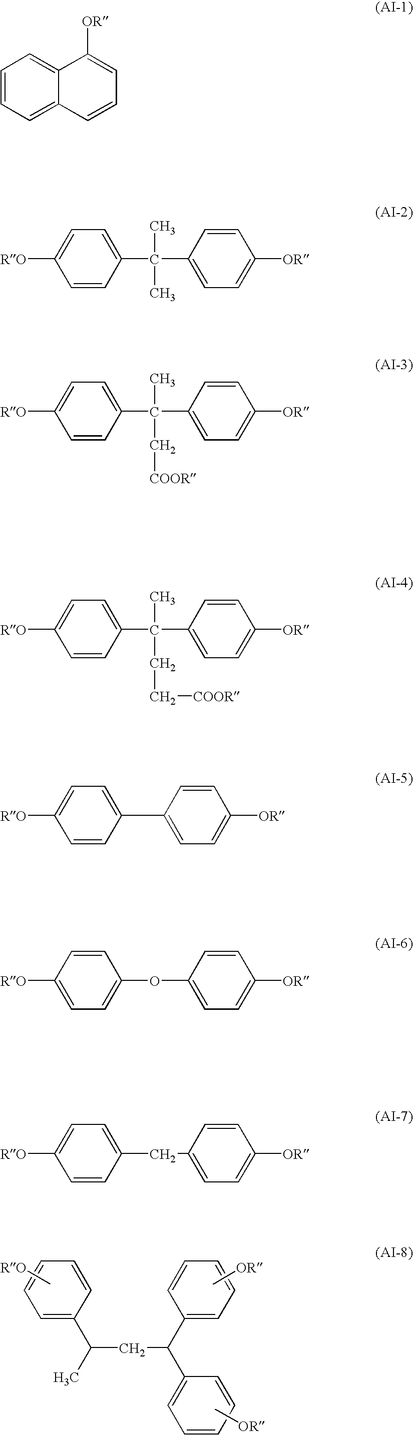

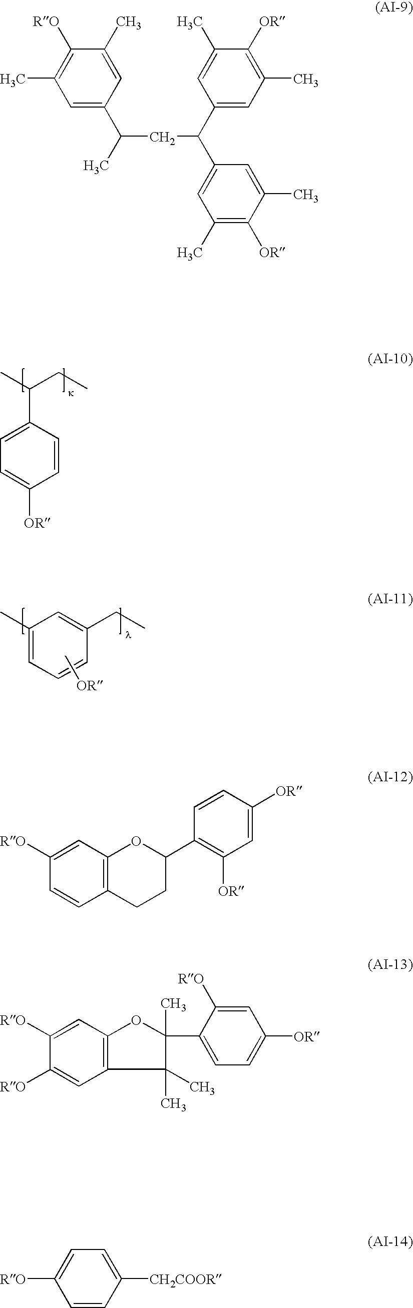

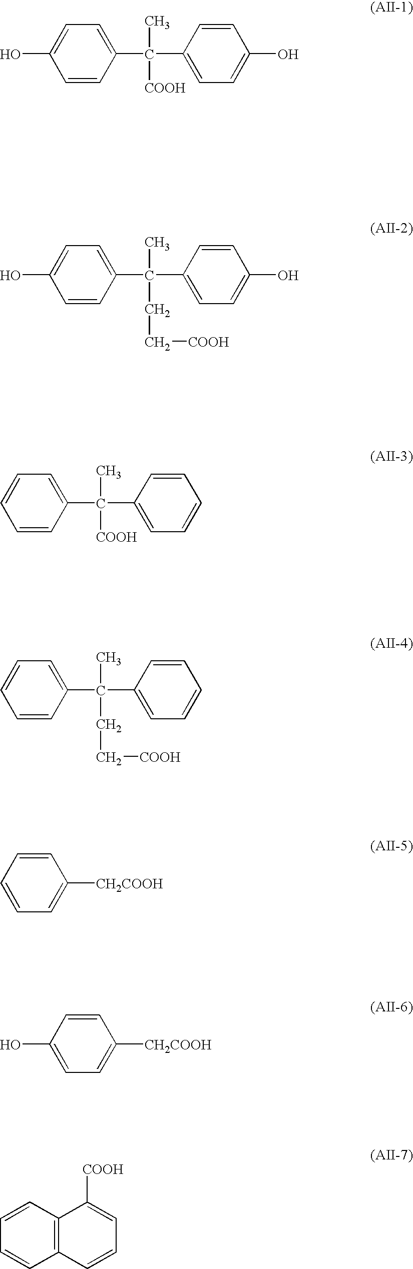

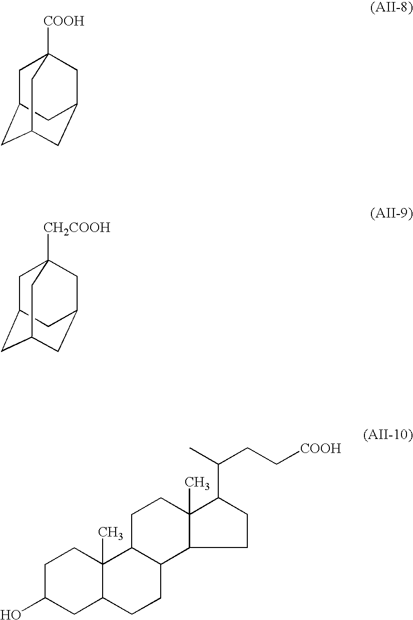

In the above formulas, R″ is hydrogen or a —CH₂COOH group such that the —CH₂COOH group accounts for 10 to 100 mol % of R″ in each compound, κ and λ are as defined above.

The compound having a ≡C—COOH group may be used singly or as combinations of two or more thereof. The compound having a ≡C—COOH group is added in an amount ranging from 0 to 5 parts, preferably 0.1 to 5 parts, more preferably 0.1 to 3 parts, further preferably 0.1 to 2 parts by weight, per 100 parts by weight of the base resin. More than 5 parts of the compound can reduce the resolution of the resist composition.

The resist composition of the invention may additionally include an acetylene alcohol derivative for the purpose of enhancing the shelf stability. Preferred acetylene alcohol derivatives are those having the general formula (S1) or (S2) below.

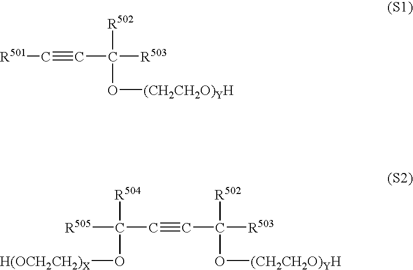

In the formulas, R⁵⁰¹, R⁵⁰² , R⁵⁰³, R⁵⁰⁴ , and R⁵⁰⁵ are each hydrogen or a straight, branched or cyclic C₁-C₈ alkyl; and X and Y are each 0 or a positive number, satisfying 0≦X≦30, 0≦Y≦30, and 0≦X+Y≦40.

Preferable examples of the acetylene alcohol derivative include Surfynol 61, Surfynol 82, Surfynol 104, Surfynol 104E, Surfynol 104H, Surfynol 104A, Surfynol TG, Surfynol PC, Surfynol 440, Surfynol 465, and Surfynol 485 from Air Products and Chemicals Inc., and Surfynol E1004 from Nisshin Chemical Industry K.K.

The acetylene alcohol derivative is preferably added in an amount of 0.01 to 2% by weight, and more preferably 0.02 to 1% by weight, per 100% by weight of the resist composition. Less than 0.01% by weight would be ineffective for improving coating characteristics and shelf stability, whereas more than 2% by weight would result in a resist having a low resolution.

The resist composition of the invention may include optional ingredients, for example, a surfactant which is commonly used for improving the coating characteristics. Optional ingredients may be added in conventional amounts so long as this does not compromise the objects of the invention.

Nonionic surfactants are preferred, examples of which include perfluoroalkylpolyoxyethylene ethanols, fluorinated alkyl esters, perfluoroalkylamine oxides, perfluoroalkyl EO-addition products, and fluorinated organosiloxane compounds. Useful surfactants are commercially available under the trade names Fluorad FC-430 and FC-431 from Sumitomo 3M, Ltd., Surflon S-141, S-145, KH-10, KH-20, KH-30 and KH-40 from Asahi Glass Co., Ltd., Unidyne DS-401, DS-403 and DS-451 from Daikin Industry Co., Ltd., Megaface F-8151 from Dai-Nippon Ink & Chemicals, Inc., and X-70-092 and X-70-093 from Shin-Etsu Chemical Co., Ltd. Preferred surfactants are Fluorad FC-430 from Sumitomo 3M, Ltd., KH-20 and KH-30 from Asahi Glass Co., Ltd., and X-70-093 from Shin-Etsu Chemical Co., Ltd.

Pattern formation using the resist composition of the invention may be carried out by a known lithographic technique. For example, the resist composition is applied onto a substrate such as a silicon wafer by spin coating or the like to form a resist film having a thickness of 0.1 to 2.0 μm, which is then pre-baked on a hot plate at 60 to 150° C. for 1 to 10 minutes, and preferably at 80 to 130° C. for 1 to 5 minutes. A patterning mask having the desired pattern is then placed over the resist film, and the film exposed through the mask to an electron beam or to high-energy radiation such as deep-UV rays, an excimer laser, or x-rays in a dose of about 1 to 200 mJ/cm², and preferably about 5 to 100 mJ/cm². Light exposure may be done by a conventional exposure process or in some cases, by an immersion process of providing liquid impregnation between the mask and the resist. The resist film is then post-exposure baked (PEB) on a hot plate at 60 to 150° C. for 1 to 5 minutes, and preferably at 80 to 130° C. for 1 to 3 minutes. Finally, development is carried out using as the developer an aqueous alkali solution, such as a 0.1 to 5 wt % (preferably 2 to 3 wt %) aqueous solution of tetramethylammonium hydroxide (TMAH), this being done by a conventional method such as dip, puddle, or spray development for a period of 0.1 to 3 minutes, and preferably 0.5 to 2 minutes. These steps result in the formation of the desired pattern on the substrate. Of the various types of high-energy radiation that may be used, the resist composition of the invention is best suited to fine pattern formation with, in particular, deep-UV rays having a wavelength of 248 to 193 nm, an excimer laser, x-rays, or an electron beam. The desired pattern may not be obtainable outside the upper and lower limits of the above range.

### EXAMPLE

Synthesis Examples and Examples are given below by way of illustration and not by way of limitation. The abbreviation Mw is a weight average molecular weight as measured by GPC using polystyrene standards, and SEM is scanning electron microscope.

Polymers within the scope of the invention were synthesized by the following procedure.

### Synthesis Example 1

Synthesis of Polymer 1

In 340 g of propylene glycol methyl ether acetate (PGMEA) were dissolved 23.8 g of 3-methacryloyloxybutanoic acid, 69.6 g of 4,8-dioxa-5-oxotricyclo[4.2.1. 0^{3,7} ]nonan-2-yl methacrylate, 56.6 g of 2-methyl-2-adamantyl methacrylate, 4.53 g of 2,2′-azobisisobutyronitrile, and 0.54 g of 2-mercaptoethanol. In a nitrogen atmosphere, this solution was added dropwise over 4 hours to 110 g of PGMEA which was heated at 800° C. At the end of dropwise addition, the solution was heated and stirred at 80° C. for 2 hours in the nitrogen atmosphere. After the reaction, the solution was cooled to room temperature, and with vigorous stirring, added dropwise to 2.3 L of hexane. The resulting solids were collected by filtration and dried under vacuum at 50° C. for 15 hours, obtaining 130.4 g (yield 86.9%) of a white solid. GPC and ¹³C-NMR spectrum showed the obtained white solid to be Polymer 1 having the formula described below and a Mw of 5,700.

### Synthesis Examples 2-7

Synthesis of Polymers 2-7

Polymers 2 to 7, identified below, were synthesized by the same procedure as above or a well-known procedure.

| | | | |
|---|---|---|---|
| (Polymer 1) (a = 0.20, b = 0.50, d = 0.30, Mw = 5,700) | 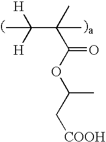 | 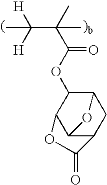 | 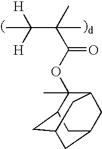 |
| (Polymer 2) (a = 0.20, b = 0.50, d = 0.30, Mw = 6,500) | 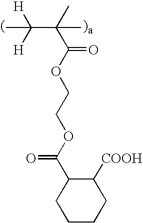 | 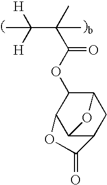 | 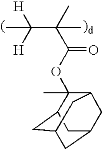 |
| (Polymer 3) (a = 0.20, b = 0.50, d = 0.30, Mw = 6,000) | 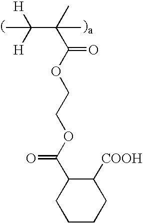 | 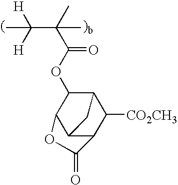 | 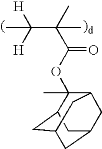 |
| (Polymer 4) (a = 0.20, b = 0.50, d = 0.30, Mw = 5,700) | 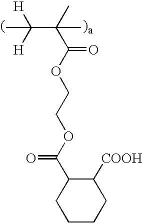 | 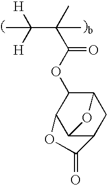 | 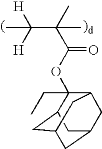 |
| (Polymer 5) (a = 0.20, b = 0.50, d = 0.30, Mw = 5,900) | 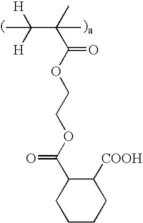 | 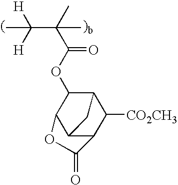 | 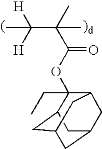 |
| (Polymer 6) (a = 0.20, b = 0.50, d = 0.30, Mw = 7,000) | 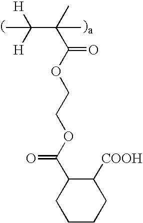 | 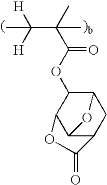 | 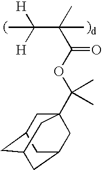 |
| (Polymer 7) (a = 0.20, b = 0.50, d = 0.30, Mw = 6,700) | 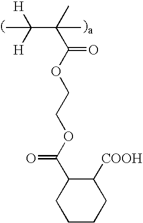 | 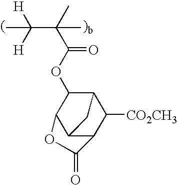 | 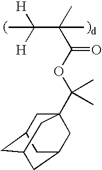 |

### Synthesis Example 8

Synthesis of Polymer 8

In 170 g of PGMEA were dissolved 5.75 g of 3-methacryloyloxybutanoic acid, 26.2 g of 4,8-dioxa-5-oxotricyclo[4.2.1.0^{3,7}]nonan-2-yl methacrylate, 43.0 g of 2-methyl-2-adamantyl methacrylate, and 2.74 g of 2,2′-azobisisobutyronitrile. In a nitrogen atmosphere, this solution was added dropwise over 4 hours to 55 g of PGMEA which was heated at 80° C. At the end of dropwise addition, the solution was heated and stirred at 80° C. for 2 hours in the nitrogen atmosphere. After the reaction, the solution was cooled to room temperature, and with vigorous stirring, added dropwise to 1.7 L of hexane. The resulting solids were collected by filtration and dried under vacuum at 50° C. for 15 hours, obtaining 62.6 g (yield 83.5%) of a white solid. GPC and ¹³C-NMR spectrum showed the obtained white solid to be Polymer 8 having the formula described below and a Mw of 6,700.

### Synthesis Examples 9-14

Synthesis of Polymers 9-14

Polymers 9 to 14, identified below, were synthesized by the same procedure as above or a well-known procedure.

| | | | |
|---|---|---|---|
| (Polymer 8) (a = 0.10, b = 0.40, d = 0.50, Mw = 6,700) | 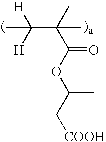 | 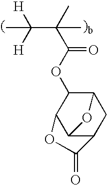 | 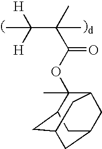 |
| (Polymer 9) (a = 0.10, b = 0.40, d = 0.50, Mw = 6,300) | 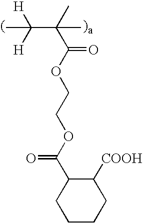 | 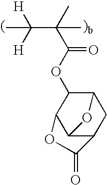 | 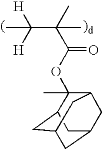 |
| (Polymer 10) (a = 0.10, b = 0.40, d = 0.50, Mw = 6,500) | 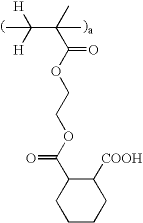 | 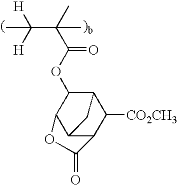 | 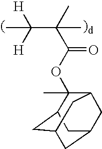 |
| (Polymer 11) (a = 0.10, b = 0.40, d = 0.50, Mw = 5,700) | 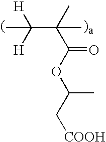 | 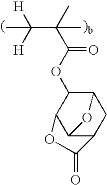 | 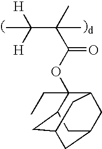 |
| (Polymer 12) (a = 0.10, b = 0.40, d = 0.50, Mw = 5,500) | 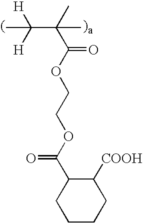 | 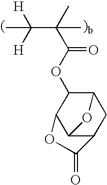 | 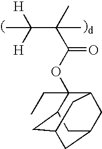 |
| (Polymer 13) (a = 0.10, b = 0.40, d = 0.50, Mw = 7,300) | 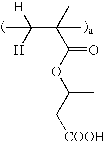 | 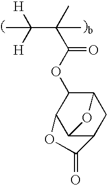 | 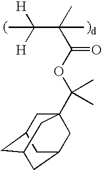 |
| (Polymer 14) (a = 0.10, b = 0.40, d = 0.50, Mw = 7,500) | 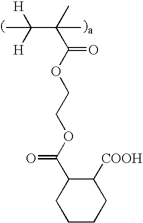 | 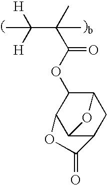 | 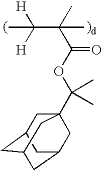 |

### Synthesis Example 15

Synthesis of Polymer 15

In 340 g of PGMEA were dissolved 11.5 g of 3-methacryloyloxybutanoic acid, 39.4 g of 4,8-dioxa-5-oxotricyclo[4.2.1.0 ^{3,7}])nonan-2-yl methacrylate, 46.9 g of 2-methyl-2-adamantyl methacrylate, 39.4 g of 3-hydroxy-1-adamantyl methacrylate, 4.38 g of 2,2′-azobisisobutyronitrile, and 0.52 g of 2-mercaptoethanol. In a nitrogen atmosphere, this solution was added dropwise over 4 hours to 110 g of PGMEA which was heated at 80° C. At the end of dropwise addition, the solution was heated and stirred at 80° C. for 2 hours in the nitrogen atmosphere. After the reaction, the solution was cooled to room temperature, and with vigorous stirring, added dropwise to 2.3 L of hexane. The resulting solids were collected by filtration and dried under vacuum at 50° C. for 15 hours, obtaining 122.3 g (yield 81.5%) of a white solid. GPC and ¹³C-NMR spectrum showed the obtained white solid to be Polymer 15 having the formula described below and a Mw of 6,500.

### Synthesis Examples 16-45

Synthesis of Polymers 16-45

Polymers 16 to 45, identified below, were synthesized by the same procedure as above or a well-known procedure.

| | | | | |
|---|---|---|---|---|
| (Polymer 15) (a = 0.10, b = 0.40, d = 0.25, f = 0.25, Mw = 6,500) | 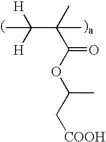 | 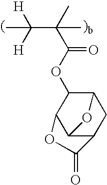 | 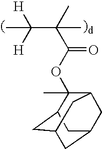 | 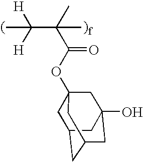 |
| (Polymer 16) (a = 0.10, b = 0.40, d = 0.25, f = 0.25, Mw = 6,700) | 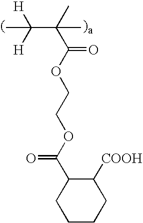 | 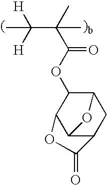 | 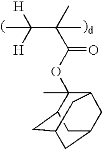 | 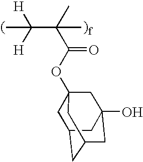 |
| (Polymer 17) (a = 0.10, b = 0.40, d = 0.25, f = 0.25, Mw = 6,300) | 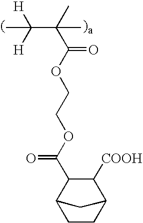 | 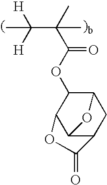 | 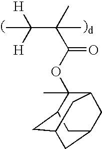 | 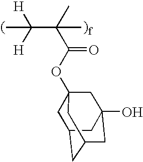 |
| (Polymer 18) (a = 0.10, b = 0.40, d = 0.25, f = 0.25, Mw = 6,500) | 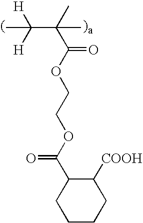 | 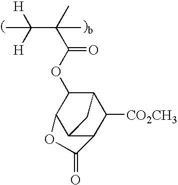 | 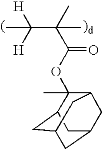 | 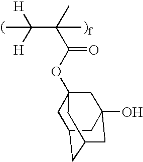 |
| (Polymer 19) (a = 0.10, b = 0.40, d = 0.25, f = 0.25, Mw = 7,000) | 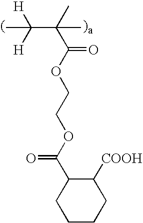 | 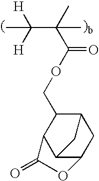 | 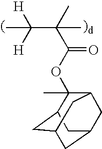 | 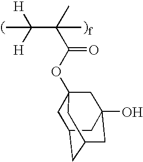 |

| | | | | | |
|---|---|---|---|---|---|
| (Polymer 20) (a = 0.10, b1 + b2 = 0.40, d = 0.25, f = 0.25, Mw = 6,000) | 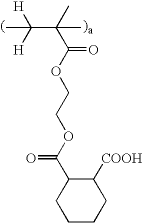 | 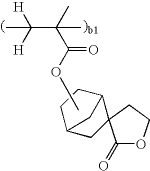 | 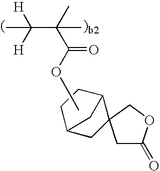 | 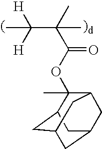 | 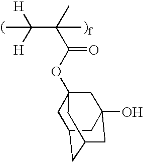 |

| | | | | |
|---|---|---|---|---|
| (Polymer 21) (a = 0.10, b = 0.40, d = 0.25, f = 0.25, Mw = 7,000) | 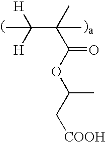 | 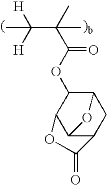 | 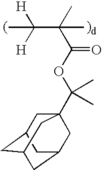 | 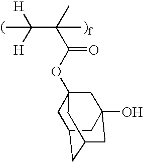 |
| (Polymer 22) (a = 0.10, b = 0.40, d = 0.25, f = 0.25, Mw = 6,700) | 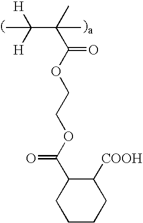 | 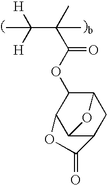 | 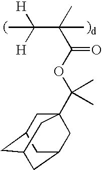 | 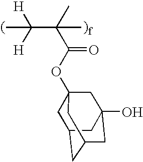 |
| (Polymer 23) (a = 0.10, b = 0.40, d = 0.25, f = 0.25, Mw = 6,500) | 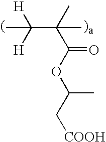 | 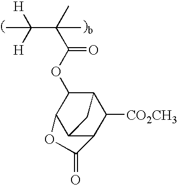 | 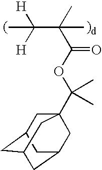 | 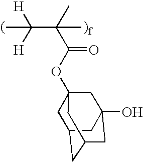 |
| (Polymer 24) (a = 0.10, b = 0.40, d = 0.25, f = 0.25, Mw = 6,200) | 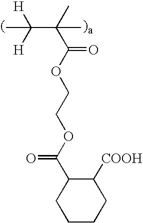 | 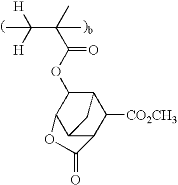 | 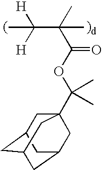 | 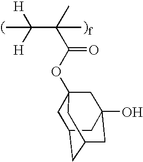 |
| (Polymer 25) (a = 0.10, b = 0.40, d = 0.25, f = 0.25, Mw = 5,600) | 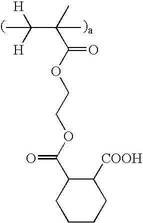 | 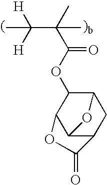 | 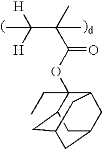 | 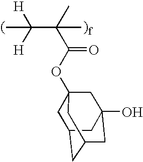 |
| (Polymer 26) (a = 0.10, b = 0.40, d = 0.25, f = 0.25, Mw = 5,800) | 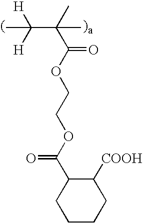 | 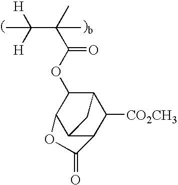 | 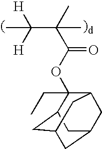 | 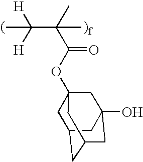 |
| (Polymer 27) (a = 0.10, b = 0.40, d = 0.25, f = 0.25, Mw = 6,300) | 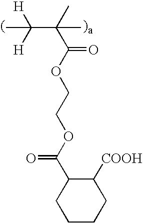 | 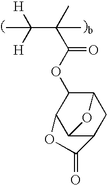 | 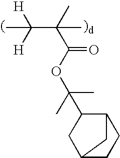 | 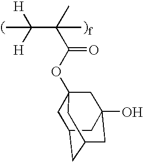 |
| (Polymer 28) (a = 0.10, b = 0.40, d = 0.25, f = 0.25, Mw = 6,800) | 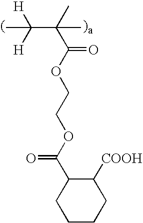 | 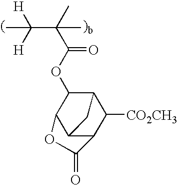 | 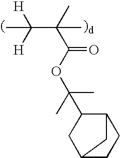 | 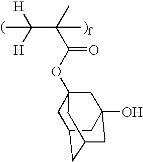 |
| (Polymer 29) (a = 0.10, b = 0.40, d = 0.25, f = 0.25, Mw = 5,800) | 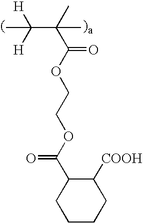 | 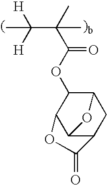 | 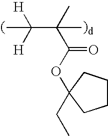 | 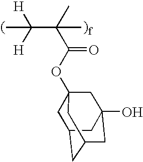 |
| (Polymer 30) (a = 0.10, b = 0.40, d = 0.25, f = 0.25, Mw = 5,800) | 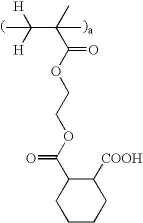 | 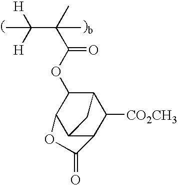 | 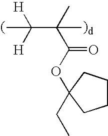 | 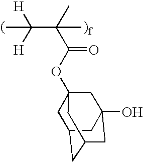 |
| (Polymer 31) (a = 0.10, b = 0.40, d = 0.25, f = 0.25, Mw = 5,800) | 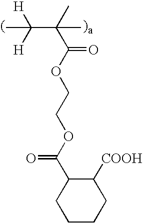 | 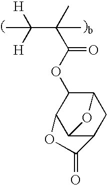 | 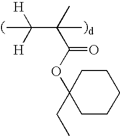 | 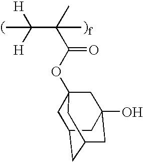 |
| (Polymer 32) (a = 0.10, b = 0.40, d = 0.25, f = 0.25, Mw = 5,800) | 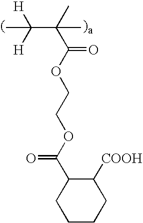 | 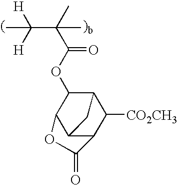 | 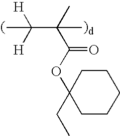 | 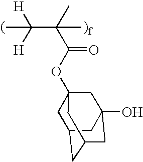 |
| (Polymer 33) (a = 0.10, b = 0.35, d = 0.30, f = 0.25, Mw = 7,000) | 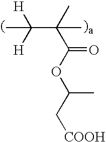 | 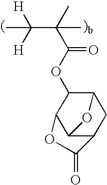 | 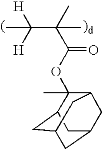 | 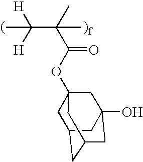 |
| (Polymer 34) (a = 0.10, b = 0.35, d = 0.30, f = 0.25, Mw = 6,800) | 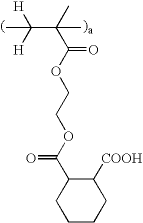 | 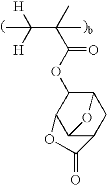 | 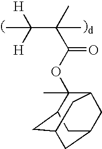 | 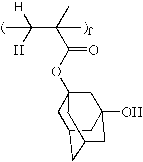 |
| (Polymer 35) (a = 0.10, b = 0.35, d = 0.30, f = 0.25, Mw = 6,500) | 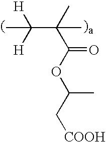 | 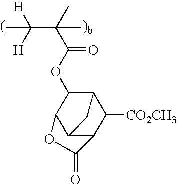 | 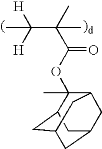 | 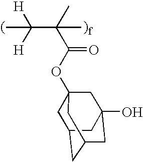 |
| (Polymer 36) (a = 0.10, b = 0.35, d = 0.30, f = 0.25, Mw = 7,100) | 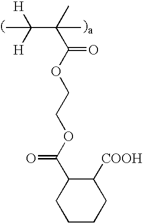 | 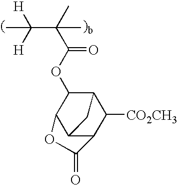 | 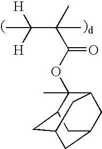 | 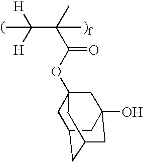 |
| (Polymer 37) (a = 0.10, b = 0.35, d = 0.30, f = 0.25, Mw = 7,700) | 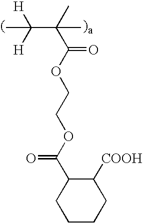 | 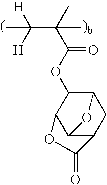 | 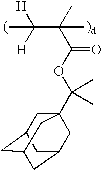 | 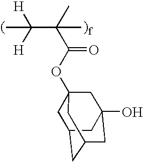 |
| (Polymer 38) (a = 0.10, b = 0.35, d = 0.30, f = 0.25, Mw = 8,300) | 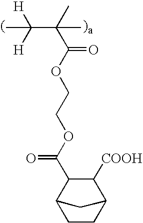 | 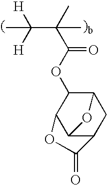 | 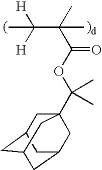 | 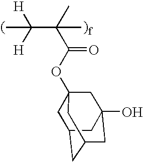 |
| (Polymer 39) (a = 0.10, b = 0.35, d = 0.30, f = 0.25, Mw = 7,000) | 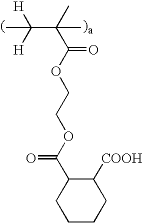 | 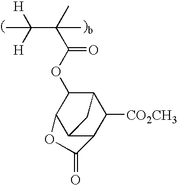 | 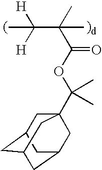 | 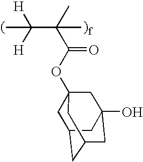 |
| (Polymer 40) (a = 0.10, b = 0.35, d = 0.30, f = 0.25, Mw = 7,100) | 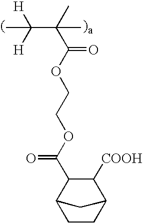 | 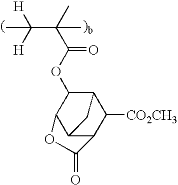 | 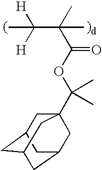 | 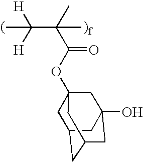 |
| (Polymer 41) (a = 0.10, b = 0.35, d = 0.30, f = 0.25, Mw = 5,800) | 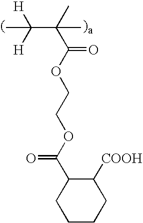 | 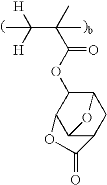 | 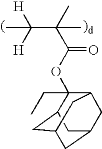 | 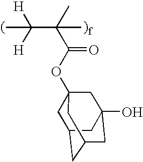 |
| (Polymer 42) (a = 0.10, b = 0.35, d = 0.30, f = 0.25, Mw = 5,600) | 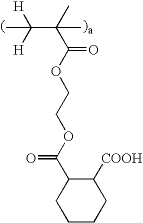 | 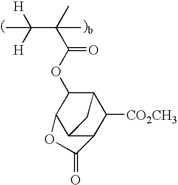 | 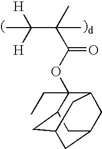 | 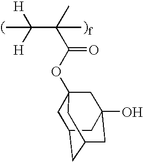 |
| (Polymer 43) (a = 0.10, b = 0.35, d = 0.30, f = 0.25, Mw = 6,700) | 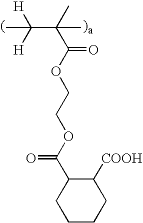 | 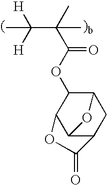 | 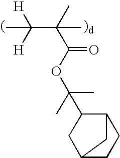 | 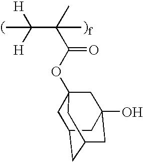 |
| (Polymer 44) (a = 0.10, b = 0.35, d = 0.30, f = 0.25, Mw = 6,000) | 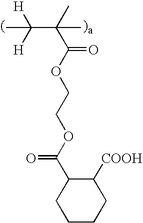 | 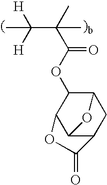 | 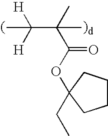 | 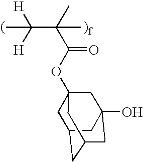 |
| (Polymer 45) (a = 0.10, b = 0.35, d = 0.30, f = 0.25, Mw = 6,100) | 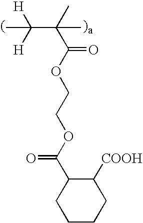 | 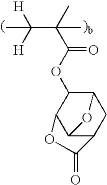 | 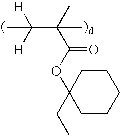 | 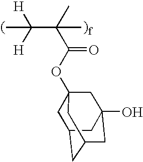 |
| (Polymer 46) (a = 0.15, b = 0.20, d = 0.45, f = 0.20, Mw = 6,700) | 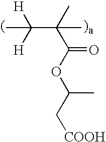 | 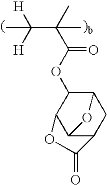 | 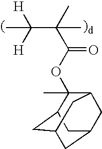 | 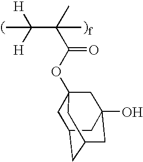 |
| (Polymer 47) (a = 0.15, b = 0.20, d = 0.45, f = 0.20, Mw = 6,500) | 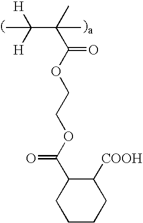 | 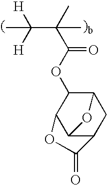 | 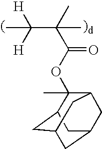 | 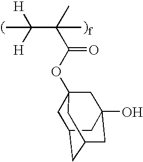 |
| (Polymer 48) (a = 0.15, b = 0.20, d = 0.45, f = 0.20, Mw = 6,500) | 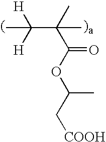 | 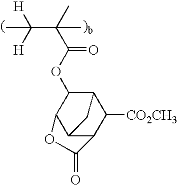 | 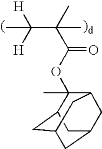 | 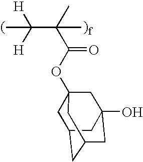 |
| (Polymer 49) (a = 0.15, b = 0.20, d = 0.45, f = 0.20, Mw = 6,800) | 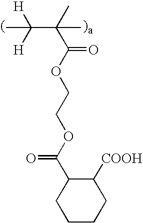 | 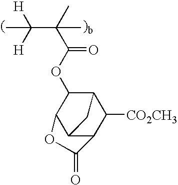 | 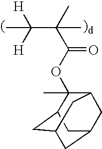 | 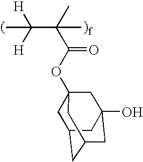 |
| (Polymer 50) (a = 0.15, b = 0.20, d = 0.45, f = 0.20, Mw = 7,600) | 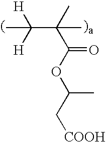 | 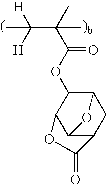 | 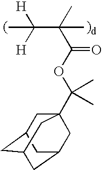 | 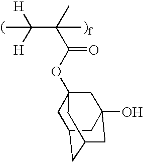 |
| (Polymer 51) (a = 0.15, b = 0.20, d = 0.45, f = 0.20, Mw = 7,100) | 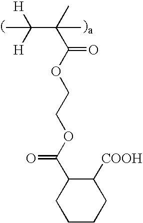 | 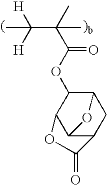 | 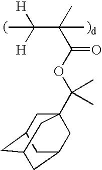 | 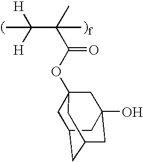 |
| (Polymer 52) (a = 0.15, b = 0.20, d = 0.45, f = 0.20, Mw = 6,800) | 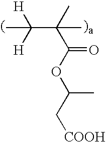 | 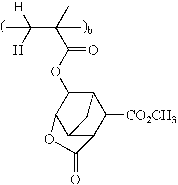 | 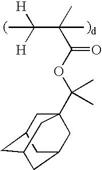 | 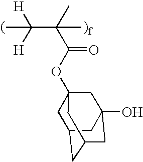 |
| (Polymer 53) (a = 0.15, b = 0.20, d = 0.45, f = 0.20, Mw = 7,000) | 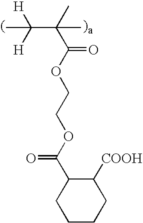 | 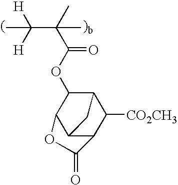 | 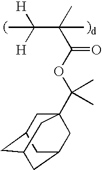 | 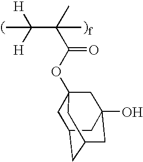 |
| (Polymer 54) (a = 0.15, b = 0.20, d = 0.45, f = 0.20, Mw = 5,700) | 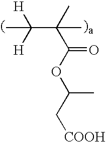 | 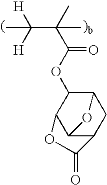 | 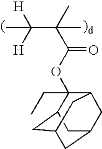 | 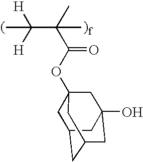 |
| (Polymer 55) (a = 0.15, b = 0.20, d = 0.45, f = 0.20, Mw = 5,700) | 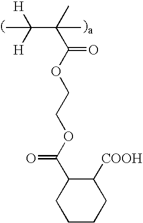 | 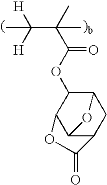 | 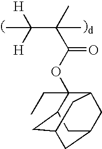 | 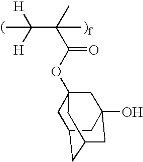 |
| (Polymer 56) (a = 0.15, b = 0.20, d = 0.45, f = 0.20, Mw = 5,700) | 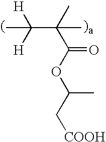 | 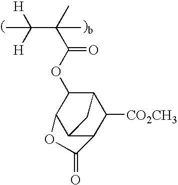 | 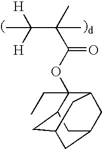 | 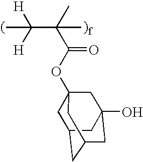 |
| (Polymer 57) (a = 0.15, b = 0.20, d = 0.45, f = 0.20, Mw = 5,700) | 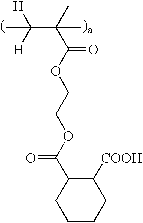 | 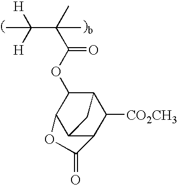 | 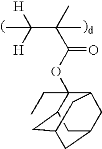 | 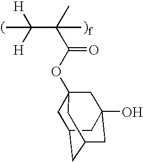 |
| (Polymer 58) (a = 0.15, b = 0.20, d = 0.45, f = 0.20, Mw = 6,500) | 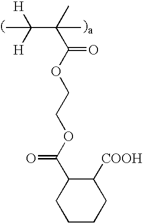 | 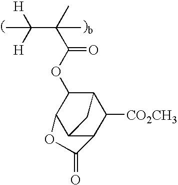 | 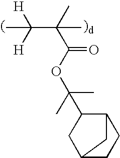 | 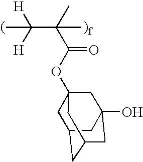 |
| (Polymer 59) (a = 0.15, b = 0.20, d = 0.45, f = 0.20, Mw = 5,800) | 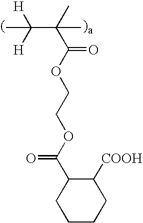 | 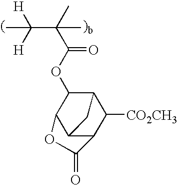 | 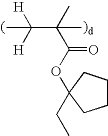 | 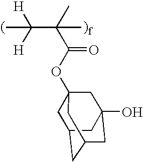 |
| (Polymer 60) (a = 0.15, b = 0.20, d = 0.45, f = 0.20, Mw = 5,700) | 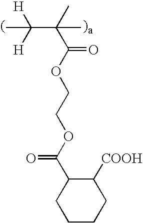 | 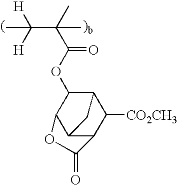 | 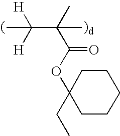 | 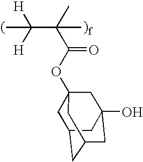 |
| (Polymer 61) (a = 0.10, b = 0.20, d = 0.50, f = 0.20, Mw = 6,200) | 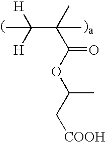 | 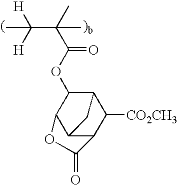 | 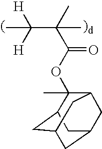 | 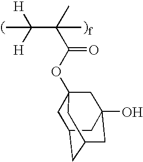 |
| (Polymer 62) (a = 0.10, b = 0.20, d = 0.50, f = 0.20, Mw = 6,400) | 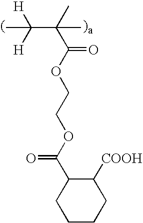 | 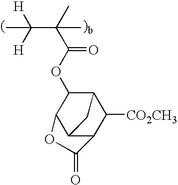 | 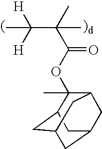 | 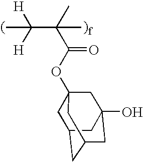 |
| (Polymer 63) (a = 0.10, b = 0.20, d = 0.50, f = 0.20, Mw = 6,700) | 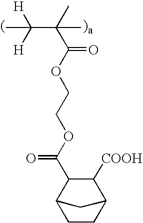 | 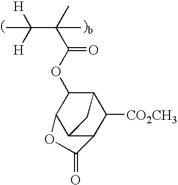 | 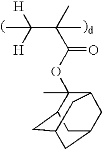 | 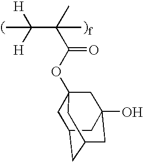 |
| (Polymer 64) (a = 0.10, b = 0.20, d = 0.50, f = 0.20, Mw = 6,800) | 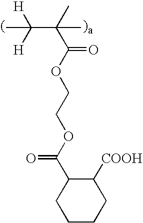 | 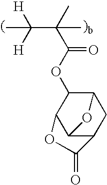 | 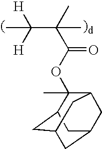 | 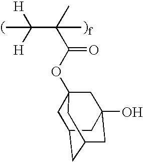 |
| (Polymer 65) (a = 0.10, b = 0.20, d = 0.50, f = 0.20, Mw = 7,000) | 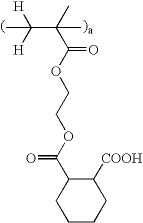 | 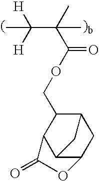 | 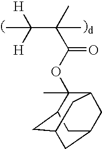 | 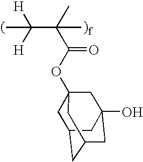 |
| (Polymer 66) (a = 0.10, b = 0.20, d = 0.50, f = 0.20, Mw = 6,700) | 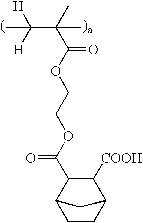 | 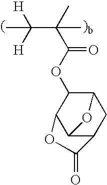 | 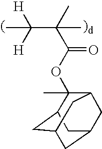 | 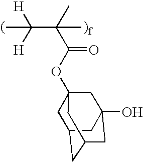 |
| (Polymer 67) (a = 0.10, b = 0.20, d = 0.50, f = 0.20, Mw = 7,500) | 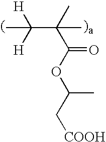 | 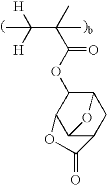 | 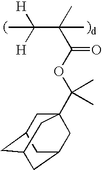 | 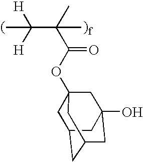 |
| (Polymer 68) (a = 0.10, b = 0.20, d = 0.50, f = 0.20, Mw = 7,300) | 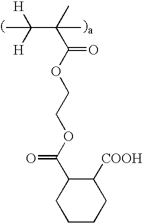 | 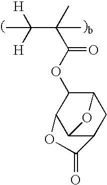 | 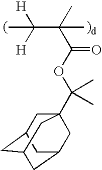 | 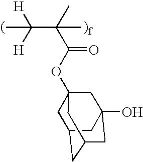 |
| (Polymer 69) (a = 0.10, b = 0.20, d = 0.50, f = 0.20, Mw = 7,700) | 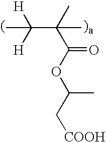 | 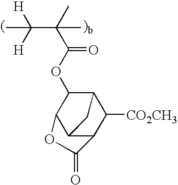 | 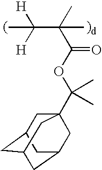 | 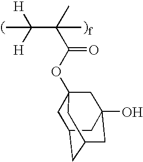 |
| (Polymer 70) (a = 0.10, b = 0.20, d = 0.50, f = 0.20, Mw = 7,500) | 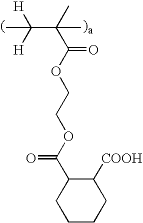 | 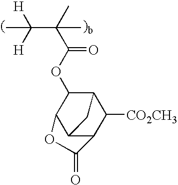 | 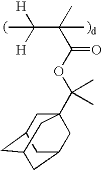 | 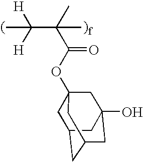 |
| (Polymer 71) (a = 0.10, b = 0.20, d = 0.50, f = 0.20, Mw = 5,800) | 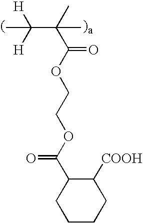 | 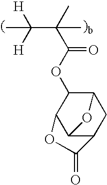 | 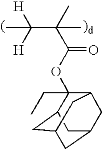 | 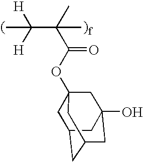 |
| (Polymer 72) (a = 0.10, b = 0.20, d = 0.50, f = 0.20, Mw = 6,100) | 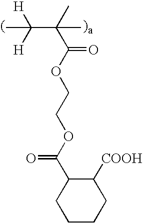 | 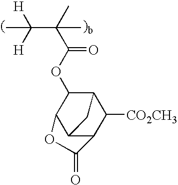 | 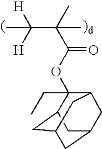 | 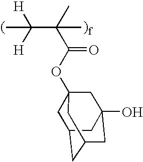 |
| (Polymer 73) (a = 0.10, b = 0.20, d = 0.50, f = 0.20, Mw = 5,300) | 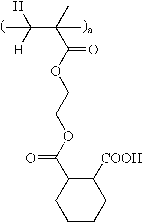 | 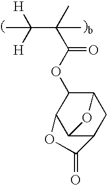 | 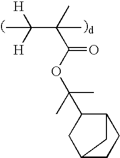 | 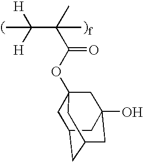 |
| (Polymer 74) (a = 0.10, b = 0.20, d = 0.50, f = 0.20, Mw = 5,500) | 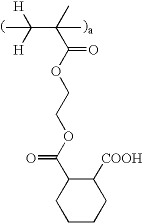 | 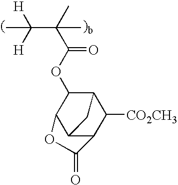 | 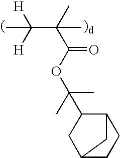 | 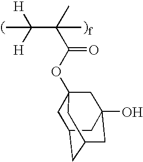 |
| (Polymer 75) (a = 0.10, b = 0.20, d = 0.50, f = 0.20, Mw = 6,100) | 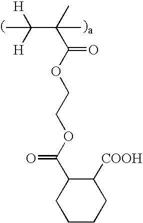 | 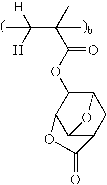 | 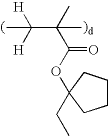 | 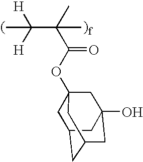 |
| (Polymer 76) (a = 0.10, b = 0.20, d = 0.50, f = 0.20, Mw = 6,300) | 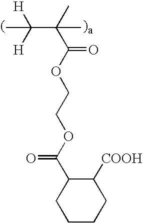 | 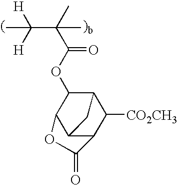 | 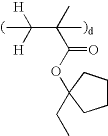 | 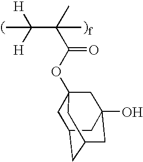 |
| (Polymer 77) (a = 0.10, b = 0.20, d = 0.50, f = 0.20, Mw = 6,500) | 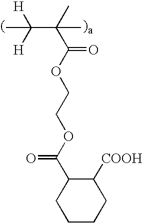 | 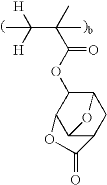 | 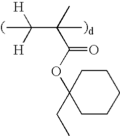 | 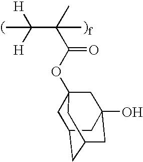 |
| (Polymer 78) (a = 0.10, b = 0.20, d = 0.50, f = 0.20, Mw = 7,000) | 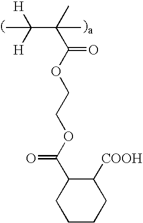 | 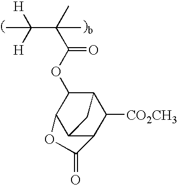 | 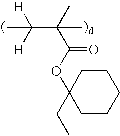 | 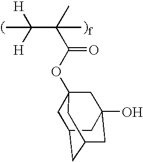 |

### Synthesis Example 46

Synthesis of Polymer 46

In 170 g of PGMEA were dissolved 8.66 g of 3-methacryloyloxybutanoic acid, 13.2 g of 4,8-dioxa-5-oxotricyclo[4.2.1.0^{3,7}]nonan-2-yl methacrylate, 39.3 g of 2-methyl-2-adamantyl methacrylate, 13.9 g of 3-hydroxy-1-adamantyl methacrylate, and 2.75 g of 2,2′-azobisisobutyronitrile. In a nitrogen atmosphere, this solution was added dropwise over 4 hours to 55 g of PGMEA which was heated at 80° C. At the end of dropwise addition, the solution was heated and stirred at 80° C. for 2 hours in the nitrogen atmosphere. After the reaction, the solution was cooled to room temperature, and with vigorous stirring, added dropwise to 1.7 L of hexane. The resulting solids were collected by filtration and dried under vacuum at 50° C. for 15 hours, obtaining 60.8 g (yield 81%) of a white solid. GPC and ¹³C-NMR spectrum showed the obtained white solid to be Polymer 46 having the formula described below and a Mw of 6,700.

### Synthesis Examples 47-78

Synthesis of Polymers 47-78

Polymers 47 to 78, identified below, were synthesized by the same procedure as above or a well-known procedure.

| | | | | |
|---|---|---|---|---|
| (Polymer 46) (a = 0.15, b = 0.20, d = 0.45, f = 0.20, Mw = 6,700) | 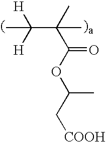 | 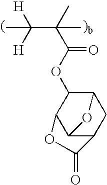 | 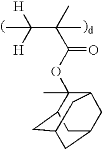 | 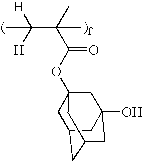 |
| (Polymer 47) (a = 0.15, b = 0.20, d = 0.45, f = 0.20, Mw = 6,500) | 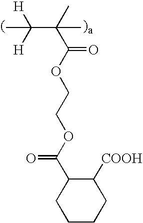 | 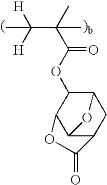 | 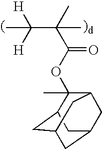 | 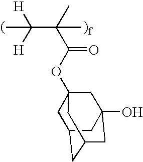 |
| (Polymer 48) (a = 0.15, b = 0.20, d = 0.45, f = 0.20, Mw = 6,500) | 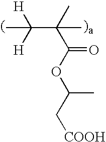 | 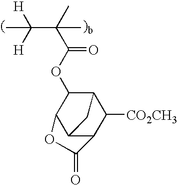 | 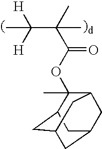 | 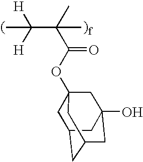 |
| (Polymer 49) (a = 0.15, b = 0.20, d = 0.45, f = 0.20, Mw = 6,800) | 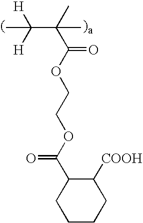 | 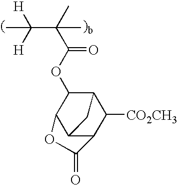 | 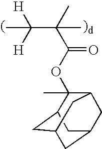 | 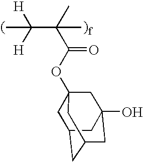 |
| (Polymer 50) (a = 0.15, b = 0.20, d = 0.45, f = 0.20, Mw = 7,600) | 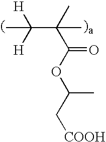 | 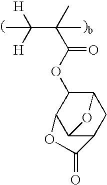 | 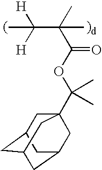 | 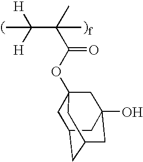 |
| (Polymer 51) (a = 0.15, b = 0.20, d = 0.45, f = 0.20, Mw = 7,100) | 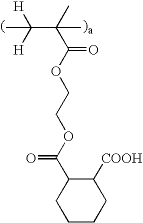 | 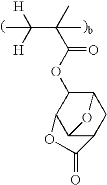 | 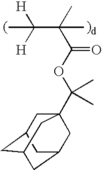 | 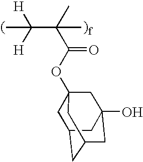 |
| (Polymer 52) (a = 0.15, b = 0.20, d = 0.45, f = 0.20, Mw = 6,800) | 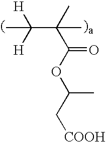 | 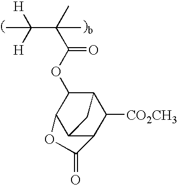 | 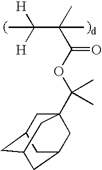 | 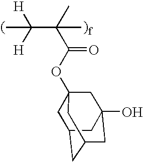 |
| (Polymer 53) (a = 0.15, b = 0.20, d = 0.45, f = 0.20, Mw = 7,000) | 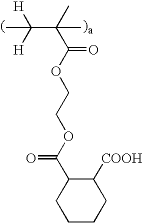 | 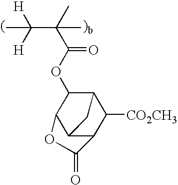 | 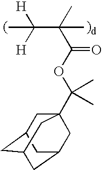 | 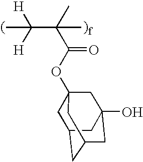 |
| (Polymer 54) (a = 0.15, b = 0.20, d = 0.45, f = 0.20, Mw = 5,700) | 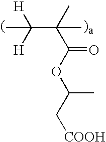 | 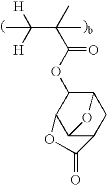 | 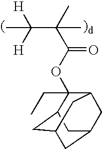 | 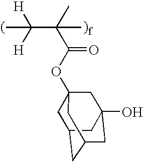 |
| (Polymer 55) (a = 0.15, b = 0.20, d = 0.45, f = 0.20, Mw = 5,700) | 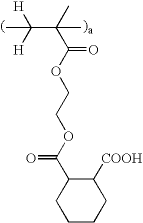 | 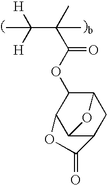 | 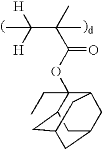 | 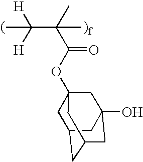 |
| (Polymer 56) (a = 0.15, b = 0.20, d = 0.45, f = 0.20, Mw = 5,700) | 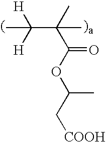 | 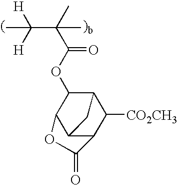 | 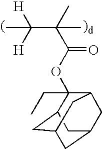 | 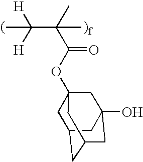 |
| (Polymer 57) (a = 0.15, b = 0.20, d = 0.45, f = 0.20, Mw = 5,700) | 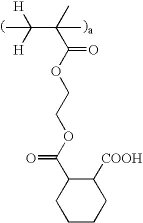 | 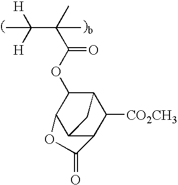 | 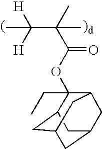 | 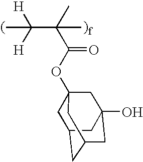 |
| (Polymer 58) (a = 0.15, b = 0.20, d = 0.45, f = 0.20, Mw = 6,500) | 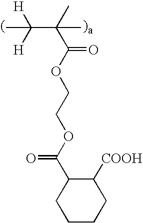 | 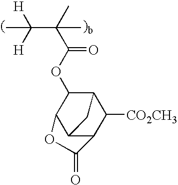 | 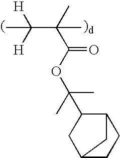 | 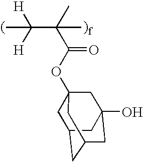 |
| (Polymer 59) (a = 0.15, b = 0.20, d = 0.45, f = 0.20, Mw = 5,800) | 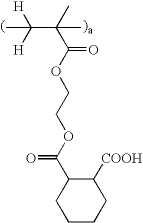 | 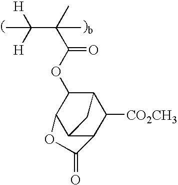 | 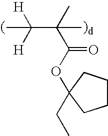 | 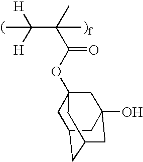 |
| (Polymer 60) (a = 0.15, b = 0.20, d = 0.45, f = 0.20, Mw = 5,700) | 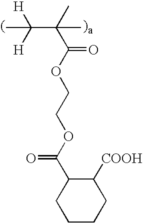 | 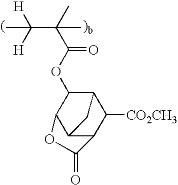 | 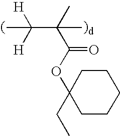 | 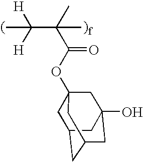 |
| (Polymer 61) (a = 0.10, b = 0.20, d = 0.50, f = 0.20, Mw = 6,200) | 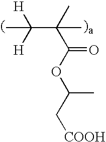 | 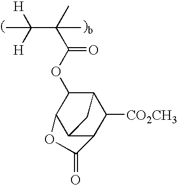 | 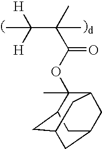 | 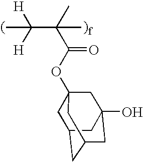 |
| (Polymer 62) (a = 0.10, b = 0.20, d = 0.50, f = 0.20, Mw = 6,400) | 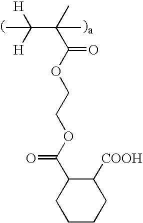 | 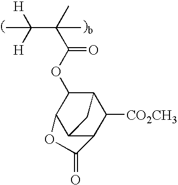 | 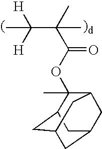 | 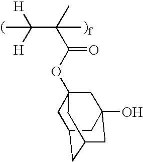 |
| (Polymer 63) (a = 0.10, b = 0.20, d = 0.50, f = 0.20, Mw = 6,700) | 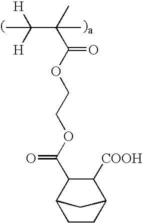 | 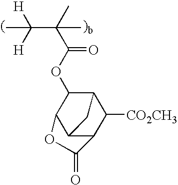 | 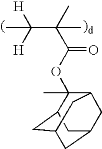 | 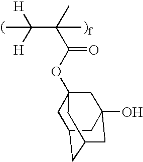 |
| (Polymer 64) (a = 0.10, b = 0.20, d = 0.50, f = 0.20, Mw = 6,800) | 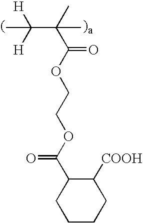 | 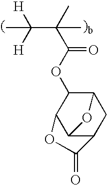 | 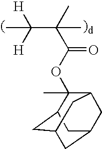 | 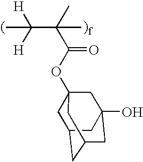 |
| (Polymer 65) (a = 0.10, b = 0.20, d = 0.50, f = 0.20, Mw = 7,000) | 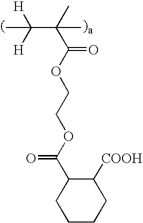 | 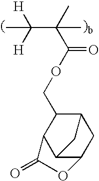 | 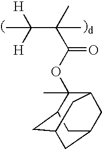 | 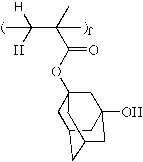 |
| (Polymer 66) (a = 0.10, b = 0.20, d = 0.50, f = 0.20, Mw = 6,700) | 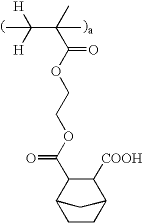 | 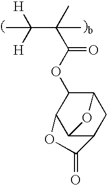 | 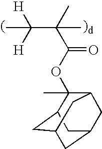 | 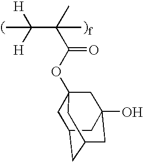 |
| (Polymer 67) (a = 0.10, b = 0.20, d = 0.50, f = 0.20, Mw = 7,500) | 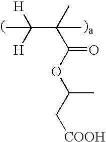 | 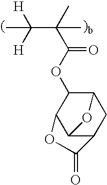 | 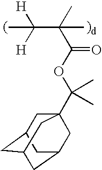 | 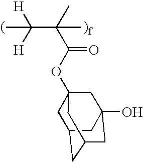 |
| (Polymer 68) (a = 0.10, b = 0.20, d = 0.50, f = 0.20, Mw = 7,300) | 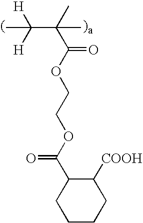 | 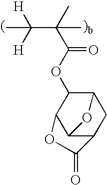 | 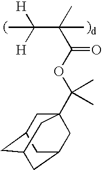 | 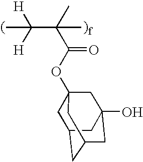 |
| (Polymer 69) (a = 0.10, b = 0.20, d = 0.50, f = 0.20, Mw = 7,700) | 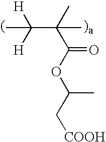 | 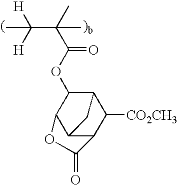 | 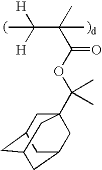 | 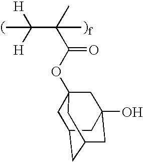 |
| (Polymer 70) (a = 0.10, b = 0.20, d = 0.50, f = 0.20, Mw = 7,500) | 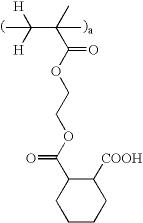 | 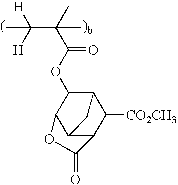 | 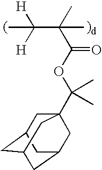 | 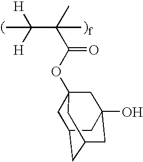 |
| (Polymer 71) (a = 0.10, b = 0.20, d = 0.50, f = 0.20, Mw = 5,800) | 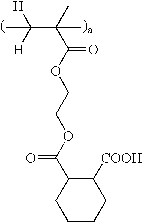 | 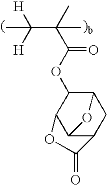 | 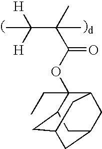 | 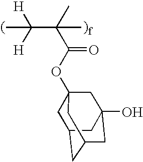 |
| (Polymer 72) (a = 0.10, b = 0.20, d = 0.50, f = 0.20, Mw = 6,100) | 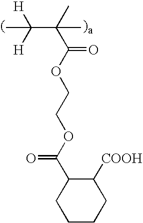 | 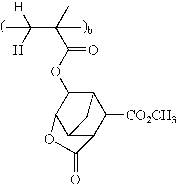 | 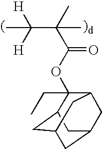 | 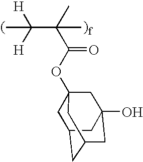 |
| (Polymer 73) (a = 0.10, b = 0.20, d = 0.50, f = 0.20, Mw = 5,300) | 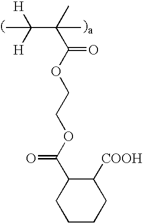 | 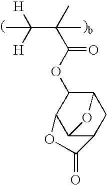 | 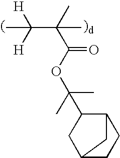 | 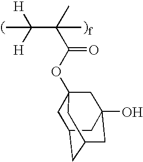 |
| (Polymer 74) (a = 0.10, b = 0.20, d = 0.50, f = 0.20, Mw = 5,500) | 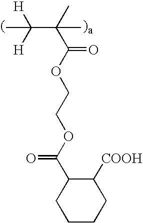 | 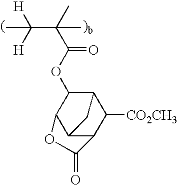 | 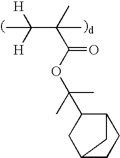 | 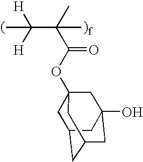 |
| (Polymer 75) (a = 0.10, b = 0.20, d = 0.50, f = 0.20, Mw = 6,100) | 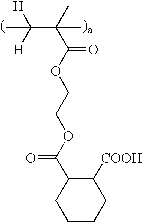 | 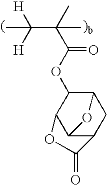 | 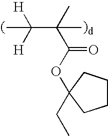 | 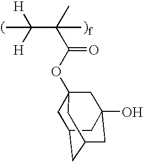 |
| (Polymer 76) (a = 0.10, b = 0.20, d = 0.50, f = 0.20, Mw = 6,300) | 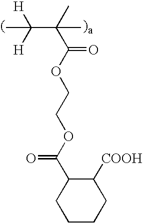 | 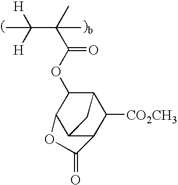 | 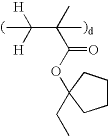 | 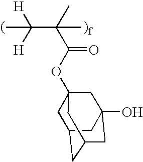 |
| (Polymer 77) (a = 0.10, b = 0.20, d = 0.50, f = 0.20, Mw = 6,500) | 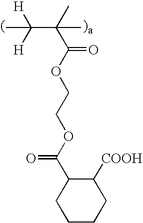 | 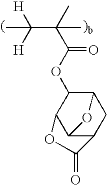 | 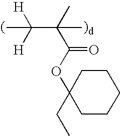 | 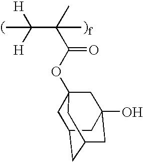 |
| (Polymer 78) (a = 0.10, b = 0.20, d = 0.50, f = 0.20, Mw = 7,000) | 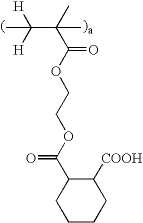 | 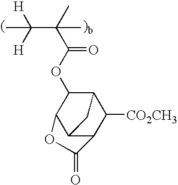 | 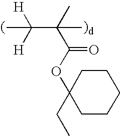 | 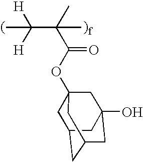 |

### Examples

Resist compositions were formulated using inventive polymers and examined for resolution.

### Examples 1-78 & Comparative Examples 79-93

Resist compositions were prepared by using inventive Polymers 1 to 78 or comparative Polymers 79 to 93, identified below, as the base resin, and dissolving the polymer, a photoacid generator, and a basic compound in a solvent in accordance with the recipe shown in Tables 1 to 3. These compositions were each filtered through a Teflon® filter having a pore diameter 0.2 μm, thereby giving resist solutions.

| | | | |
|---|---|---|---|
| (Polymer 79) (b = 0.50, d = 0.50, Mw = 6,700) | 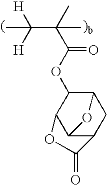 | 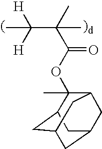 | |
| (Polymer 80) (b = 0.50, d = 0.50, Mw = 6,000) | 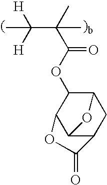 | 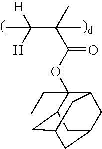 | |
| (Polymer 81) (b = 0.50, d = 0.50, Mw = 7,600) | 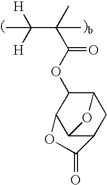 | 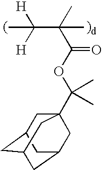 | |
| (Polymer 82) (b = 0.50, d = 0.50, Mw = 6,900) | 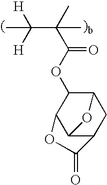 | 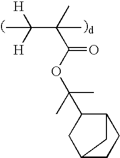 | |
| (Polymer 83) (b = 0.50, d = 0.50, Mw = 6,300) | 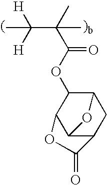 | 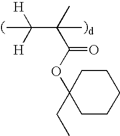 | |
| (Polymer 84) (b = 0.40, d = 0.35, f = 0.25, Mw = 6,500) | 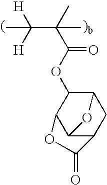 | 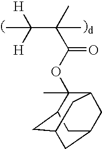 | 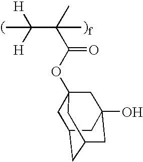 |
| (Polymer 85) (b = 0.40, d = 0.35, f = 0.25, Mw = 5,700) | 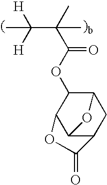 | 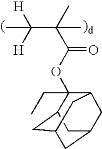 | 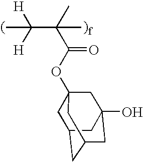 |
| (Polymer 86) (b = 0.40, d = 0.35, f = 0.25, Mw = 7,300) | 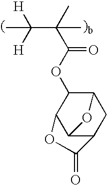 | 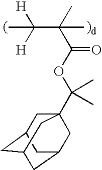 | 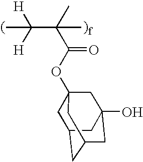 |
| (Polymer 87) (b = 0.40, d = 0.35, f = 0.25, Mw = 6,700) | 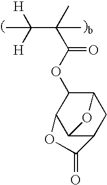 | 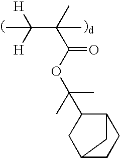 | 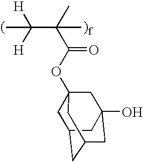 |
| (Polymer 88) (b = 0.40, d = 0.35, f = 0.25, Mw = 6,000) | 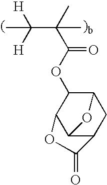 | 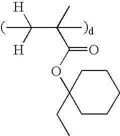 | 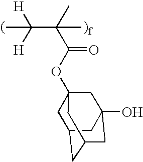 |
| (Polymer 89) (b = 0.30, d = 0.50, f = 0.20, Mw = 6,900) | 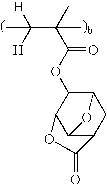 | 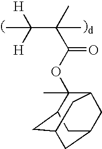 | 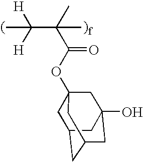 |
| (Polymer 90) (b = 0.30, d = 0.50, f = 0.20, Mw = 5,500) | 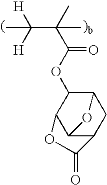 | 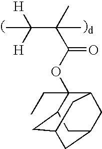 | 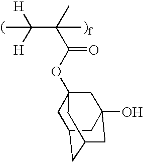 |
| (Polymer 91) (b = 0.30, d = 0.50, f = 0.20, Mw = 7,800) | 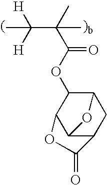 | 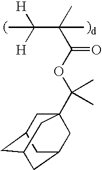 | 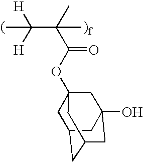 |
| (Polymer 92) (b = 0.30, d = 0.50, f = 0.20, Mw = 7,700) | 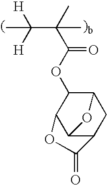 | 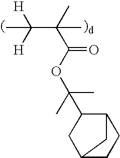 | 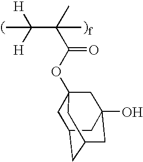 |
| (Polymer 93) (b = 0.30, d = 0.50, f = 0.20, Mw = 7,000) | 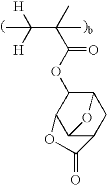 | 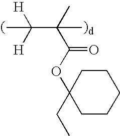 | 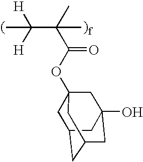 |

These resist solutions were spin coated onto silicon wafers having an antireflective film (ARC29A by Nissan Chemical Co., Ltd., 78 nm thick) coated thereon, then heat treated at 130° C. for 60 seconds to form resist films having a thickness of 250 nm. The resist films were exposed using an ArF excimer laser stepper (Nikon Corporation; NA 0.68), then heat treated at 100° C. to 130° C. for 60 seconds, and puddle developed with a solution of 2.38 wt % tetramethylammonium hydroxide in water for 60 seconds, thereby giving 1:1 line-and-space patterns.

The wafers as developed were sectioned and observed under sectional SEM. The optimal exposure (Eop, mJ/cm²) was defined as the exposure dose which provided a 1:1 resolution at the top and bottom of a 0.13 μm line-and-space pattern. The resolution of the resist under evaluation was defined as the minimum line width (μm) of the lines and spaces that separated at the optimal exposure. The profile of the resist pattern was examined under a SEM and classified into rectangular, rounded top, T-top, forward taper and reverse taper. The adhesion of resist film to substrate was examined and rated “◯” (firm) or “X” (weak). The roughness of sidewall was examined and rated “⊚” (very smooth), “◯” (smooth), “Δ” (somewhat rough) or “X” (rough). If any pattern was found seized, collapsed or fallen down, such a remark was made.

The composition and test results of the resist of each example are reported in Tables 1 and 2. The composition and test results of the resist of each comparative example are reported in Table 3. The acid generator, basic compound and solvent shown in Tables 1 to 3 are identified below. It is noted that the solvent contained 0.01% by weight of surfactant KH-20 (Asahi Glass Co., Ltd.).

TPSNF: triphenylsulfonium nonafluorobutanesulfonate

TMMEA: trismethoxymethoxyethylamine

PGMEA: propylene glycol methyl ether acetate

TABLE 1

| | | Photoacid | Basic | | PEB | | | | | |
|---|---|---|---|---|---|---|---|---|---|---|
| | Resin | generator | compound | Solvent | temp., | Eop, | Resolution, | | Substrate | Sidewall |
| Example | (pbw) | (pbw) | (pbw) | (pbw) | ° C. | mJ/cm² | μm | Profile | adhesion | roughness |
| 1 | Polymer 1 | TPSNF | TMMEA | PGMEA | 130 | 33.0 | 0.13 | rectangular | ◯ | ⊚ |
| | (80) | (2.18) | (0.472) | (640) | | | | | | |
| 2 | Polymer 2 | TPSNF | TMMEA | PGMEA | 130 | 31.0 | 0.13 | rectangular | ◯ | ◯ |
| | (80) | (2.18) | (0.472) | (640) | | | | | | |
| 3 | Polymer 3 | TPSNF | TMMEA | PGMEA | 130 | 30.0 | 0.13 | rectangular | ◯ | ⊚ |
| | (80) | (2.18) | (0.472) | (640) | | | | | | |
| 4 | Polymer 4 | TPSNF | TMMEA | PGMEA | 120 | 26.0 | 0.12 | rectangular | ◯ | ◯ |
| | (80) | (2.18) | (0.472) | (640) | | | | | | |
| 5 | Polymer 6 | TPSNF | TMMEA | PGMEA | 125 | 27.0 | 0.13 | rectangular | ◯ | ⊚ |
| | (80) | (2.18) | (0.472) | (640) | | | | | | |
| 6 | Polymer 7 | TPSNF | TMMEA | PGMEA | 125 | 31.0 | 0.13 | rectangular | ◯ | ◯ |
| | (80) | (2.18) | (0.472) | (640) | | | | | | |
| 7 | Polymer 8 | TPSNF | TMMEA | PGMEA | 125 | 28.0 | 0.12 | rectangular | ◯ | ◯ |
| | (80) | (2.18) | (0.472) | (640) | | | | | | |
| 8 | Polymer 9 | TPSNF | TMMEA | PGMEA | 125 | 27.0 | 0.12 | rectangular | ◯ | ◯ |
| | (80) | (2.18) | (0.472) | (640) | | | | | | |
| 9 | Polymer 10 | TPSNF | TMMEA | PGMEA | 125 | 27.0 | 0.13 | rectangular | ◯ | ⊚ |
| | (80) | (2.18) | (0.472) | (640) | | | | | | |
| 10 | Polymer 11 | TPSNF | TMMEA | PGMEA | 115 | 24.0 | 0.13 | rectangular | ◯ | ◯ |
| | (80) | (2.18) | (0.472) | (640) | | | | | | |
| 11 | Polymer 12 | TPSNF | TMMEA | PGMEA | 115 | 24.0 | 0.12 | rectangular | ◯ | ⊚ |
| | (80) | (2.18) | (0.472) | (640) | | | | | | |
| 12 | Polymer 14 | TPSNF | TMMEA | PGMEA | 120 | 28.0 | 0.13 | rectangular | ◯ | ◯ |
| | (80) | (2.18) | (0.472) | (640) | | | | | | |
| 13 | Polymer 15 | TPSNF | TMMEA | PGMEA | 130 | 28.0 | 0.12 | rectangular | ◯ | ◯ |
| | (80) | (2.18) | (0.472) | (640) | | | | | | |
| 14 | Polymer 16 | TPSNF | TMMEA | PGMEA | 130 | 26.0 | 0.11 | rectangular | ◯ | ◯ |
| | (80) | (2.18) | (0.472) | (640) | | | | | | |
| 15 | Polymer 18 | TPSNF | TMMEA | PGMEA | 130 | 26.0 | 0.12 | rectangular | ◯ | ⊚ |
| | (80) | (2.18) | (0.472) | (640) | | | | | | |
| 16 | Polymer 19 | TPSNF | TMMEA | PGMEA | 130 | 28.0 | 0.13 | rectangular | ◯ | ⊚ |
| | (80) | (2.18) | (0.472) | (640) | | | | | | |
| 17 | Polymer 20 | TPSNF | TMMEA | PGMEA | 130 | 29.0 | 0.12 | rectangular | ◯ | ◯ |
| | (80) | (2.18) | (0.472) | (640) | | | | | | |
| 18 | Polymer 21 | TPSNF | TMMEA | PGMEA | 125 | 28.0 | 0.12 | rectangular | ◯ | ◯ |
| | (80) | (2.18) | (0.472) | (640) | | | | | | |
| 19 | Polymer 22 | TPSNF | TMMEA | PGMEA | 125 | 27.0 | 0.11 | rectangular | ◯ | ◯ |
| | (80) | (2.18) | (0.472) | (640) | | | | | | |
| 20 | Polymer 23 | TPSNF | TMMEA | PGMEA | 125 | 26.0 | 0.12 | rectangular | ◯ | ◯ |
| | (80) | (2.18) | (0.472) | (640) | | | | | | |
| 21 | Polymer 25 | TPSNF | TMMEA | PGMEA | 120 | 23.0 | 0.12 | rectangular | ◯ | ◯ |
| | (80) | (2.18) | (0.472) | (640) | | | | | | |
| 22 | Polymer 26 | TPSNF | TMMEA | PGMEA | 120 | 22.0 | 0.12 | rectangular | ◯ | ◯ |
| | (80) | (2.18) | (0.472) | (640) | | | | | | |
| 23 | Polymer 27 | TPSNF | TMMEA | PGMEA | 120 | 25.0 | 0.12 | rectangular | ◯ | ◯ |
| | (80) | (2.18) | (0.472) | (640) | | | | | | |
| 24 | Polymer 28 | TPSNF | TMMEA | PGMEA | 120 | 25.0 | 0.12 | rectangular | ◯ | ⊚ |
| | (80) | (2.18) | (0.472) | (640) | | | | | | |

TABLE 2

| | | Photoacid | Basic | | PEB | | | | | |
|---|---|---|---|---|---|---|---|---|---|---|
| | Resin | generator | compound | Solvent | temp., | Eop, | Resolution, | | Substrate | Sidewall |
| Example | (pbw) | (pbw) | (pbw) | (pbw) | ° C. | mJ/cm² | μm | Profile | adhesion | roughness |
| 25 | Polymer 29 | TPSNF | TMMEA | PGMEA | 120 | 23.0 | 0.12 | rectangular | ◯ | ⊚ |
| | (80) | (2.18) | (0.472) | (640) | | | | | | |
| 26 | Polymer 30 | TPSNF | TMMEA | PGMEA | 120 | 24.0 | 0.12 | rectangular | ◯ | ⊚ |
| | (80) | (2.18) | (0.472) | (640) | | | | | | |
| 27 | Polymer 31 | TPSNF | TMMEA | PGMEA | 120 | 24.0 | 0.11 | rectangular | ◯ | ◯ |
| | (80) | (2.18) | (0.472) | (640) | | | | | | |
| 28 | Polymer 32 | TPSNF | TMMEA | PGMEA | 120 | 22.0 | 0.12 | rectangular | ◯ | ⊚ |
| | (80) | (2.18) | (0.472) | (640) | | | | | | |
| 29 | Polymer 34 | TPSNF | TMMEA | PGMEA | 130 | 26.0 | 0.11 | rectangular | ◯ | ⊚ |
| | (80) | (2.18) | (0.472) | (640) | | | | | | |
| 30 | Polymer 37 | TPSNF | TMMEA | PGMEA | 125 | 25.0 | 0.12 | rectangular | ◯ | ◯ |
| | (80) | (2.18) | (0.472) | (640) | | | | | | |
| 31 | Polymer 41 | TPSNF | TMMEA | PGMEA | 120 | 23.0 | 0.13 | rectangular | ◯ | ◯ |
| | (80) | (2.18) | (0.472) | (640) | | | | | | |
| 32 | Polymer 43 | TPSNF | TMMEA | PGMEA | 120 | 25.0 | 0.12 | rectangular | ◯ | ⊚ |
| | (80) | (2.18) | (0.472) | (640) | | | | | | |
| 33 | Polymer 44 | TPSNF | TMMEA | PGMEA | 120 | 23.0 | 0.12 | rectangular | ◯ | ⊚ |
| | (80) | (2.18) | (0.472) | (640) | | | | | | |
| 34 | Polymer 4 5 | TPSNF | TMMEA | PGMEA | 120 | 24.0 | 0.13 | rectangular | ◯ | ⊚ |
| | (80) | (2.18) | (0.472) | (640) | | | | | | |
| 35 | Polymer 49 | TPSNF | TMMEA | PGMEA | 125 | 25.0 | 0.11 | rectangular | ◯ | ⊚ |
| | (80) | (2.18) | (0.472) | (640) | | | | | | |
| 36 | Polymer 52 | TPSNF | TMMEA | PGMEA | 120 | 25.0 | 0.11 | rectangular | ◯ | ◯ |
| | (80) | (2.18) | (0.472) | (640) | | | | | | |
| 37 | Polymer 54 | TPSNF | TMMEA | PGMEA | 115 | 22.0 | 0.12 | rectangular | ◯ | ◯ |
| | (80) | (2.18) | (0.472) | (640) | | | | | | |
| 38 | Polymer 58 | TPSNF | TMMEA | PGMEA | 115 | 24.0 | 0.12 | rectangular | ◯ | ⊚ |
| | (80) | (2.18) | (0.472) | (640) | | | | | | |
| 39 | Polymer 59 | TPSNF | TMMEA | PGMEA | 115 | 24.0 | 0.12 | rectangular | ◯ | ⊚ |
| | (80) | (2.18) | (0.472) | (640) | | | | | | |
| 40 | Polymer 60 | TPSNF | TMMEA | PGMEA | 115 | 24.0 | 0.13 | rectangular | ◯ | ◯ |
| | (80) | (2.18) | (0.472) | (640) | | | | | | |
| 41 | Polymer 62 | TPSNF | TMMEA | PGMEA | 125 | 26.0 | 0.11 | rectangular | ◯ | ⊚ |
| | (80) | (2.18) | (0.472) | (640) | | | | | | |
| 42 | Polymer 64 | TPSNF | TMMEA | PGMEA | 125 | 25.0 | 0.11 | rectangular | ◯ | ◯ |
| | (80) | (2.18) | (0.472) | (640) | | | | | | |
| 43 | Polymer 65 | TPSNF | TMMEA | PGMEA | 125 | 21.0 | 0.12 | rectangular | ◯ | ⊚ |
| | (80) | (2.18) | (0.472) | (640) | | | | | | |
| 44 | Polymer 69 | TPSNF | TMMEA | PGMEA | 120 | 25.0 | 0.11 | rectangular | ◯ | ◯ |
| | (80) | (2.18) | (0.472) | (640) | | | | | | |
| 45 | Polymer 71 | TPSNF | TMMEA | PGMEA | 115 | 20.0 | 0.12 | rectangular | ◯ | ◯ |
| | (80) | (2.18) | (0.472) | (640) | | | | | | |
| 46 | Polymer 73 | TPSNF | TMMEA | PGMEA | 115 | 21.0 | 0.11 | rectangular | ◯ | ⊚ |
| | (80) | (2.18) | (0.472) | (640) | | | | | | |
| 47 | Polymer 76 | TPSNF | TMMEA | PGMEA | 115 | 22.0 | 0.12 | rectangular | ◯ | ⊚ |
| | (80) | (2.18) | (0.472) | (640) | | | | | | |
| 48 | Polymer 77 | TPSNF | TMMEA | PGMEA | 115 | 21.0 | 0.12 | rectangular | ◯ | ⊚ |
| | (80) | (2.18) | (0.472) | (640) | | | | | | |

TABLE 3

| Compar- | | Photoacid | Basic | | PEB | | | | | |
|---|---|---|---|---|---|---|---|---|---|---|
| ative | Resin | generator | compound | Solvent | temp., | Eop, | Resolution, | | Substrate | Sidewall |
| Example | (pbw) | (pbw) | (pbw) | (pbw) | ° C. | mJ/cm² | μm | Profile | adhesion | roughness |
| 1 | Polymer 79 | TPSNF | TMMEA | PGMEA | 125 | 28.0 | 0.14 | T-top | X | X |
| | (80) | (2.18) | (0.472) | (640) | | | | | | pattern |
| | | | | | | | | | | swelling |
| 2 | Polymer 80 | TPSNF | TMMEA | PGMEA | 115 | 25.0 | 0.13 | forward | X | X |
| | (80) | (2.18) | (0.472) | (640) | | | | taper | | pattern |
| | | | | | | | | | | swelling |
| 3 | Polymer 81 | TPSNF | TMMEA | PGMEA | 120 | 28.0 | 0.14 | T-top | X | X |
| | (80) | (2.18) | (0.472) | (640) | | | | | | pattern |
| | | | | | | | | | | collapse |
| 4 | Polymer 82 | TPSNF | TMMEA | PGMEA | 115 | 26.0 | 0.14 | rectangular | X | Δ |
| | (80) | (2.18) | (0.472) | (640) | | | | | | |
| 5 | Polymer 83 | TPSNF | TMMEA | PGMEA | 115 | 27.0 | 0.14 | rounded top | ◯ | Δ |
| | (80) | (2.18) | (0.472) | (640) | | | | | | |
| 6 | Polymer 84 | TPSNF | TMMEA | PGMEA | 130 | 28.0 | 0.13 | T-top | ◯ | Δ |
| | (80) | (2.18) | (0.472) | (640) | | | | | | |
| 7 | Polymer 85 | TPSNF | TMMEA | PGMEA | 120 | 25.0 | 0.13 | rounded top | X | X |
| | (80) | (2.18) | (0.472) | (640) | | | | | | |
| 8 | Polymer 86 | TPSNF | TMMEA | PGMEA | 125 | 28.0 | 0.14 | T-top | ◯ | X |
| | (80) | (2.18) | (0.472) | (640) | | | | | | |
| 9 | Polymer 87 | TPSNF | TMMEA | PGMEA | 120 | 26.0 | 0.14 | rounded top | ◯ | Δ |
| | (80) | (2.18) | (0.472) | (640) | | | | | | |
| 10 | Polymer 88 | TPSNF | TMMEA | PGMEA | 120 | 26.0 | 0.14 | rounded top | ◯ | ◯ |
| | (80) | (2.18) | (0.472) | (640) | | | | | | |
| 11 | Polymer 89 | TPSNF | TMMEA | PGMEA | 125 | 26.0 | 0.13 | rectangular | X | X |
| | (80) | (2.18) | (0.472) | (640) | | | | | | pattern |
| | | | | | | | | | | swelling |
| 12 | Polymer 90 | TPSNF | TMMEA | PGMEA | 115 | 24.0 | 0.12 | T-top | X | X |
| | (80) | (2.18) | (0.472) | (640) | | | | | | pattern |
| | | | | | | | | | | swelling |
| 13 | Polymer 91 | TPSNF | TMMEA | PGMEA | 120 | 27.0 | 0.14 | T-top | X | X |
| | (80) | (2.18) | (0.472) | (640) | | | | | | pattern |
| | | | | | | | | | | swelling |
| 14 | Polymer 92 | TPSNF | TMMEA | PGMEA | 115 | 24.0 | 0.14 | T-top | ◯ | ◯ |
| | (80) | (2.18) | (0.472) | (640) | | | | | | |
| 15 | Polymer 93 | TPSNF | TMMEA | PGMEA | 115 | 24.0 | 0.13 | rounded top | ◯ | ◯ |
| | (80) | (2.18) | (0.472) | (640) | | | | | | |

It is seen from Tables 1 to 3 that the resist compositions within the scope of the invention are improved in sensitivity, resolution, and solvent dissolution and minimized in sidewall roughness upon ArF excimer laser exposure.

Japanese Patent Application No. 2004-182686 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A polymer comprising recurring units having the general formulae (1) and (2), the recurring units being of at least one type for each formula, and having a weight average molecular weight of 1,000 to 50,000, 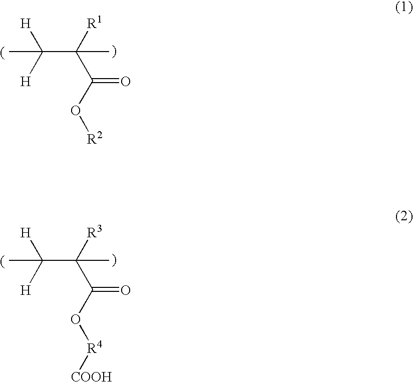
wherein R¹ and R³ are independently hydrogen or methyl, R⁴ is a straight, branched or cyclic alkylene group of 1 to 20 carbon atoms, which may be substituted with at least one oxygen-containing functional group and/or have at least one oxygen atom intervening in at least one carbon-to-carbon bond, R² is a lactone structure-containing substituent group selected from the general formulae (R²-1) to (R²-4): 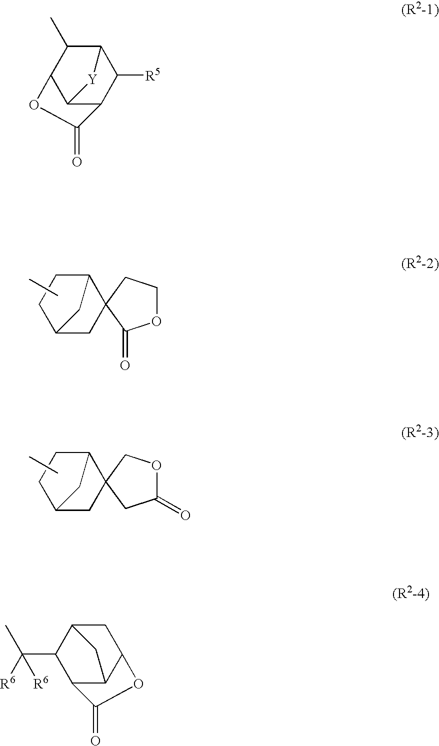
wherein Y is a methylene group or oxygen atom, R⁵ is CO₂R⁷ when Y is methylene, or R⁵ is hydrogen or CO₂R⁷ when Y is oxygen, R⁶ is each independently hydrogen or a straight, branched or cyclic alkyl group of 1 to 10 carbon atoms, two R⁶ may bond together to form a ring with the carbon atom to which they are attached, and R′ is a straight, branched or cyclic alkyl group of 1 to 15 carbon atoms which may have at least one oxygen atom intervening in at least one carbon-to-carbon bond.

2. A polymer comprising recurring units having the general formulae (1) to (3), the recurring units being of at least one type for each formula, and having a weight average molecular weight of 1,000 to 50,000, 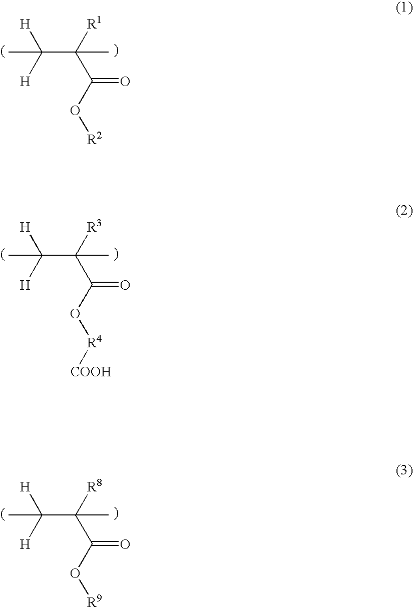
wherein R¹, R³ and R⁸ are independently hydrogen or methyl, R⁴ is a straight, branched or cyclic alkylene group of 1 to 20 carbon atoms, which may be substituted with at least one oxygen-containing functional group and/or have at least one oxygen atom intervening in at least one carbon-to-carbon bond, R² is a lactone structure-containing substituent group selected from the general formulae (R²-1) to (R²-4): 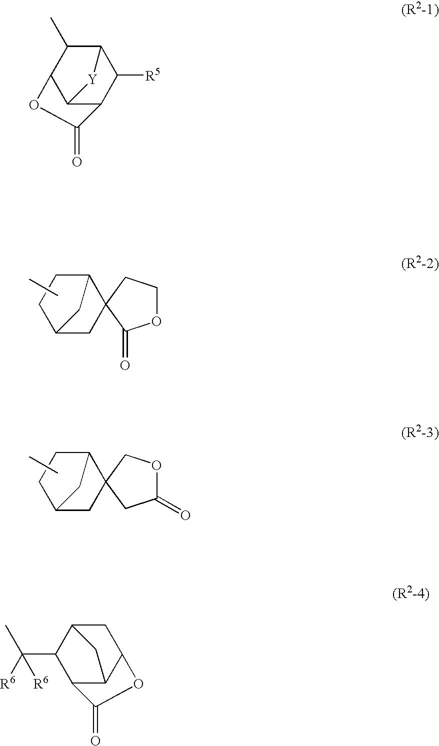
wherein Y is a methylene group or oxygen atom, R⁵ is CO₂R⁷ when Y is methylene, or R⁵ is hydrogen or CO₂R⁷ when Y is oxygen, R⁶ is each independently hydrogen or a straight, branched or cyclic alkyl group of 1 to 10 carbon atoms, two R⁶ may bond together to form a ring with the carbon atom to which they are attached, and R⁷ is a straight, branched or cyclic alkyl group of 1 to 15 carbon atoms which may have at least one oxygen atom intervening in at least one carbon-to-carbon bond,
R⁹ is an acid-labile protective group selected from the general formulae (R⁹-1) and (R⁹-2): 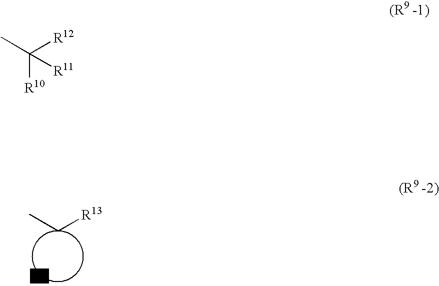
wherein R¹⁰, R¹¹ and R¹² are each independently a straight, branched or cyclic alkyl group of 1 to 15 carbon atoms, R¹³ is a straight or branched alkyl group of 1 to 15 carbon atoms, and Z forms cyclopentane, cyclohexane or adamantane with the carbon atom to which it is attached.

3. A polymer comprising recurring units having the general formulae (1) to (4), the recurring units being of at least one type for each formula, and having a weight average molecular weight of 1,000 to 50,000, 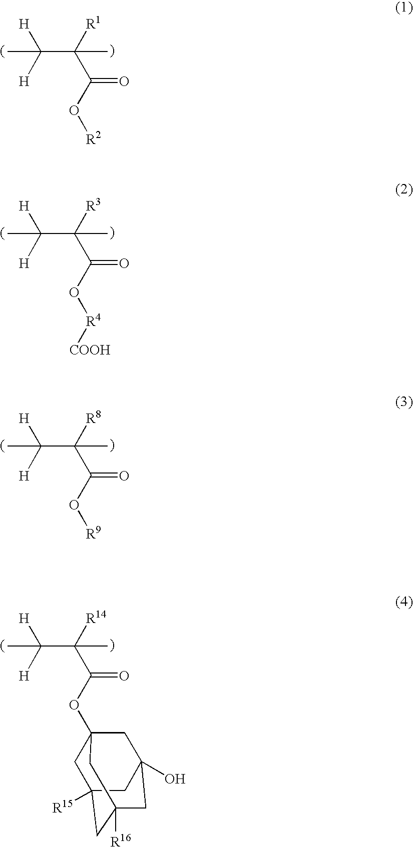
wherein R¹, R³, R⁸ and R¹⁴ are independently hydrogen or methyl, R⁴ is a straight, branched or cyclic alkylene group of 1 to 20 carbon atoms, which may be substituted with at least one oxygen-containing functional group and/or have at least one oxygen atom intervening in at least one carbon-to-carbon bond, R² is a lactone structure-containing substituent group selected from the general formulae (R²-1) to (R²-4): 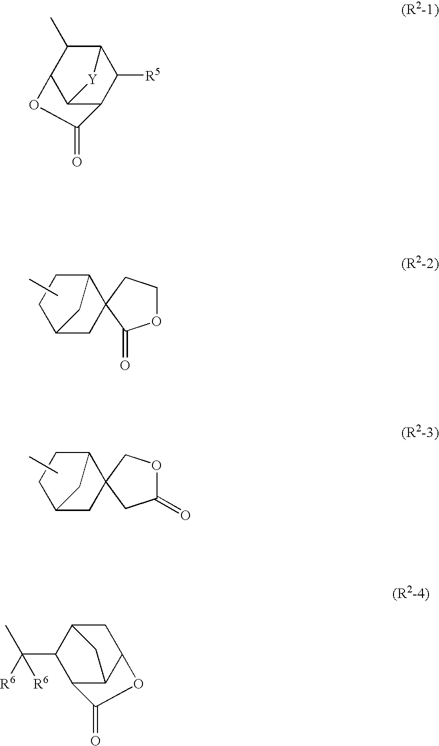
wherein Y is a methylene group or oxygen atom, R⁵ is CO₂R⁷ when Y is methylene, or R⁵ is hydrogen or CO₂R⁷ when Y is oxygen, R⁶ is each independently hydrogen or a straight, branched or cyclic alkyl group of 1 to 10 carbon atoms, two R⁶ may bond together to form a ring with the carbon atom to which they are attached, and R⁷ is a straight, branched or cyclic alkyl group of 1 to 15 carbon atoms which may have at least one oxygen atom intervening in at least one carbon-to-carbon bond,
R⁹ is an acid-labile protective group selected from the general formulae (R⁹-1) and (R⁹-2): 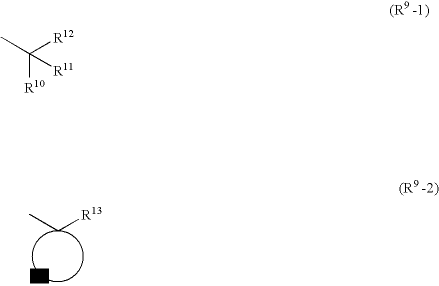
wherein R¹⁰, R¹¹ and R¹² are each independently a straight, branched or cyclic alkyl group of 1 to 15 carbon atoms, R¹³ is a straight or branched alkyl group of 1 to 15 carbon atoms, and Z forms cyclopentane, cyclohexane or adamantane with the carbon atom to which it is attached,
R¹⁵ and R¹⁶ are each independently hydrogen or hydroxyl.

4. A resist composition comprising the polymer of claim 1.

5. A resist composition comprising the polymer of claim 2.

6. A resist composition comprising the polymer of claim 3.

7. A pattern forming process comprising the steps of:
applying the resist composition of claim 4 onto a substrate to form a coating,
heat treating the coating and then exposing it to high-energy radiation or electron beam through a photomask, and
heat treating the exposed coating and developing it with a developer.

8. A pattern forming process comprising the steps of:
applying the resist composition of claim 5 onto a substrate to form a coating,
heat treating the coating and then exposing it to high-energy radiation or electron beam through a photomask, and
heat treating the exposed coating and developing it with a developer.

9. A pattern forming process comprising the steps of:
applying the resist composition of claim 6 onto a substrate to form a coating,
heat treating the coating and then exposing it to high-energy radiation or electron beam through a photomask, and
heat treating the exposed coating and developing it with a developer.
